(19) United States
(12) Patent Application Publication
(10) Pub. No.: US 2024/0349249 A1
(43) Pub. Date: Oct. 17, 2024

(54) NODE IN WIRELESS COMMUNICATION SYSTEM AND METHOD PERFORMED BY THE SAME

(71) Applicant: Samsung Electronics Co., Ltd., Suwon-si, Gyeonggi-do (KR)

(72) Inventors: Yanru WANG, Beijing (CN); Hong WANG, Beijing (CN); Lixiang XU, Beijing (CN); Weiwei WANG, Beijing (CN); Xiaoning MA, Beijing (CN)

(21) Appl. No.: 18/292,136

(22) PCT Filed: Jul. 26, 2022
(86) PCT No.: PCT/KR2022/010993

§ 371 Date: Jan. 25, 2024

(30) Foreign Application Priority Data
Jul. 26, 2021 (CN) 202110845470.8

(51) Int. Cl. H04W 72/04

(52) U.S. Cl. CPC H04W 72/04

(57) ABSTRACT

The disclosure relates to a 5G or 6G communication system for supporting a higher data transmission rate. A first node, a second node, a method performed by first node and a method performed by second node in a wireless communication system are provided. The method performed by first node includes receiving a message regarding at least one of a measurement report of a UE, a suggested target cell for UE, a suggested handover execution condition for UE, and a PDCP sequence number for UE from a second node, and determining information for handover of UE based on the received message. The invention can improve efficiency of handover and/or avoid redundancy for data forwarding during handover.

### CROSS-REFERENCE TO RELATED APPLICATION(S)

This application is a U.S. National Stage application under 35 U.S.C. § 371 of an International application number PCT/KR2022/010993, filed on Jul. 26, 2022, which is based on and claims priority of a Chinese patent application number 202110845470.8, filed on Jul. 26, 2021, in the Chinese Intellectual Property Office, the disclosure of which is incorporated by reference herein in its entirety.

### TECHNICAL FIELD

The present disclosure generally relates to the field of wireless communication, and in particular, relates to a first node, a second node, a method performed by the first node and a method performed by the second node in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE

### Technical Solution

According to at least one embodiment of the disclosure, there is provided a method performed by a first node in a wireless communication system, including: receiving a message regarding at least one of a measurement report of a user equipment (UE), a suggested target cell for the UE, a suggested handover execution condition for the UE, and a packet data convergence protocol (PDCP) sequence number for the UE from a second node; and determining information for handover of the UE based on the received message.

In some implementations, for example, the message regarding at least one of the measurement report of the UE, the suggested target cell for the UE, the suggested handover execution condition for the UE, and the PDCP sequence number for the UE includes a first message including a first prediction result of prediction of the measurement report of the UE.

In some implementations, for example, receiving the message regarding at least one of the measurement report of the UE, the suggested target cell for the UE, the suggested handover execution condition for the UE, and the PDCP sequence number for the UE from the second node includes receiving the first message from the second node.

In some implementations, for example, receiving the first message from the second node includes transmitting a second message including a first request requesting to predict the measurement report of the UE to the second node, and receiving the first message transmitted in response to the second message from the second node.

In some implementations, for example, the second message includes at least one of: a handover time; a prediction identification; a prediction registration request; a prediction time interval; a prediction result reporting type; a prediction result reporting period; a reporting trigger condition; a prediction type; a prediction content; or an identification of a cell for prediction.

In some implementations, for example, the first message includes at least one of: a prediction identification of a prediction content; a handover time; a prediction request content confirmation; a prediction time interval; a prediction type; the prediction content; or an identification of a cell for prediction.

In some implementations, for example, the method further includes receiving a third message indicating that the measurement report cannot be predicted based on the first request from the second node, where the third message is transmitted in case that the second node cannot feed back the first prediction result to the first node based on the first request.

In some implementations, for example, the third message includes at least one of: a prediction request content confirmation; or a cause.

In some implementations, for example, the message regarding at least one of the measurement report of the UE, the suggested target cell for the UE, the suggested handover execution condition for the UE, and the PDCP sequence number for the UE includes a fourth message including a first feedback result of the suggested target cell for the UE.

In some implementations, for example, receiving the message regarding at least one of the measurement report of the UE, the suggested target cell for the UE, the suggested handover execution condition for the UE, and the PDCP sequence number for the UE from the second node includes receiving the fourth message from the second node.

In some implementations, for example, receiving the fourth message from the second node includes transmitting a fifth message including a second request requesting to feed back information on the suggested target cell for the UE to the second node, and receiving the fourth message transmitted in response to the fifth message including the second request from the second node.

In some implementations, for example, the fifth message includes at least one of: a handover time; a prediction identification; a registration request; a prediction registration request; a prediction time interval; a result reporting type; a prediction result reporting type; a result reporting period; a prediction result reporting period; a reporting trigger condition; or a prediction type.

In some implementations, for example, the fourth message includes at least one of: a prediction identification of a prediction content; a handover time; a request content confirmation; a prediction request content confirmation; a prediction time interval; a prediction type; or a predicted cell identification.

In some implementations, for example, the method further includes receiving a sixth message indicating that the suggested candidate serving cell cannot be fed back based on the second request from the second node, where the sixth message is transmitted in case that the second node cannot feed back the suggested candidate serving cell to the first node based on the second request.

In some implementations, for example, the sixth message includes at least one of: a request content confirmation; a prediction request content confirmation; or a cause.

In some implementations, for example, the message regarding at least one of the measurement report of the UE, the suggested target cell for the UE, the suggested handover execution condition for the UE, and the PDCP sequence number for the UE includes a seventh message including a second feedback result of the suggested handover execution condition for the UE.

In some implementations, for example, receiving the message regarding at least one of the measurement report of the UE, the suggested target cell for the UE, the suggested handover execution condition for the UE, and the PDCP sequence number for the UE from the second node includes receiving the seventh message from the second node.

In some implementations, for example, receiving the seventh message from the second node includes transmitting an eighth message including a third request requesting to predict information on the suggested handover execution condition for the UE to the second node, and receiving the seventh message transmitted in response to the eighth message including the third request from the second node.

In some implementations, for example, the eighth message includes at least one of: a handover time; a prediction identification; a registration request; a prediction registration request; a prediction time interval; a result reporting type; a prediction result reporting type; a result reporting period; a prediction result reporting period; a reporting trigger condition; a prediction type; a prediction content; or an identification of a cell for prediction.

In some implementations, for example, the seventh message includes at least one of: a prediction identification of a prediction content; a handover time; a request content confirmation; a prediction request content confirmation; a prediction time interval; a prediction type; a cell identification; or an identification of a cell for prediction.

In some implementations, for example, the method further includes receiving a ninth message indicating that the suggested handover execution condition cannot be fed back based on the thirdsecond request from the second node, where the ninth message is transmitted in case that the second node cannot feed back the suggested handover execution condition to the first node based on the third request.

In some implementations, for example, the ninth message includes at least one of: a request content confirmation; a prediction request content confirmation; or a cause.

In some implementations, for example, the message regarding at least one of the measurement report of the UE, the suggested target cell for the UE, the suggested handover execution condition for the UE, and the PDCP sequence number for the UE includes a tenth message including a second prediction result of prediction of the PDCP sequence number for the UE.

In some implementations, for example, receiving the message regarding at least one of the measurement report of the UE, the suggested target cell for the UE, the suggested handover execution condition for the UE, and the PDCP sequence number for the UE from the second node includes receiving the tenth message from the second node.

In some implementations, for example, the prediction of the PDCP sequence number for the UE includes a prediction of the PDCP sequence number for data forwarding, a prediction of the PDCP sequence number for data transmission, a prediction of a changing trend of the PDCP sequence number, etc.

In some implementations, for example, receiving the tenth message from the second node includes transmitting an eleventh message including a fourth request requesting to predict the PDCP sequence number for the UE to the second node, and receiving the tenth message transmitted in response to the eleventh message from the second node.

In some implementations, for example, the eleventh message includes at least one of: a handover time; a prediction identification; a prediction registration request; a prediction time interval; a prediction result reporting type; a prediction result reporting period; a reporting trigger condition; a prediction type; a prediction content; or an identification of a cell for prediction.

In some implementations, for example, the tenth message includes at least one of: a prediction identification of a prediction content; a handover time; a prediction request content confirmation; a prediction time interval; a prediction type; the prediction content; or an identification of a cell for prediction.

In some implementations, for example, the method further includes receiving a twelfth message indicating that the PDCP sequence number for the UE cannot be predicted based on the fourth request from the second node, where the twelfth message is transmitted in case that the second node cannot feed back the second prediction result to the first node based on the first request.

In some implementations, for example, the twelfth message includes at least one of: a prediction request content confirmation; or a cause.

In some implementations, for example, the message regarding at least one of the measurement report of the UE, the suggested target cell for the UE, the suggested handover execution condition for the UE, and the PDCP sequence number for the UE includes a thirteenth message including a third feedback result of the PDCP sequence number for the UE.

In some implementations, for example, receiving the message regarding at least one of the measurement report of the UE, the suggested target cell for the UE, the suggested handover execution condition for the UE, and the PDCP sequence number for the UE from the second node includes receiving the thirteenth message from the second node.

In some implementations, for example, receiving the thirteenth message from the second node includes transmitting a fourteenth message including a fifth request requesting to report the PDCP sequence number for the UE to the second node, and receiving the thirteenth message transmitted in response to the fourteenth message from the second node.

In some implementations, for example, the fourteenth message includes at least one of: a reporting identification; a reporting registration request; an information reporting time interval; a result reporting type; a result reporting period; or a reporting content.

In some implementations, for example, the thirteenth message includes at least one of: a request content confirmation; an information reporting time interval; or a reporting content.

In some implementations, for example, the method further includes receiving a fifteenth message indicating that the PDCP sequence number for the UE cannot be reported based on the fifth request from the second node, where the fifteenth message is transmitted in case that the second node cannot report the third feedback result to the first node based on the fifth request.

In some implementations, for example, the fifteenth message includes at least one of: a request content confirmation; or a cause.

In some implementations, for example, the information for handover of the UE includes at least one of: information on selection of a target node, information on a handover execution condition, information on determination of whether to perform handover, information on determination of a handover timing, or information on a setting of a data forwarding amount for data forwarding.

According to at least one embodiment of the disclosure, there is also provided a method performed by a second node in a wireless communication system. The method includes transmitting a message regarding at least one of a measurement report of a user equipment (UE), a suggested target cell for the UE, a suggested handover execution condition for the UE, and a PDCP sequence number for the UE to a first node, where information for handover of the UE is determined based on the transmitted message.

In some implementations, for example, the message regarding at least one of the measurement report of the UE, the suggested target cell for the UE, the suggested handover execution condition for the UE, and the PDCP sequence number for the UE includes a first message including a first prediction result of prediction of the measurement report of the UE.

In some implementations, for example, transmitting the message regarding at least one of the measurement report of the UE, the suggested target cell for the UE, the suggested handover execution condition for the UE, and the PDCP sequence number for the UE to the first node includes transmitting the first message to the first node.

In some implementations, for example, transmitting the first message to the first node includes receiving a second message including a first request requesting to predict the measurement report of the UE from the first node; and transmitting the first message to the first node in response to the second message.

In some implementations, for example, the message regarding at least one of the measurement report of the UE, the suggested target cell for the UE, the suggested handover execution condition for the UE, and the PDCP sequence number for the UE includes a fourth message including a first feedback result of the suggested target cell for the UE.

In some implementations, for example, transmitting the message regarding at least one of the measurement report of the UE, the suggested target cell for the UE, the suggested handover execution condition for the UE, and the PDCP sequence number for the UE to the first node includes transmitting the fourth message to the first node.

In some implementations, for example, transmitting the fourth message to the first node includes receiving a fifth message including a second request requesting to feed back information on the suggested target cell for the UE from the first node; and transmitting the fourth message to the first node in response to the fifth message including the second request.

In some implementations, for example, the message regarding at least one of the measurement report of the UE, the suggested target cell for the UE, the suggested handover execution condition for the UE, and the PDCP sequence number for the UE includes a seventh message including a second feedback result of the suggested handover execution condition for the UE.

In some implementations, for example, transmitting the message regarding at least one of the measurement report of the UE, the suggested target cell for the UE, the suggested handover execution condition for the UE, and the PDCP sequence number for the UE to the first node includes transmitting the seventh message to the first node.

In some implementations, for example, transmitting the seventh message to the first node includes receiving an eighth message including a third request for information on predicting the suggested handover execution condition for the UE from the first node, and transmitting the seventh message including the second feedback result to the first node in response to the eighth message including the third request.

In some implementations, for example, the message regarding at least one of the measurement report of the UE, the suggested target cell for the UE, the suggested handover execution condition for the UE, and the PDCP sequence number for the UE includes a tenth message including a second prediction result of prediction of the PDCP sequence number for the UE.

In some implementations, for example, transmitting the message regarding at least one of the measurement report of the UE, the suggested target cell for the UE, the suggested handover execution condition for the UE, and the PDCP sequence number for the UE to the first node includes transmitting the tenth message to the first node.

In some implementations, for example, transmitting the tenth message to the first node includes receiving an eleventh message including a fourth request requesting to predict the PDCP sequence number for the UE from the first node, and transmitting the tenth message to the first node in response to the eleventh message.

In some implementations, for example, the message regarding at least one of the measurement report of the UE, the suggested target cell for the UE, the suggested handover execution condition for the UE, and the PDCP sequence number for the UE includes a thirteenth message including a third feedback result of the PDCP sequence number for data transmission of the UE.

In some implementations, for example, transmitting the message regarding at least one of the measurement report of the UE, the suggested target cell for the UE, the suggested handover execution condition for the UE, and the PDCP sequence number for the UE to the first node includes transmitting the thirteenth message to the first node.

In some implementations, for example, transmitting the thirteenth message to the first node includes receiving a fourteenth message including a fifth request requesting to report the PDCP sequence number for data transmission of the UE from the first node, and transmitting the thirteenth message to the first node in response to the fourteenth message.

In some implementations, for example, the information for handover of the UE includes at least one of: information on selection of a target node, information on a handover execution condition, information on determination of whether to perform handover, information on determination of a handover timing, or information on a setting of a data forwarding amount for data forwarding.

According to at least one embodiment of the disclosure, there is also provided a first node in a wireless communication system. The first node includes: a transceiver configured to transmit and receive signals; and a controller coupled with the transceiver and configured to perform one or more operations of the methods performed by the first node described above.

According to at least one embodiment of the disclosure, there is also provided a second node in a wireless communication system. The second node includes: a transceiver configured to transmit and receive signals; and a controller coupled with the transceiver and configured to perform one or more operations of the methods performed by the second node described above.

According to at least one embodiment of the disclosure, there is also provided a computer-readable storage medium having one or more computer programs stored therein that, when executed by one or more processors, implement any of the methods described above.

### DESCRIPTION OF DRAWINGS

In order to more clearly explain technical schemes of the embodiments of the disclosure, accompanying drawings of the embodiments of the disclosure will be briefly introduced below. It is apparent that the accompanying drawings described below only relate to some embodiments of the disclosure, and are not limitations of the disclosure. In the accompanying drawings:

FIG. 1 is an exemplary system architecture of System Architecture Evolution (SAE);

FIG. 2 is an exemplary system architecture according to some embodiments of the disclosure;

FIG. 3 illustrates a schematic diagram of a method for supporting data collection and processing according to some embodiments of the disclosure (e.g., Embodiment 1);

FIG. 4 illustrates a schematic diagram of a method for supporting data collection and processing according to some embodiments of the disclosure (e.g., Embodiment 2);

FIG. 5 illustrates a schematic diagram of a method for supporting data collection and processing according to some embodiments of the disclosure (e.g., Embodiment 3);

FIG. 6 illustrates a schematic diagram of a method for supporting data collection and processing according to some embodiments of the disclosure (e.g., Embodiment 4);

FIG. 7 illustrates a schematic diagram of a method for supporting data collection and processing according to some embodiments of the disclosure (e.g., Embodiment 5);

FIG. 8 illustrates a schematic diagram of a method for supporting data collection and processing according to some embodiments of the disclosure (e.g., Embodiment 6);

FIG. 9 illustrates a schematic diagram of a method for supporting data collection and processing according to some embodiments of the disclosure (e.g., Embodiment 7);

FIG. 10 illustrates a schematic diagram of a method for supporting data collection and processing according to some embodiments of the disclosure (e.g., Embodiment 8);

FIG. 11 illustrates a schematic diagram of a method for supporting data collection and processing according to some embodiments of the disclosure (e.g., Embodiment 9);

FIG. 12 illustrates a schematic diagram of a method for supporting data collection and processing according to some embodiments of the disclosure (e.g., Embodiment 10);

FIG. 13 illustrates a schematic diagram of a method for supporting data collection and processing according to some embodiments of the disclosure (e.g., Embodiment 11);

FIG. 14 illustrates a schematic diagram of a method for supporting data collection and processing according to some embodiments of the disclosure (e.g., Embodiment 12);

FIG. 15 illustrates a schematic diagram of a method for supporting data collection and processing according to some embodiments of the disclosure (e.g., Embodiment 13);

FIG. 16 illustrates a schematic diagram of a method for supporting data collection and processing according to some embodiments of the disclosure (e.g., Embodiment 14);

FIG. 17 illustrates a schematic diagram of a method for supporting data collection and processing according to some embodiments of the disclosure (e.g., Embodiment 15);

FIG. 18 illustrates a schematic diagram of a method for supporting data collection and processing according to some embodiments of the disclosure (e.g., Embodiment 16);

FIG. 19 illustrates a schematic diagram of a method for supporting data collection and processing according to some embodiments of the disclosure (e.g., Embodiment 17);

FIG. 20 illustrates a schematic diagram of a method for supporting data collection and processing according to some embodiments of the disclosure (e.g., Embodiment 18);

FIG. 21 illustrates a schematic diagram of a method for supporting data collection and processing according to some embodiments of the disclosure (e.g., Embodiment 19);

FIG. 22 illustrates a schematic diagram of a method for supporting data collection and processing according to some embodiments of the disclosure (e.g., Embodiment 20);

FIG. 23 illustrates a schematic diagram of a method for supporting data collection and processing according to some embodiments of the disclosure (e.g., Embodiment 21);

FIG. 24 illustrates a schematic diagram of a method for supporting data collection and processing according to some embodiments of the disclosure (e.g., Embodiment 22);

FIG. 25 illustrates a schematic diagram of a method for supporting data collection and processing according to some embodiments of the disclosure (e.g., Embodiment 23);

FIG. 26 illustrates a flowchart of a method performed by a first node according to some embodiments of the disclosure;

FIG. 27 illustrates a flowchart of a method performed by a second node according to some embodiments of the disclosure;

FIG. 28 illustrates a block diagram of a configuration of a terminal according to some embodiments of the disclosure; and

FIG. 29 illustrates a block diagram of a configuration of a base station according to some embodiments of the disclosure.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

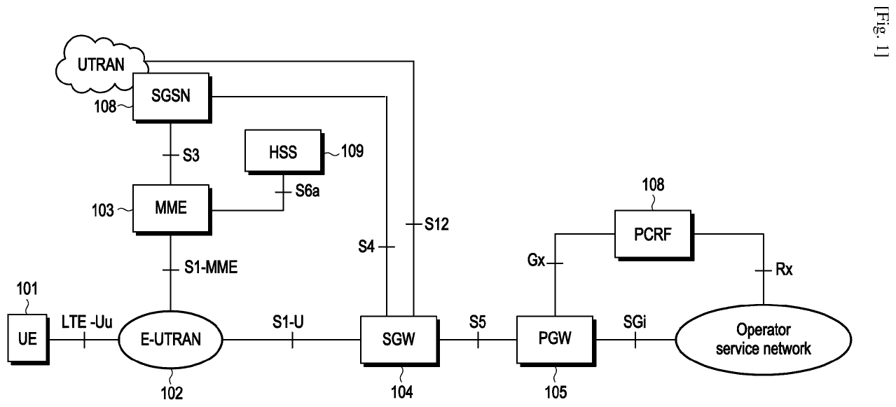

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

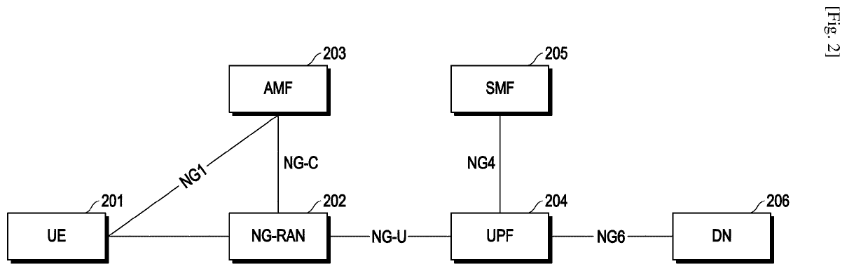

FIG. 2 is an exemplary system architecture 200 according to various embodiments of the disclosure. Other embodiments of the system architecture 200 can be used without departing from the scope of the disclosure.

User equipment (UE) 201 is a terminal device for receiving data. A next generation radio access network (NG-RAN) 202 is a radio access network, which includes a base station (a gNB or an eNB connected to 5G core network (5GC), where the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity (SMF) 205 is responsible for session management. A data network (DN) 206 includes, for example, services of operators, accesses of Internet and services of third parties.

Exemplary embodiments of the disclosure are further described below with reference to the accompanying drawings. For convenience of explanation, some terms and names defined in the 3rd generation partnership project (3GPP), Long Term Evolution (LTE), LTE-Advanced (LTE-A), 5th generation (5G) and New Radio (NR) standards may be used. However, details of the disclosure are not limited by the terms and names according to the standards, and can be equally applied to systems according to other standards.

Conditional change/handover of a Primary Secondary Cell (PSCell) is under study as a new technology. An initiating node provides an upper limit of the number of candidate target PSCells, a target secondary node selects a list of appropriate candidate target PSCells according to a current measurement report of a UE and/or resource states of the nodes, and a master node sets corresponding execution conditions according to the list of candidate target PSCells. When one or more of the execution conditions are met, a PSCell change/handover procedure is performed. Under this mechanism, the selection of the list of candidate target PSCells by the target secondary node according to the current measurement report of the UE may cause situations such as too many or too few candidate target cells, inaccurate candidate target cells and so on, thus resulting in low handover success rate and handover efficiency. Conditional handover supports early data forwarding, in which a source secondary node performs data forwarding to all target secondary nodes after confirming a secondary node release request. For different target cells, the handover time of the UE is different due to different execution conditions, so the performing of the same early data forwarding to all target secondary nodes cause a large amount for data forwarding and redundancy for data forwarding.

In order to solve at least one of the above-mentioned problems, embodiments of the disclosure provide a method and an apparatus for supporting data collection and processing.

According to some embodiments of the disclosure, a method for supporting data collection and processing may include receiving, by a first node, a first message including a result of prediction of a measurement report of a UE (in embodiments of the disclosure, it may also be referred to as a first prediction result) from a second node, so that reference information is provided for the first node and/or other nodes to perform at least one of target node selection, handover execution condition setting, determination of whether to perform handover, or determination of a handover timing for the UE. In this way, by performing change/handover of a cell (or node) of the UE in consideration of the result of the prediction of the measurement report of the UE, it may be possible to avoid situations such as too many candidate target nodes, inaccurate candidate target nodes, handover failure, handover ping-pong, etc.

In some embodiments, the first node may transmit a second message including a measurement report prediction request (in embodiments of the disclosure, it may also be referred to as a first request) requesting to predict the measurement report of the UE to the second node, so as to inform the second node of a feedback requirement for the prediction of the measurement report of the UE. After receiving the second message, the second node may report prediction information of the measurement report of the UE to the first node according to the feedback requirement (for example, based on the first request), so that the first node may obtain the result of the prediction of the measurement report of the UE by the second node, and thus reference information is provided for the first node and/or other nodes to perform at least one of target node selection, handover execution condition setting, determination of whether to perform handover, and determination of a handover timing for the UE.

In some implementations, the first node may be one of a gNB, a gNB CU (Central Unit)-CP (Control Plane), an en-gNB, an eNB, or an ng-eNB.

In some implementations, the second node may be one of a gNB, a gNB CU-CP, an en-gNB, an eNB, or an ng-eNB.

In some examples, in a dual connectivity scenario in which a master node and a secondary node are connected with the UE, when handover occurs, the second node may be a master node, and the first node may be a source secondary node or a target secondary node changed from the source secondary node. In some other examples, the first node may be a master node and the second node may be a source secondary node.

In some implementations, the measurement report prediction request may be carried by any suitable message (existing message or newly defined message) over any suitable interface (e.g., X2 interface, Xn interface, S1 interface, or NG interface). For example, the second message carrying the measurement report prediction request may be an SENB RELEASE REQUEST message or an SGNB RELEASE REQUEST message of X2; or, the message may also be an S-NODE RELEASE REQUEST message of Xn; or, the message may also be a HANDOVER REQUEST ACKNOWLEDGE message or a RETRIEVE UE CONTEXT REQUEST message or a HANDOVER SUCCESS message of X2 or Xn; or, the message may also be an SENB MODIFICATION REQUEST message or an SGNB MODIFICATION REQUEST message or an SENB MODIFICATION REQUIRED message or an SGNB MODIFICATION REQUIRED message of X2; or, the message may also be an S-NODE MODIFICATION REQUEST message or an S-NODE MODIFICATION REQUIRED message of Xn; or, the message may also be a HANDOVER COMMAND message or a HANDOVER PREPARATION FAILURE message or a HANDOVER REQUEST ACKNOWLEDGE message or a HANDOVER NOTIFY message or a HANDOVER SUCCESS message or a PATH SWITCH REQUEST message of NG; or, the message may also be a newly defined X2 or Xn or NG message.

In some implementations, the second message (for example, the measurement report prediction request and/or information related thereto in the second message) may include one or more of the following (or include information or parameters or fields on (or indicating) each of the one or more of the following):

UE Identification (ID): it is used to identify the UE for which the measurement report needs to be predicted. The UE ID may include one or more of an NG (next generation)-RAN node UE XnAP ID, a Source NG-RAN node UE XnAP ID, an M (master)-NG-RAN node UE XnAP ID, an S (secondary)-NG-RAN node UE XnAP ID, an MeNB (master eNB) UE X2AP ID, an SeNB (secondary eNB) UE X2AP ID, an MeNB UE X2AP ID, an SgNB (secondary gNB) UE X2AP ID, an AMF UE NGAP ID, a RAN UE NGAP ID, or a Source AMF UE NGAP ID.

First Node ID: it is used to identify a node transmitting the request. For example, the first node ID may include one or more of a Cell Global ID, a Target Cell Global ID and a Requested Target Cell ID.

Second Node ID: it is used to identify a node receiving the request. For example, the second node ID may include one or more of a Cell Global ID, a Target Cell Global ID and a Requested Target Cell ID.

Handover Time: it is used to indicate a time point (e.g., time) when the UE performs handover. For example, the time may be a relative time or an absolute time.

Prediction Identification: it is used to indicate whether a request for measurement report prediction or a request for prediction is included. The information (e.g., field) may be indicated by a single bit, for example, a value (e.g., bit) of “1” may be used to indicate that the request is a request for measurement report prediction (e.g., the first request), and a value (e.g., bit) of “0” may be used to indicate that the request is not the request for measurement report prediction; or a value (e.g., bit) of “1” may be used to indicate that the request is the request for prediction, and a value (e.g., bit) of “0” may be used to indicate that the request is not the request for prediction.

Prediction Registration Request: it is used to indicate a start, end, addition, etc. of the prediction of the measurement report.

Prediction Time Interval: it is used to indicate a time interval (time period or time span) for the prediction. For example, the prediction time interval may be indicated by 2*n bits, for example, the first n bits indicate a prediction start time and the last n bits indicate a prediction end time, where n may be a positive integer. The time may be a relative time or an absolute time. Alternatively, the prediction time interval may be indicated by separate fields, including one or more of the following:

Prediction Start Time: it is used to indicate a start time of the prediction. For example, the start time may be a relative time or an absolute time.

Prediction End Time: it is used to indicate an end time of the prediction. For example, the end time may be a relative time or an absolute time.

Prediction Result Reporting Type: it is used to indicate a reporting type of the first prediction result. For example, the prediction result reporting type may be used to indicate whether a measurement report prediction result (for example, the first prediction result) is reported aperiodically (for example, reported once or reported sporadically) or reported periodically. For example, the reporting type may include, but is not limited to, an on-demand type, a periodic type, etc.

Prediction Result Reporting Period: it is used to indicate a time interval of periodic reporting of the measurement report prediction result (for example, the first prediction result). For example, the reporting period may also be the prediction time of the data reported this time. For example, if there is no such information (e.g., field), it may indicate that a single report is enough, where the prediction time of the single report is from the prediction start time to the prediction end time.

Reporting Trigger Condition: it is used to indicate a trigger condition under which the measurement report prediction result (for example, the first prediction result) needs to be reported. For example, it needs to be reported only when the prediction result or actual situation meets the trigger condition (for example, a measurement report value (also be referred to as a value (or parameter) related to the measurement report) abruptly increases or drops, the measurement report value changes in a ping-pong way, etc.). For example, the measurement report value may include at least one of a Reference Signal Receiving Power (RSRP), a Reference Signal Receiving Quality (RSRQ), and a Signal to Interference plus Noise Ratio (SINR), etc.

Prediction Type: it is used to indicate a type of prediction that needs to be performed for the measurement report. For example, the prediction type includes but is not limited to: a prediction of the measurement report value, a prediction of a changing trend of the measurement report value, etc.

Prediction Content: it is used to indicate parameters that need to be predicted. For example, the indicated parameters that need to be predicted may include one or more of a Reference Signal Receiving Power (RSRP), a Reference Signal Receiving Quality (RSRQ), a Signal to Interference plus Noise Ratio (SINR), the changing trend (for example, increasing or abruptly increasing or decreasing or abruptly decreasing or remaining unchanged or changing in a ping-pong way) of the RSRP or RSRQ or SINR, a prediction accuracy, etc.

Identification of a cell for prediction: it is used to indicate a cell for which the measurement report of the UE needs to be predicted. For example, the cell identification may indicate one or more of a cell, a master cell, a secondary cell, a primary cell, a primary secondary cell, etc. For example, the identification of a cell for prediction may be a Physical Cell Identifier, or a Global NG-RAN Cell Identity, etc.

In some implementations, the prediction content may be related to the prediction type. For example, if the prediction type is the prediction of the measurement report value, the prediction content includes at least one of a time point, a cell identification, a RSRP value, a RSRQ value, a SINR value, a prediction accuracy, etc. For another example, if the prediction type is the prediction of the changing trend of the measurement report value, the prediction content includes at least one of a time point, a cell identification, a changing trend (for example, increasing or abruptly increasing or decreasing or abruptly decreasing or remaining unchanged or changing in a ping-pong way) of a RSRP or RSRQ or SINR, a prediction accuracy, etc.

In some implementations, the second node may transmit the first message including the measurement report prediction result (for example, the first prediction result) to the first node according to its own situation and/or the measurement report prediction request (for example, the first request) transmitted by the first node, so that the first node may obtain the result of the prediction of the measurement report of the UE by the second node, and thus reference information is provided for the first node and/or other nodes to perform target node selection, handover execution condition setting, determination of whether to perform handover, and determination of a handover timing, etc. for the UE, thereby avoiding situations such as too many candidate target nodes, inaccurate candidate nodes, handover failure, handover ping-pong, etc.

In some implementations, the measurement report prediction result may be carried by any suitable message (existing message or newly defined message) over any suitable interface (e.g., X2 interface, Xn interface, S1 interface, or NG interface). For example, the first message carrying the measurement report prediction result may be an SGNB RELEASE REQUEST ACKNOWLEDGE message or an SENB ADDITION REQUEST message or an SGNB ADDITION REQUEST message or an SGNB CHANGE REQUIRED message of X2; or, the first message may also be an S-NODE RELEASE REQUEST ACKNOWLEDGE message or an S-NODE ADDITION REQUEST message or an S-NODE CHANGE REQUIRED message of Xn; or the first message may also be a HANDOVER REQUEST message or a RETRIEVE UE CONTEXT RESPONSE message or a RETRIEVE UE CONTEXT FAILURE message of X2 or Xn; or, the first message may also be an SENB MODIFICATION REQUEST ACKNOWLEDGE message or an SENB MODIFICATION REQUEST REJECT message or an SGNB MODIFICATION REQUEST ACKNOWLEDGE message or an SGNB MODIFICATION REQUEST REJECT message or an SENB MODIFICATION CONFIRM message or an SENB MODIFICATION REFUSE message or an SGNB MODIFICATION CONFIRM message or an SGNB MODIFICATION REFUSE message of X2; or, the first message may also be an S-NODE MODIFICATION REQUEST ACKNOWLEDGE message or an S-NODE MODIFICATION REQUEST REJECT message or an S-NODE MODIFICATION CONFIRM message or an S-NODE MODIFICATION REFUSE message of Xn; or, the first message may also be a PATH SWITCH REQUEST ACKNOWLEDGE message or a PATH SWITCH REQUEST FAILURE message of NG; or, the first message may also be a newly defined X2 or Xn or NG message.

In some implementations, the first message (e.g., the measurement report prediction result (e.g., the first prediction result) and/or information related thereto in the first message) may include one or more of the following (or include information or parameters or fields on (or indicating) each of the one or more of the following):

UE ID: it is used to identify the UE for which the measurement report prediction is performed. For example, the identification may include one or more of an NG-RAN node UE XnAP ID, a Source NG-RAN node UE XnAP ID, an M-NG-RAN node UE XnAP ID, an S-NG-RAN node UE XnAP ID, an MeNB UE X2AP ID, an SeNB UE X2AP ID, an MeNB UE X2AP ID, an SgNB UE X2AP ID, an AMF UE NGAP ID, a RAN UE NGAP ID, or a Source AMF UE NGAP ID.

First Node ID: it is used to identify the first node. For example, the first node ID may include one or more of a Cell Global ID, a Target Cell Global ID and a Requested Target Cell ID.

Second Node ID: it is used to identify the second node. For example, the second node ID may include one or more of a Cell Global ID, a Target Cell Global ID and a Requested Target Cell ID.

Prediction Identification of Prediction Content: it is used to indicate whether the measurement report information (for example, the first prediction result) is a prediction content, for example, whether it is obtained by prediction. For example, the information (e.g., field) may be indicated by a single bit; for example, a value (e.g., bit) of “1” may be used to indicate that the information is a prediction content, and a value (e.g., bit) of “0” may be used to indicate that the information is an actual state content (e.g., a measurement report actually reported by the UE).

Handover Time: it is used to indicate a time point when the UE performs handover. For example, the time may be a relative time or an absolute time.

Prediction Request Content Confirmation: it is used to indicate whether prediction of the measurement report can be performed. In an example, whether the prediction can be performed may be indicated by a single bit; for example, the bit of “1” indicates that all of the requested content(s) can be predicted, and the bit of “0” indicates that the requested content(s) cannot be predicted. In another example, the prediction of the request content(s) may also be confirmed one by one by a plurality of bits, for example, in a form of bitmap of which each bit corresponds to the confirmation of one prediction content; for example, the bit of “1” indicates that information of the predicted measurement report of a corresponding prediction content can be transmitted, and the bit of “0” indicates that the information of the predicted measurement report of the corresponding prediction content cannot be transmitted. In still another example, separate fields may also be used to indicate the confirmation of different prediction contents.

Prediction Time Interval: it is used to indicate a prediction time interval (time period or time span) to which the prediction data of the measurement report (for example, information related to the measurement report obtained by prediction) is applicable. For example, the prediction time interval may be indicated by 2*n bits; for example, the first n bits indicate a prediction start time and the last n bits indicate a prediction end time, where n may be a positive integer. For example, the time may be a relative time or an absolute time. Alternatively, the prediction time interval may be indicated by separate fields, including one or more of the following:

Prediction Start Time: it is used to indicate a start time of the prediction. For example, the start time may be a relative time or an absolute time.

Prediction End Time: it is used to indicate an end time of the prediction. For example, the end time may be a relative time or an absolute time.

Prediction Type: it is used to indicate a type of prediction of the measurement report. For example, the prediction type includes but is not limited to: a prediction of the measurement report value, a prediction of a changing trend of the measurement report value, etc.

Prediction Content: it is used to indicate predicted parameters related to the measurement report. For example, the parameters include one or more of a Reference Signal Receiving Power (RSRP), a Reference Signal Receiving Quality (RSRQ), a Signal to Interference plus Noise Ratio (SINR), the changing trend (for example, increasing or abruptly increasing or decreasing or abruptly decreasing or remaining unchanged or changing in a ping-pong way) of the RSRP or RSRQ or SINR, a prediction accuracy, etc.

Identification of a cell for prediction: it is used to indicate the identification of a cell for which the measurement report of the UE is predicted. For example, the identification of the cell for prediction may indicate one or more of a cell, a master cell, a secondary cell, a primary cell, a primary secondary cell, etc. For example, the identification may be a Physical Cell Identifier, or a Global NG-RAN Cell Identity, etc.

In some implementations, the prediction content may be related to the prediction type. For example, if the prediction type is the prediction of the measurement report value, the prediction content includes at least one of the time point, cell identification, RSRP value, RSRQ value, SINR value, prediction accuracy, etc. For another example, if the prediction type is the prediction of the changing trend of the measurement report value, the prediction content includes at least one of the time point, cell identification, changing trend (for example, increasing or abruptly increasing or decreasing or abruptly decreasing or remaining unchanged or changing in a ping-pong way) of the RSRP or RSRQ or SINR, prediction accuracy, etc.

In some implementations, if the second node cannot feed back the measurement report prediction result (e.g., the first prediction result) to the first node according to the measurement report prediction request (e.g., the first request) transmitted by the first node, the second node transmits a third message including information indicating that the prediction cannot be performed or the prediction fails to the first node, so that the first node knows that the second node cannot perform prediction according to the request.

In some implementations, the information indicating that the prediction cannot be performed or the prediction fails may be carried by any suitable message (existing message or newly defined message) over any suitable interface (e.g., X2 interface, Xn interface, S1 interface, or NG interface). In some examples, the third message may be an SGNB RELEASE REQUEST ACKNOWLEDGE message or an SGNB RELEASE REQUEST REJECT message or an SENB ADDITION REQUEST message or an SGNB ADDITION REQUEST message or an SGNB CHANGE REQUIRED message of X2; or the third message may also be an S-NODE RELEASE REQUEST ACKNOWLEDGE message or an S-NODE RELEASE REJECT message or an S-NODE ADDITION REQUEST message or an S-NODE CHANGE REQUIRED message of Xn; or, the third message may also be a RETRIEVE UE CONTEXT RESPONSE message or a RETRIEVE UE CONTEXT FAILURE message of X2 or Xn; or the third message may also be an SENB MODIFICATION REQUEST ACKNOWLEDGE message or an SENB MODIFICATION REQUEST REJECT message or an SGNB MODIFICATION REQUEST ACKNOWLEDGE message or an SGNB MODIFICATION REQUEST REJECT message or an SENB MODIFICATION CONFIRM message or an SENB MODIFICATION REFUSE message or an SGNB MODIFICATION CONFIRM message or an SGNB MODIFICATION REFUSE message of X2; or the third message may also be an S-NODE MODIFICATION REQUEST ACKNOWLEDGE message or an S-NODE MODIFICATION REQUEST REJECT message or an S-NODE MODIFICATION CONFIRM message or an S-NODE MODIFICATION REFUSE message of Xn; or the third message may also be a PATH SWITCH REQUEST ACKNOWLEDGE message or a PATH SWITCH REQUEST FAILURE message of NG; or the third message may also be a newly defined X2 or Xn or NG message.

In some implementations, the third message (e.g., the information indicating that the prediction cannot be performed or the prediction fails and/or information related thereto) may include one or more of the following (or include information or parameters or fields on (or indicating) each of the one or more of the following):

UE ID: it is used to identify the UE for which the measurement report prediction is required. For example, the identification may include one or more of an NG-RAN node UE XnAP ID, a Source NG-RAN node UE XnAP ID, an M-NG-RAN node UE XnAP ID, an S-NG-RAN node UE XnAP ID, an MeNB UE X2AP ID, an SeNB UE X2AP ID, an MeNB UE X2AP ID, an SgNB UE X2AP ID, an AMF UE NGAP ID, a RAN UE NGAP ID, or a Source AMF UE NGAP ID.

First Node ID: it is used to identify the first node. For example, the identification may include one or more of a Cell Global ID, a Target Cell Global ID and a Requested Target Cell ID.

Second Node ID: it is used to identify the second node. For example, the identification may include one or more of a Cell Global ID, a Target Cell Global ID and a Requested Target Cell ID.

Prediction Request Content Confirmation: it is used to indicate whether prediction of the measurement report can be performed. In an example, whether the prediction can be performed may be indicated by a single bit; for example, the bit of “1” indicates that all of the requested content(s) can be predicted, and the bit of “0” indicates that the requested content(s) cannot be predicted. In another example, the prediction of the request content(s) may also be confirmed one by one by a plurality of bits, for example, in a form of bitmap, where each bit corresponds to the confirmation of one prediction content; for example, the bit of “1” indicates that the predicted measurement report information of a corresponding prediction content can be transmitted, and the bit of “0” indicates that the predicted measurement report information of the corresponding prediction content cannot be transmitted. In still another example, separate fields may also be used to indicate the confirmation of different prediction contents.

Cause: it is used to indicate a cause for the failure of the request (for example, the first request), such as measurement report prediction failure, no prediction ability, no measurement report prediction ability, insufficient data, etc.

According to some embodiments of the disclosure, a method for supporting data collection and processing may include receiving, by a first node, a feedback result (in embodiments of the disclosure, it may be referred to as a first feedback result) of suggested candidate target cell(s) (or simply referred to as target cell(s)) for a UE from a second node, so that reference information is provided for the first node and/or other nodes to perform at least one of target node selection, handover execution condition setting, determination of whether to perform handover, or determination of a handover timing for the UE. In this way, by performing change/handover of a cell (or node) of the UE in consideration of the result of the suggested candidate target cell(s) for the UE, it may be possible to avoid situations such as too many candidate target nodes, inaccurate candidate target nodes, handover failure, handover ping-pong, etc.

In some implementations, the first node may transmit a fifth message including a feedback request (in embodiments of the disclosure, it may be referred to as a second request) for providing the suggested candidate target cell(s) for the UE to the second node, so as to inform the second node of a feedback requirement for the suggested candidate target cell(s) for the UE. After receiving the fifth message, the second node needs to report information (e.g., the first feedback result) of the suggested candidate target cell(s) for the UE to the first node according to the feedback requirement (e.g., based on the second request), so that the first node may obtain the target cell(s) suggested by the second node for the UE, and thus reference information is provided for the first node and/or other nodes to perform target node selection, handover execution condition setting, determination of whether to perform handover, and determination of a handover timing, etc. for the UE, thereby avoiding situations such as too many candidate target nodes, inaccurate candidate target nodes, handover failure, handover ping-pong, etc.

In some examples, the second node may determine information on the suggested candidate target cell(s) based on a predefined or predetermined method (e.g., a non-artificial intelligence method and/or a non-machine learning method). Alternatively, the second node may obtain the information on the suggested candidate target cell(s) by prediction, and in this case, the information on the suggested candidate target cell(s) obtained by prediction may be the result of the prediction. For example, the information on the suggested candidate target cell(s) may be obtained by prediction by using a machine learning model, which will be described in detail later.

In some implementations, the target cell may be a cell, a master cell, a secondary cell, a primary cell, a primary secondary cell, etc.

In some implementations, the first node may be one of a gNB, a gNB CU-CP, an en-gNB, an eNB, or an ng-eNB.

In some implementations, the second node may be one of a gNB, a gNB CU-CP, an en-gNB, an eNB, or an ng-eNB.

In some examples, in a dual connectivity scenario in which a master node and a secondary node are connected with the UE, when handover occurs, the second node may be a master node, and the first node may be a source secondary node or a target secondary node changed from the source secondary node. In some other examples, the first node may be a master node and the second node may be a source secondary node.

In some implementations, the feedback request for the suggested candidate target cell(s) (e.g., the second request) may be carried by any suitable message (existing message or newly defined message) over any suitable interface (e.g., X2 interface, Xn interface, S1 interface, or NG interface). For example, the fifth message carrying the feedback request for the suggested candidate target cell(s) (e.g., the second request) may be an SENB RELEASE REQUEST message or an SGNB RELEASE REQUEST message of X2; for example, the fifth message may also be an S-NODE RELEASE REQUEST message of Xn; for example, the fifth message may also be a HANDOVER REQUEST ACKNOWLEDGE message or a RETRIEVE UE CONTEXT REQUEST message or a HANDOVER SUCCESS message of X2 or Xn; for example, the fifth message may also be an SENB MODIFICATION REQUEST message or an SGNB MODIFICATION REQUEST message or an SENB MODIFICATION REQUIRED message or an SGNB MODIFICATION REQUIRED message of X2; for example, the fifth message may also be an S-NODE MODIFICATION REQUEST message or an S-NODE MODIFICATION REQUIRED message of Xn; for example, the fifth message may also be a HANDOVER COMMAND message or a HANDOVER PREPARATION FAILURE message or a HANDOVER REQUEST ACKNOWLEDGE message or a HANDOVER NOTIFY message or a HANDOVER SUCCESS message or a PATH SWITCH REQUEST message of NG; for example, the fifth message may also be a newly defined X2 or Xn or NG message.

In some implementations, the fifth message (e.g., the second request and/or information related thereto) may include one or more of the following (or include information or parameters or fields on (or indicating) each of the one or more of the following):

UE ID: it is used to identify the UE for which the suggested target cell needs to be provided. For example, the UE ID may include one or more of an NG-RAN node UE XnAP ID, a Source NG-RAN node UE XnAP ID, an M-NG-RAN node UE XnAP ID, an S-NG-RAN node UE XnAP ID, an MeNB UE X2AP ID, an SeNB UE X2AP ID, an MeNB UE X2AP ID, an SgNB UE X2AP ID, an AMF UE NGAP ID, a RAN UE NGAP ID, or a Source AMF UE NGAP ID.

First Node ID: it is used to identify a node transmitting the request. For example, the first node ID may include one or more of a Cell Global ID, a Target Cell Global ID and a Requested Target Cell ID.

Second Node ID: it is used to identify a node receiving the request. For example, the second node ID may include one or more of a Cell Global ID, a Target Cell Global ID and a Requested Target Cell ID.

Handover Time: it is used to indicate a time point when the UE performs handover. For example, the time may be a relative time or an absolute time.

Prediction Identification: it is used to indicate whether a request for prediction of the suggested target cell(s) or a request for prediction is included. The information (e.g., field) may be indicated by a single bit, for example, a value (e.g., bit) of “1” may be used to indicate that the request is the request for prediction of the suggested target cell(s), and a value (e.g., bit) of “0” may be used to indicate that the request is not the request for prediction of the suggested target cell(s); or a value (e.g., bit) of “1” may be used to indicate that the request is the request for prediction, and a value (e.g., bit) of “0” may be used to indicate that the request is not the request for prediction.

Registration Request: it is used to indicate a start, end, addition, etc. of the reporting of the suggested target cell(s).

Prediction Registration Request: it is used to indicate a start, end, addition, etc. of the prediction of the suggested target cell(s).

Prediction Time Interval: it is used to indicate a time interval (time period or time span) for the prediction. The prediction time interval may be indicated by 2*n bits, for example, the first n bits indicate a prediction start time and the last n bits indicate a prediction end time, where n may be a positive integer. For example, the time may be a relative time or an absolute time. Alternatively, the prediction time interval may be indicated by separate fields, including one or more of the following:

Prediction Start Time: it is used to indicate a start time of the prediction. For example, the start time may be a relative time or an absolute time.

Prediction End Time: it is used to indicate an end time of the prediction. For example, the end time may be a relative time or an absolute time.

Result Reporting Type: it is used to indicate a reporting type of a result of the suggested target cell(s) (e.g., a non-predicted result of the suggested target cell(s) or a result of the suggested target cell(s) obtained based on a predefined or predetermined method (e.g., a non-artificial intelligence method and/or a non-machine learning method)). For example, the result reporting type may be used to indicate whether the result of the suggested target cell(s) is reported aperiodically (for example, reported once or reported sporadically) or reported periodically. For example, the reporting type may include, but is not limited to, an on-demand type, a periodic type, etc.

Prediction Result Reporting Type: it is used to indicate a reporting type of a prediction result of the suggested target cell(s). For example, the prediction result reporting type may be used to indicate whether the prediction result of the suggested target cell(s) is reported aperiodically (for example, reported once or reported sporadically) or reported periodically. For example, the reporting type may include, but is not limited to, an on-demand type, a periodic type, etc.

Result Reporting Period: it is used to indicate a time interval of periodic reporting of the result of the suggested target cell(s). For example, if there is no such information (e.g., field), it indicates that a single report is enough.

Prediction Result Reporting Period: it is used to indicate a time interval of periodic reporting of the prediction result of the suggested target cell(s). For example, the reporting period may also be the prediction time of the data reported this time. For example, if there is no such information (e.g., field), it indicates that a single report is enough, where the prediction time of the single report is from the prediction start time to the prediction end time.

Reporting Trigger Condition: it is used to indicate a trigger condition under which the suggested target cell(s) (for example, the first feedback result) needs to be reported. It needs to be reported only when the prediction result or actual situation meets the trigger condition (for example, the measurement report value abruptly increases or drops, the measurement report value changes in a ping-pong way, etc.). For example, the measurement report value may include at least one of a Reference Signal Receiving Power (RSRP), a Reference Signal Receiving Quality (RSRQ), and a Signal to Interference plus Noise Ratio (SINR), etc.

Prediction Type: it is used to indicate a type of prediction that needs to be performed for the suggested target cell(s). For example, the prediction type may include, but is not limited to, the suggested target cell(s), etc.

In some implementations, the second node may transmit a fourth message including a result of the suggested target cell(s) (for example, the first feedback result) to the first node according to its own situation and/or according to a request for the suggested target cell(s) (for example, the second request) transmitted by the first node, so that the first node may obtain the result of the target cell(s) suggested by the second node for the UE, and thus reference information is provided for the first node and/or other nodes to perform target node selection, handover execution condition setting, determination of whether to perform handover, and determination of a handover timing, etc. for the UE, thereby avoiding situations such as too many candidate target nodes, inaccurate candidate nodes, handover failure, handover ping-pong, etc.

In some examples, the result of the suggested target cell(s) (for example, the first feedback result) may be carried by any suitable message (existing message or newly defined message) over any suitable interface (e.g., X2 interface, Xn interface, S1 interface, or NG interface). For example, the fourth message carrying the result of the suggested target cell(s) (for example, the first feedback result) may be an SGNB RELEASE REQUEST ACKNOWLEDGE message or an SENB ADDITION REQUEST message or an SGNB ADDITION REQUEST message or an SGNB CHANGE REQUIRED message of X2; or the fourth message may also be an S-NODE RELEASE REQUEST ACKNOWLEDGE message or an S-NODE ADDITION REQUEST message or an S-NODE CHANGE REQUIRED message of Xn; or the fourth message may also be a HANDOVER REQUEST message or a RETRIEVE UE CONTEXT RESPONSE message or a RETRIEVE UE CONTEXT FAILURE message of X2 or Xn; or the fourth message may also be an SENB MODIFICATION REQUEST ACKNOWLEDGE message or an SENB MODIFICATION REQUEST REJECT message or an SGNB MODIFICATION REQUEST ACKNOWLEDGE message or an SGNB MODIFICATION REQUEST REJECT message or an SENB MODIFICATION CONFIRM message or an SENB MODIFICATION REFUSE message or an SGNB MODIFICATION CONFIRM message or an SGNB MODIFICATION REFUSE message of X2; or the fourth message may also be an S-NODE MODIFICATION REQUEST ACKNOWLEDGE message or an S-NODE MODIFICATION REQUEST REJECT message or an S-NODE MODIFICATION CONFIRM message or an S-NODE MODIFICATION REFUSE message of Xn; or the fourth message may also be a PATH SWITCH REQUEST ACKNOWLEDGE message or a PATH SWITCH REQUEST FAILURE message of NG; or the fourth message may also be a newly defined X2 or Xn or NG message.

In some examples, the fourth message (e.g., the first feedback result and/or information related thereto) may include one or more of the following (or include information or parameters or fields on (or indicating) each of the one or more of the following):

UE ID: it is used to identify the UE for which the suggested target cell(s) is provided. For example, the UE ID may include one or more of an NG-RAN node UE XnAP ID, a Source NG-RAN node UE XnAP ID, an M-NG-RAN node UE XnAP ID, an S-NG-RAN node UE XnAP ID, an MeNB UE X2AP ID, an SeNB UE X2AP ID, an MeNB UE X2AP ID, an SgNB UE X2AP ID, an AMF UE NGAP ID, a RAN UE NGAP ID, or a Source AMF UE NGAP ID.

First Node ID: it is used to identify the first node. For example, the first node ID may include one or more of a Cell Global ID, a Target Cell Global ID and a Requested Target Cell ID.

Second Node ID: it is used to identify the second node. For example, the second node ID may include one or more of a Cell Global ID, a Target Cell Global ID and a Requested Target Cell ID.

Prediction Identification of Prediction Content: it is used to indicate whether information of the suggested target cell(s) is a prediction content, for example, whether it is obtained by prediction. The information (e.g., field) may be indicated by a single bit, for example, a value (e.g., bit) of “1” may be used to indicate that the information is a prediction content, and a value (e.g., bit) of “0” may be used to indicate that the information is an actual state content.

Handover Time: it is used to indicate a time point when the UE performs handover. For example, the time may be a relative time or an absolute time.

Request Content Confirmation: it is used to indicate whether the suggested target cell(s) can be fed back based on the second request. In an example, whether the suggested cell can be fed back according to the request may be indicated by a single bit; for example, the bit of “1” indicates that all of the requested content(s) can be fed back, and the bit of “0” indicates that the requested content(s) cannot be fed back. In another example, the requested content(s) may also be confirmed one by one by a plurality of bits, for example, in a form of bitmap, where each bit corresponds to one requested content; for example, the bit of “1” indicates that information of the suggested target cell(s) of the corresponding requested content can be transmitted, and the bit of “0” indicates that the information of the suggested target cell(s) of the corresponding requested content cannot be transmitted. In still another example, separate fields may also be used to indicate the confirmation of different request contents.

Prediction Request Content Confirmation: it is used to indicate whether prediction of the suggested target cell(s) can be performed. In an example, whether the prediction can be performed may be indicated by a single bit; for example, the bit of “1” indicates that all of the requested content(s) can be predicted, and the bit of “0” indicates that the requested content(s) cannot be predicted. In another example, the prediction of the request content(s) may also be confirmed one by one by a plurality of bits, for example, in a form of bitmap, where each bit corresponds to the confirmation of one prediction content; for example, the bit of “1” indicates that information of the predicted suggested target cell of the corresponding prediction content can be transmitted, and the bit of “0” indicates that information of the predicted suggested target cell of the corresponding prediction content cannot be transmitted. In still another example, separate fields may also be used to indicate the confirmation of different prediction contents.

Prediction Time Interval: it is used to indicate a prediction time interval (time period or time span) to which the prediction data of the suggested target cell(s) is applicable. For example, the prediction time interval may be indicated by 2*n bits, for example, the first n bits indicate a prediction start time and the last n bits indicate a prediction end time, where n may be a positive integer. For example, the time may be a relative time or an absolute time. Alternatively, the prediction time interval may be indicated by separate fields, including one or more of the following:

Prediction Start Time: it is used to indicate a start time of the prediction. For example, the start time may be a relative time or an absolute time.

Prediction End Time: it is used to indicate an end time of the prediction. For example, the end time may be a relative time or an absolute time.

Prediction Type: it is used to indicate a type of prediction of the suggested target cell(s). For example, the prediction type includes, but is not limited to, a prediction of the suggested target cell(s), etc.

Predicted Cell Identification: it is used to indicate the suggested target cells (for example, a suggested handover target cell) for the UE by prediction. For example, the predicted cell identification may indicate one or more of a cell, a master cell, a secondary cell, a primary cell, a primary secondary cell, etc. For example, the predicted cell identification may be a Physical Cell Identifier, or a Global NG-RAN cell identity, etc.

In some implementations, if the second node cannot feed back the result of the suggested target cell(s) to the first node according to the request for the suggested target cell(s) transmitted by the first node, the second node transmits a sixth message including information indicating that the feedback cannot be performed to the first node, so that the first node knows that the second node cannot feed back according to the request.

In some implementations, the information indicating that the feedback cannot be performed may be carried by any suitable message (existing message or newly defined message) over any suitable interface (e.g., X2 interface, Xn interface, S1 interface, or NG interface). In some examples, the sixth message carrying the information indicating that the feedback cannot be performed may be an SGNB RELEASE REQUEST ACKNOWLEDGE message or an SGNB RELEASE REQUEST REJECT message or an SENB ADDITION REQUEST message or an SGNB ADDITION REQUEST message or an SGNB CHANGE REQUIRED message of X2; or the sixth message may also be an S-NODE RELEASE REQUEST ACKNOWLEDGE message or an S-NODE RELEASE REJECT message or an S-NODE ADDITION REQUEST message or an S-NODE CHANGE REQUIRED message of Xn; or the sixth message may also be a RETRIEVE UE CONTEXT RESPONSE message or a RETRIEVE UE CONTEXT FAILURE message of X2 or Xn; or the sixth message may also be an SENB MODIFICATION REQUEST ACKNOWLEDGE message or an SENB MODIFICATION REQUEST REJECT message or an SGNB MODIFICATION REQUEST ACKNOWLEDGE message or an SGNB MODIFICATION REQUEST REJECT message or an SENB MODIFICATION CONFIRM message or an SENB MODIFICATION REFUSE message or an SGNB MODIFICATION CONFIRM message or an SGNB MODIFICATION REFUSE message of X2; or the sixth message may also be an S-NODE MODIFICATION REQUEST ACKNOWLEDGE message or an S-NODE MODIFICATION REQUEST REJECT message or an S-NODE MODIFICATION CONFIRM message or an S-NODE MODIFICATION REFUSE message of Xn; or the sixth message may also be a PATH SWITCH REQUEST ACKNOWLEDGE message or a PATH SWITCH REQUEST FAILURE message of NG; or the sixth message may also be a newly defined X2 or Xn or NG message.

In some examples, the sixth message (e.g., the information indicating that the feedback cannot be performed and/or information related thereto) may include one or more of the following (or include information or parameters or fields on (or indicating) each of the one or more of the following):

UE ID: it is used to identify the UE for which the suggested target cell(s) needs to be provided. For example, the UE ID may include one or more of an NG-RAN node UE XnAP ID, a Source NG-RAN node UE XnAP ID, an M-NG-RAN node UE XnAP ID, an S-NG-RAN node UE XnAP ID, an MeNB UE X2AP ID, an SeNB UE X2AP ID, an MeNB UE X2AP ID, an SgNB UE X2AP ID, an AMF UE NGAP ID, a RAN UE NGAP ID, or a Source AMF UE NGAP ID.

First Node ID: it is used to identify the first node. For example, the first node ID may include one or more of a Cell Global ID, a Target Cell Global ID and a Requested Target Cell ID.

Second Node ID: it is used to identify the second node. For example, the second node ID may include one or more of a Cell Global ID, a Target Cell Global ID and a Requested Target Cell ID.

Request Content Confirmation: it is used to indicate whether the suggested target cell(s) can be fed back based on the second request. In an example, whether the suggested cell can be fed back according to the request may be indicated by a single bit; for example, the bit of “1” indicates that all of the requested content(s) can be fed back, and the bit of “0” indicates that the requested content(s) cannot be fed back. In another example, the requested content(s) may also be confirmed one by one by a plurality of bits, for example, in a form of bitmap, where each bit corresponds to one requested content; for example, the bit of “1” indicates that information of the suggested target cell(s) of the corresponding requested content can be transmitted, and the bit of “0” indicates that the information of the suggested target cell(s) of the corresponding requested content cannot be transmitted. In still another example, separate fields may also be used to indicate the confirmation of different request contents.

Prediction Request Content Confirmation: it is used to indicate whether prediction of the suggested target cell(s) can be performed. In an example, whether the prediction can be performed may be indicated by a single bit; for example, the bit of “1” indicates that all of the requested content(s) can be predicted, and the bit of “0” indicates that the requested content(s) cannot be predicted. In another example, the prediction of the request content(s) may also be confirmed one by one by a plurality of bits, for example, in a form of bitmap, where each bit corresponds to the confirmation of one prediction content; for example, the bit of “1” indicates that information of the predicted suggested target cell of the corresponding prediction content can be transmitted, and the bit of “0” indicates that information of the predicted suggested target cell of the corresponding prediction content cannot be transmitted. In still another example, separate fields may also be used to indicate the confirmation of different prediction contents.

Cause: it is used to indicate a cause for the failure of the request, for example, prediction failure of the suggested target cell(s), the suggested target cell(s) cannot be obtained, no prediction ability, no prediction ability of suggested target cell, insufficient data, no ability of suggested target cell, etc.

According to some embodiments of the disclosure, a method for supporting data collection and processing may include receiving, by a first node, a feedback result (in embodiments of the disclosure, it may be referred to as a second feedback result) of suggested handover execution condition(s) for a UE from a second node, so that reference information is provided for the first node and/or other nodes to perform at least one of target node selection, handover execution condition setting, determination of whether to perform handover, or determination of a handover timing for the UE. In this way, by performing change/handover of a cell (or node) of the UE in consideration of the feedback result of the suggested handover execution condition(s) for the UE, it may be possible to avoid situations such as too many candidate target nodes, inaccurate candidate target nodes, handover failure, handover ping-pong, etc.

In some implementations, the first node may transmit an eighth message including a feedback request for suggested execution condition(s) for the UE (in embodiments of the disclosure, it may be referred to as a third request) to the second node, so as to inform the second node of a feedback requirement for the suggested execution condition(s) for the UE. After receiving the message, the second node needs to report information of the suggested execution condition(s) for the UE to the first node according to the feedback requirement (for example, based on the third request), so that the first node may obtain the result of setting(s) of the suggested execution condition(s) for the UE by the second node, and thus reference information is provided for the first node and/or other nodes to perform handover execution condition setting, target node selection, determination of whether to perform handover, and determination of a handover timing, etc. for the UE, thereby reducing inaccuracy of the handover execution condition, handover failure, handover ping-pong, etc.

In some examples, the second node may determine information on setting(s) of the suggested execution condition(s) based on a predefined or predetermined method (e.g., a non-artificial intelligence method and/or a non-machine learning method). Alternatively, the second node may obtain the information on the setting(s) of the suggested execution condition(s) by prediction, and in this case, the information on the setting(s) of the suggested execution condition(s) obtained by prediction may be the result of the prediction. For example, the information on the setting(s) of the suggested execution condition(s) may be predicted by using a machine learning model, which will be described in detail later.

In some implementations, the first node may be one of a gNB, a gNB CU-CP, an en-gNB, an eNB, or an ng-eNB.

In some implementations, the second node may be one of a gNB, a gNB CU-CP, an en-gNB, an eNB, or an ng-eNB.

In some examples, in a dual connectivity scenario in which a master node and a secondary node are connected with the UE, when handover occurs, the second node may be a master node, and the first node may be a source secondary node or a target secondary node changed from the source secondary node. In some other examples, the first node may be a master node and the second node may be a source secondary node.

In some implementations, the feedback request for the suggested handover execution condition(s) for the UE (in embodiments of the disclosure, it may be referred to as the third request) may be carried by any suitable message (existing message or newly defined message) over any suitable interface (e.g., X2 interface, Xn interface, S1 interface, or NG interface). The eighth message carrying the feedback request for the suggested handover execution condition(s) for the UE (e.g., the third request) may be an SENB RELEASE REQUEST message or an SGNB RELEASE REQUEST message of X2; or the eighth message may also be an S-NODE RELEASE REQUEST message of Xn; or the eighth message may also be a HANDOVER REQUEST ACKNOWLEDGE message or a RETRIEVE UE CONTEXT REQUEST message or a HANDOVER SUCCESS message of X2 or Xn; or the eighth message may also be an SENB MODIFICATION REQUEST message or an SGNB MODIFICATION REQUEST message or an SENB MODIFICATION REQUIRED message or an SGNB MODIFICATION REQUIRED message of X2; or the eighth message may also be an S-NODE MODIFICATION REQUEST message or an S-NODE MODIFICATION REQUIRED message of Xn; or the eighth message may also be a HANDOVER COMMAND message or a HANDOVER PREPARATION FAILURE message or a HANDOVER REQUEST ACKNOWLEDGE message or a HANDOVER NOTIFY message or a HANDOVER SUCCESS message or a PATH SWITCH REQUEST message of NG; or the eighth message may also be a newly defined X2 or Xn or NG message.

In some examples, the eighth message (e.g., the third request) may include one or more of the following (or include information or parameters or fields on (or indicating) each of the one or more of the following):

UE ID: it is used to identify the UE for which information of the suggested execution condition(s) needs to be provided. For example, the UE ID may include one or more of an NG-RAN node UE XnAP ID, a Source NG-RAN node UE XnAP ID, an M-NG-RAN node UE XnAP ID, an S-NG-RAN node UE XnAP ID, an MeNB UE X2AP ID, an SeNB UE X2AP ID, an MeNB UE X2AP ID, an SgNB UE X2AP ID, an AMF UE NGAP ID, a RAN UE NGAP ID, or a Source AMF UE NGAP ID.

First Node ID: it is used to identify a node transmitting the request (for example, the third request). For example, the first node ID may include one or more of a Cell Global ID, a Target Cell Global ID and a Requested Target Cell ID.

Second Node ID: it is used to identify a node receiving the request (for example, the third request). For example, the second node ID may include one or more of a Cell Global ID, a Target Cell Global ID and a Requested Target Cell ID.

Handover Time: it is used to indicate a time point when the UE performs handover. For example, the time may be a relative time or an absolute time.

Prediction Identification: it is used to indicate whether a request for prediction of the suggested execution condition(s) or a request for prediction is included. The information (e.g., field) may be indicated by a single bit, for example, a value (e.g., bit) of “1” may be used to indicate that the request is the request for prediction of the suggested execution condition(s), and a value (e.g., bit) of “0” may be used to indicate that the request is not the request for prediction of the suggested execution condition(s); or a value (e.g., bit) of “1” may be used to indicate that the request is the request for prediction, and a value (e.g., bit) of “0” may be used to indicate that the request is not the request for prediction.

Registration Request: it is used to indicate a start, end, addition, etc. of the feedback of the suggested execution condition(s).

Prediction Registration Request: it is used to indicate a start, end, addition, etc. of the prediction of the suggested execution condition(s).

Prediction Time Interval: it is used to indicate a time interval (time period or time span) for the prediction. The prediction time interval may be indicated by 2*n bits, for example, the first n bits indicate a prediction start time and the last n bits indicate a prediction end time, where n may be a positive integer. For example, the time may be a relative time or an absolute time. Alternatively, the prediction time interval may be indicated by separate fields, including one or more of the following:

Prediction Start Time: it is used to indicate a start time of the prediction. For example, the start time may be a relative time or an absolute time.

Prediction End Time: it is used to indicate an end time of the prediction. For example, the end time may be a relative time or an absolute time.

Result Reporting Type: it is used to indicate a reporting type of a result of the suggested execution condition(s) (e.g., a non-predicted result of the suggested execution condition(s) or a result of the suggested execution condition(s) obtained based on a predefined or predetermined method (e.g., a non-artificial intelligence method and/or a non-machine learning method)). For example, the result reporting type may be used to indicate whether the result of the suggested execution condition(s) is reported aperiodically (for example, reported once or reported sporadically) or reported periodically. For example, the reporting type may include, but is not limited to, an on-demand type, a periodic type, etc.

Prediction Result Reporting Type: it is used to indicate a reporting type of the prediction result of the suggested execution condition(s). For example, the prediction result reporting type may be used to indicate whether the prediction result of the suggested execution condition(s) is reported aperiodically (for example, reported once or reported sporadically) or reported periodically. For example, the reporting type may include, but is not limited to, an on-demand type, a periodic type, etc.

Result Reporting Period: it is used to indicate a time interval of periodic reporting of the result of the suggested execution condition(s). For example, if there is no such information (e.g., field), it indicates that a single report is enough.

Prediction Result Reporting Period: it is used to indicate a time interval of periodic reporting of the prediction result of the suggested execution condition(s). For example, the reporting period may also be the prediction time of the data reported this time. For example, if there is no such information (e.g., field), it indicates that a single report is enough, and the prediction time of the single report is from the prediction start time to the prediction end time.

Reporting Trigger Condition: it is used to indicate a trigger condition under which reporting is needed. For example, it needs to be reported only when the prediction result or actual situation meets the trigger condition (for example, the measurement report value abruptly increases or drops, the measurement report value changes in a ping-pong way, etc.). For example, the measurement report value may include at least one of a Reference Signal Receiving Power (RSRP), a Reference Signal Receiving Quality (RSRQ), and a Signal to Interference plus Noise Ratio (SINR), etc.

Prediction Type: it is used to indicate a type of prediction that needs to be performed for the suggested execution condition(s). For example, the prediction type includes, but is not limited to, a prediction of the suggested execution condition(s), etc.

Prediction Content: it is used to indicate parameters that need to be predicted. For example, the parameters to be predicted may include one or more of suggested execution condition(s), a prediction accuracy, etc.

Identification of a cell for prediction: it is used to indicate a cell in which the prediction needs to be performed for the UE. For example, the cell identification may indicate one or more of a cell, a master cell, a secondary cell, a primary cell, a primary secondary cell, etc. For example, the identification may be a Physical Cell Identifier, or a Global NG-RAN Cell Identity, etc.

In some implementations, the second node may transmit a seventh message including the result of the suggested execution condition(s) to the first node according to its own situation and/or according to the feedback request for the suggested execution condition(s) transmitted by the first node, so that the first node may obtain the result of the setting(s) of the suggested execution condition(s) for the UE by the second node, so that reference information is provided for the first node and/or other nodes to perform handover execution condition setting, target node selection, determination of whether to perform handover, and determination of a handover timing, etc. for the UE, thereby reducing inaccuracy of the execution condition setting, handover failure, handover ping-pong, etc.

In some implementations, the result of the suggested execution condition(s) may be carried by any suitable message (existing message or newly defined message) over any suitable interface (e.g., X2 interface, Xn interface, S1 interface, or NG interface). In some examples, the seventh message carrying the result of the suggested execution condition(s) may be an SGNB RELEASE REQUEST ACKNOWLEDGE message or an SENB ADDITION REQUEST message or an SENB ADDITION REQUEST ACKNOWLEDGE message or an SGNB ADDITION REQUEST message or an SGNB ADDITION REQUEST ACKNOWLEDGE message or an SGNB CHANGE REQUIRED message of X2; or the seventh message may also be an S-NODE RELEASE REQUEST ACKNOWLEDGE message or an S-NODE ADDITION REQUEST message or an S-NODE RELEASE REQUEST ACKNOWLEDGE message or an S-NODE CHANGE REQUIRED message of Xn; or the seventh message may also be a HANDOVER REQUEST message or a RETRIEVE UE CONTEXT RESPONSE message or a RETRIEVE UE CONTEXT FAILURE message of X2 or Xn; or the seventh message may also be an SENB MODIFICATION REQUEST ACKNOWLEDGE or an SENB MODIFICATION REQUEST REJECT message or an SGNB MODIFICATION REQUEST ACKNOWLEDGE message or an SGNB MODIFICATION REQUEST REJECT message or an SENB MODIFICATION CONFIRM message or an SENB MODIFICATION REFUSE message or an SGNB MODIFICATION CONFIRM message or an SGNB MODIFICATION REFUSE message of X2; or the seventh message may also be an S-NODE MODIFICATION REQUEST ACKNOWLEDGE message or an S-NODE MODIFICATION REQUEST REJECT message or an S-NODE MODIFICATION CONFIRM message or an S-NODE MODIFICATION REFUSE message of Xn; or the seventh message may also be a PATH SWITCH REQUEST ACKNOWLEDGE message or a PATH SWITCH REQUEST FAILURE message of NG; or the seventh message may also be a newly defined X2 or Xn or NG message.

In some examples, the seventh message (e.g., the result of the suggested execution condition(s) and/or information related thereto) may include one or more of the following (or include information or parameters or fields on (or indicating) each of the one or more of the following):

UE ID: it is used to identify the UE for which information of the suggested execution condition(s) is provided. For example, the UE ID may include one or more of an NG-RAN node UE XnAP ID, a Source NG-RAN node UE XnAP ID, an M-NG-RAN node UE XnAP ID, an S-NG-RAN node UE XnAP ID, an MeNB UE X2AP ID, an SeNB UE X2AP ID, an MeNB UE X2AP ID, an SgNB UE X2AP ID, an AMF UE NGAP ID, a RAN UE NGAP ID, or a Source AMF UE NGAP ID.

First Node ID: it is used to identify the first node. For example, the first node ID may include one or more of a Cell Global ID, a Target Cell Global ID and a Requested Target Cell ID.

Second Node ID: it is used to identify the second node. For example, the second node ID may include one or more of a Cell Global ID, a Target Cell Global ID and a Requested Target Cell ID.

Prediction Identification of Prediction Content: it is used to indicate whether the information of the suggested execution condition(s) is a prediction content. The information (e.g., field) may be indicated by a single bit, for example, a value (e.g., bit) of “1” may be used to indicate that the information is a prediction content, and a value (e.g., bit) of “0” may be used to indicate that the information is an actual state content.

Handover Time: it is used to indicate a time point when the UE performs handover. For example, the time may be a relative time or an absolute time.

Request Content Confirmation: it is used to indicate whether the suggested handover execution condition(s) can be fed back based on the third request. In an example, whether the suggested handover execution condition(s) can be fed back according to the request may be indicated by a single bit; for example, the bit of “1” indicates that all of the requested content(s) can be fed back, and the bit of “0” indicates that the requested content(s) cannot be fed back. In another example, the requested content(s) may also be confirmed one by one by a plurality of bits, for example, in a form of bitmap, where each bit corresponds to one requested content; for example, the bit of “1” indicates that information of the suggested handover execution condition(s) of the corresponding requested content can be transmitted, and the bit of “0” indicates that information of the suggested handover execution condition(s) of the corresponding requested content cannot be transmitted. In still another example, separate fields may also be used to indicate the confirmation of different request contents.

Prediction Request Content Confirmation: it is used to indicate whether prediction of the suggested handover execution condition(s) can be performed. In an example, whether the prediction can be performed may be indicated by a single bit; for example, the bit of “1” indicates that all of the requested content(s) can be predicted, and the bit of “0” indicates that the requested content(s) cannot be predicted. In another example, the prediction of the request content(s) may also be confirmed one by one by a plurality of bits, for example, in a form of bitmap, where each bit corresponds to the confirmation of one prediction content; for example, the bit of “1” indicates that information of the predicted suggested handover execution condition(s) of the corresponding prediction content can be transmitted, and the bit of “0” indicates that information of the predicted suggested handover execution condition(s) of the corresponding prediction content cannot be transmitted. In still another example, separate fields may also be used to indicate the confirmation of different prediction contents.

Prediction Time Interval: it is used to indicate a prediction time interval (time period or time span) to which the prediction data of the suggested execution condition(s) is applicable. For example, the prediction time interval may be indicated by 2*n bits, for example, the first n bits indicate a prediction start time and the last n bits indicate a prediction end time, where n may be a positive integer. For example, the time may be a relative time or an absolute time. Alternatively, the prediction time interval may be indicated by separate fields, including one or more of the following:

Prediction Start Time: it is used to indicate a start time of the prediction. For example, the start time may be a relative time or an absolute time.

Prediction End Time: it is used to indicate an end time of the prediction. For example, the end time may be a relative time or an absolute time.

Prediction Type: it is used to indicate a type of prediction for the suggested execution condition(s). For example, the prediction type includes, but is not limited to, a prediction of the suggested execution condition(s), etc.

Prediction Content: it is used to indicate predicted parameters. For example, the predicted parameters may include one or more of suggested execution condition(s), a prediction accuracy, etc.

Cell Identification: it is used to indicate a cell for which the suggested execution condition(s) is set for the UE. For example, the cell identification may indicate one or more of a cell, a master cell, a secondary cell, a primary cell, a primary secondary cell, etc. For example, the identification may be a Physical Cell Identifier, or a Global NG-RAN Cell Identity, etc.

Identification of a cell for prediction: it is used to indicate a cell in which the prediction is performed for the UE. For example, the cell identification may indicate one or more of a cell, a master cell, a secondary cell, a primary cell, a primary secondary cell, etc. For example, the identification may be a Physical Cell Identifier, or a Global NG-RAN Cell Identity, etc.

In some implementations, if the second node cannot feed back the prediction result of the suggested execution condition(s) to the first node according to the request for the suggested execution condition(s) transmitted by the first node, the second node transmits a ninth message including information indicating that the suggested execution condition(s) cannot be fed back to the first node, so that the first node knows that the second node cannot perform prediction according to the request.

In some examples, the ninth message carrying the information indicating that the suggested execution condition(s) cannot be fed back may be an SGNB RELEASE REQUEST ACKNOWLEDGE message or an SGNB RELEASE REQUEST REJECT message or an SENB ADDITION REQUEST ACKNOWLEDGE message or an SGNB ADDITION REQUEST message or an SGNB ADDITION REQUEST ACKNOWLEDGE message or an SGNB CHANGE REQUIRED message of X2; or the ninth message may also be an S-NODE RELEASE REQUEST ACKNOWLEDGE message or an S-NODE RELEASE REJECT message or an S-NODE ADDITION REQUEST message or an S-NODE RELEASE REQUEST ACKNOWLEDGE message or an S-NODE CHANGE REQUIRED message of Xn; or the ninth message may also be a RETRIEVE UE CONTEXT RESPONSE message or a RETRIEVE UE CONTEXT FAILURE message of X2 or Xn; or the ninth message may also be an SENB MODIFICATION REQUEST ACKNOWLEDGE message or an SENB MODIFICATION REQUEST REJECT message or an SGNB MODIFICATION REQUEST ACKNOWLEDGE message or an SGNB MODIFICATION REQUEST REJECT message or an SENB MODIFICATION CONFIRM message or an SENB MODIFICATION REFUSE message or an SGNB MODIFICATION CONFIRM message or an SGNB MODIFICATION REFUSE message of X2; or the ninth message may also be an S-NODE MODIFICATION REQUEST ACKNOWLEDGE message or an S-NODE MODIFICATION REQUEST REJECT message or an S-NODE MODIFICATION CONFIRM message or an S-NODE MODIFICATION REFUSE message of Xn; or the ninth message may also be a PATH SWITCH REQUEST ACKNOWLEDGE message or a PATH SWITCH REQUEST FAILURE message of NG, or it may also be a newly defined X2 or Xn or NG message.

In some examples, the ninth message (e.g., information indicating that the suggested execution condition(s) cannot be fed back and/or information related thereto) may include one or more of the following (or include information or parameters or fields on (or indicating) each of the one or more of the following):

UE ID: it is used to identify the UE for which the suggested execution condition(s) information needs to be provided. For example, the UE ID may include one or more of an NG-RAN node UE XnAP ID, a Source NG-RAN node UE XnAP ID, an M-NG-RAN node UE XnAP ID, an S-NG-RAN node UE XnAP ID, an MeNB UE X2AP ID, an SeNB UE X2AP ID, an MeNB UE X2AP ID, an SgNB UE X2AP ID, an AMF UE NGAP ID, a RAN UE NGAP ID, or a Source AMF UE NGAP ID.

First Node ID: it is used to identify the first node. For example, the first node ID may include one or more of a Cell Global ID, a Target Cell Global ID and a Requested Target Cell ID.

Second Node ID: it is used to identify the second node. For example, the second node ID may include one or more of a Cell Global ID, a Target Cell Global ID and a Requested Target Cell ID.

Request Content Confirmation: it is used to indicate whether the suggested execution condition(s) can be fed back based on the third request. In an example, whether the suggested execution condition(s) can be fed back according to the request may be indicated by a single bit; for example, the bit of “1” indicates that all of the requested content(s) can be fed back, and the bit of “0” indicates that the requested content(s) cannot be fed back. In another example, the requested content(s) may also be confirmed one by one by a plurality of bits, for example, in a form of bitmap, where each bit corresponds to one requested content; for example, the bit of “1” indicates that information of the suggested execution condition(s) of the corresponding requested content can be transmitted, and the bit of “0” indicates that information of the suggested execution condition(s) of the corresponding requested content cannot be transmitted. In still another example, separate fields may also be used to indicate the confirmation of different request contents.

Prediction Request Content Confirmation: it is used to indicate whether prediction of the suggested execution condition(s) can be performed. In an example, whether the prediction can be performed may be indicated by a single bit; for example, the bit of “1” indicates that all of the requested content(s) can be predicted, and the bit of “0” indicates that the requested content(s) cannot be predicted. In another example, the prediction of the request content(s) may also be confirmed one by one by a plurality of bits, for example, in a form of bitmap, where each bit corresponds to the confirmation of one prediction content; for example, the bit of “1” indicates that information of the predicted suggested execution condition(s) of the corresponding prediction content can be transmitted, and the bit of “0” indicates that information of the predicted suggested execution condition(s) of the corresponding prediction content cannot be transmitted. In still another example, separate fields may also be used to indicate the confirmation of different prediction contents.

Cause: it is used to indicate a cause for the failure of the request, for example, prediction failure of the suggested execution condition(s), the suggested execution condition(s) cannot be obtained, no prediction ability, no prediction ability of suggested execution condition(s), insufficient data, no ability of suggested execution condition(s) setting, etc.

According to some embodiments of the disclosure, a method for supporting data collection and processing may include receiving, by a first node, an eleventh message including a result of prediction of a packet data convergence protocol (PDCP) Sequence Number (PDCP Sequence Number) for a UE (in embodiments of the disclosure, it may be referred to as a second prediction result) from a second node, where it includes a prediction of the PDCP sequence number for data forwarding of the UE, a prediction of the PDCP sequence number for data transmission of the UE, a prediction of a changing trend of the PDCP sequence number for data transmission of the UE, etc., so as to provide reference for setting data forwarding amount when the second node and/or the first node performs data forwarding for the UE. In this way, by setting the data forwarding amount in consideration of the prediction result of PDCP sequence number for the UE, the forwarding amount of unnecessary data can be reduced.

In some implementations, the first node transmits an eleventh message including a request for predicting the PDCP sequence number for the UE (in embodiments of the disclosure, it may be referred to as a fourth request) to the second node, so as to inform the second node of a feedback requirement for the prediction of the PDCP sequence number for the UE. After receiving the eleventh message, the second node needs to perform prediction of the PDCP sequence number for the UE according to the feedback requirement, and/or report the prediction result of the PDCP sequence number for the UE to the first node, so that the first node may obtain the result of the PDCP sequence number predicted by the second node for the UE, so as for the second node and/or the first node to accurately set the data forwarding amount when performing data forwarding for the UE, thereby reducing the forwarding amount of unnecessary data.

In some implementations, the first node may be one of a gNB, a gNB CU (Central Unit)-CP (Control Plane), an en-gNB, an eNB, or an ng-eNB.

In some implementations, the second node may be one of a gNB, a gNB CU-CP, an en-gNB, an eNB, or an ng-eNB.

In some examples, in a dual connectivity scenario in which a master node and a secondary node are connected with the UE, when handover occurs, the second node may be a master node, and the first node may be a source secondary node or a target secondary node changed from the source secondary node. In some other examples, the first node may be a master node and the second node may be a source secondary node.

In some implementations, the request for predicting the PDCP sequence number for the UE (e.g., the fourth request) may be carried by any suitable message (existing message or newly defined message) over any suitable interface (e.g., X2 interface, Xn interface, S1 interface, or NG interface). In some examples, the eleventh message carrying the fourth request may be an SENB RELEASE REQUEST message or an SGNB RELEASE REQUEST message or an SGNB RELEASE REQUEST ACKNOWLEDGE message of X2; or the eleventh message may also be an S-NODE RELEASE REQUEST message or an S-NODE RELEASE REQUEST ACKNOWLEDGE message of Xn; or the eleventh message may also be a HANDOVER REQUEST ACKNOWLEDGE message or a RETRIEVE UE CONTEXT REQUEST message or a HANDOVER SUCCESS message of X2 or Xn; or the eleventh message may also be an SENB MODIFICATION REQUEST message or an SGNB MODIFICATION REQUEST message or an SENB MODIFICATION REQUIRED message or an SGNB MODIFICATION REQUIRED message of X2; or the eleventh message may also be an S-NODE MODIFICATION REQUEST message or an S-NODE MODIFICATION REQUIRED message of Xn; or the eleventh message may also be a HANDOVER COMMAND message or a HANDOVER PREPARATION FAILURE message or a HANDOVER REQUEST ACKNOWLEDGE message or a HANDOVER NOTIFY message or a HANDOVER SUCCESS message or a PATH SWITCH REQUEST message of NG; or the eleventh message may also be a newly defined X2 or Xn or NG message.

In some examples, the eleventh message (e.g., the fourth request and/or information related thereto) may include one or more of the following (or include information or parameters or fields on (or indicating) each of the one or more of the following):

UE ID: it is used to identify the UE for which the prediction of the PDCP sequence number is required. For example, the UE ID may include one or more of an NG-RAN node UE XnAP ID, a Source NG-RAN node UE XnAP ID, an M-NG-RAN node UE XnAP ID, an S-NG-RAN node UE XnAP ID, an MeNB UE X2AP ID, an SeNB UE X2AP ID, an MeNB UE X2AP ID, an SgNB UE X2AP ID, an AMF UE NGAP ID, a RAN UE NGAP ID, or a Source AMF UE NGAP ID.

First Node ID: it is used to identify a node transmitting the request (for example, the fourth request). For example, the first node ID may include one or more of a Cell Global ID, a Target Cell Global ID and a Requested Target Cell ID.

Second Node ID: it is used to identify the node receiving the request. For example, the second node ID may include one or more of a Cell Global ID, a Target Cell Global ID and a Requested Target Cell ID.

Handover Time: it is used to indicate a time point when the UE performs handover. For example, the time may be a relative time or an absolute time.

Prediction Identification: it is used to indicate whether a request for prediction of the PDCP Sequence number or a request for prediction (for example, the fourth request) is included. The information (e.g., field) may be indicated by a single bit, for example, a value (e.g., bit) of “1” may be used to indicate that the request is the request for prediction of the PDCP sequence number, and a value (e.g., bit) of “0” may be used to indicate that the request is not the request for prediction of the PDCP sequence number; or a value (e.g., bit) of “1” may be used to indicate that the request is the request for prediction, and a value (e.g., bit) of “0” may be used to indicate that the request is not the request for prediction.

Prediction Registration Request: it is used to indicate a start, end, addition, etc. of the prediction of the PDCP sequence number.

Prediction Time Interval: it is used to indicate a time interval (time period or time span) for the prediction. For example, the prediction time interval may be indicated by 2*n bits, for example, the first n bits indicate a prediction start time and the last n bits indicate a prediction end time, where n may be a positive integer. The time may be a relative time or an absolute time. Alternatively, the prediction time interval may be indicated by separate fields, including one or more of the following:

Prediction Start Time: it is used to indicate a start time of the prediction. For example, the start time may be a relative time or an absolute time.

Prediction End Time: it is used to indicate an end time of the prediction. For example, the end time may be a relative time or an absolute time.

Prediction Result Reporting Type: it is used to indicate a reporting type of the prediction result of the PDCP sequence number. The prediction result reporting type may be used to indicate whether the prediction result of the PDCP sequence number is reported aperiodically (for example, reported once or reported sporadically) or reported periodically. For example, the reporting type may include, but is not limited to, an on-demand type, a periodic type, etc.

Prediction Result Reporting Period: it is used to indicate a time interval of periodic reporting of the prediction result of the PDCP sequence number. For example, the reporting period may also be the prediction time of the data reported this time. For example, if there is no such information (e.g., field), it indicates that a single report is enough, and the prediction time of the single report is from the prediction start time to the prediction end time.

Reporting Trigger Condition: it is used to indicate a trigger condition under which reporting is needed. For example, it needs to be reported only when the prediction result or actual situation meets the trigger condition (for example, there is a large difference (for example, the difference is larger than a preset threshold) between prediction results of the PDCP sequence number for different target cells and/or target nodes).

Prediction Type: it is used to indicate a type of prediction that needs to be performed for the PDCP sequence number. For example, the prediction type includes, but is not limited to, a prediction of the PDCP sequence number for data forwarding, a prediction of the PDCP sequence number for data transmission, a prediction of a changing trend of the PDCP sequence number for data transmission, etc.

Prediction Content: it is used to indicate parameters that need to be predicted. For example, the parameters to be predicted may include one or more of a PDCP sequence number for data forwarding, a PDCP sequence number for data transmission, a changing trend of the PDCP sequence number for data transmission, a prediction accuracy, etc.

Identification of a cell for prediction: it is used to indicate a cell in which the prediction needs to be performed for the UE. For example, the cell identification may indicate one or more of a cell, a master cell, a secondary cell, a primary cell, a primary secondary cell, etc. For example, the identification may be a Physical Cell Identifier, or a Global NG-RAN Cell Identity, etc.

For example, the prediction content may be related to the prediction type. If the prediction type is the prediction of the PDCP sequence number for data forwarding, the prediction content includes at least one of: time point, PDCP sequence number for data forwarding, cell identification, prediction accuracy, etc. If the prediction type is the prediction of the PDCP sequence number for data transmission, the prediction content includes at least one of: time point, PDCP sequence number for data transmission, cell identification, prediction accuracy, etc. If the prediction type is the prediction of a changing trend of the PDCP sequence value for data transmission, the prediction content includes at least one of: time point, cell identification, the changing trend of the PDCP sequence value for data transmission, prediction accuracy, etc.

In some implementations, the second node may transmit a tenth message including a prediction result of the PDCP sequence number to the first node according to its own situation and/or according to a prediction request for the PDCP sequence number (for example, the fourth request) transmitted by the first node, so that the first node may obtain the prediction result of the PDCP sequence number for data forwarding for the UE by the second node, so as for the first node to accurately set the data forwarding amount when performing data forwarding for the UE, thereby reducing the forwarding amount of unnecessary data.

In some implementations, the prediction result of the PDCP sequence number (e.g., the second prediction result) may be carried by any suitable message (existing message or newly defined message) over any suitable interface (e.g., X2 interface, Xn interface, S1 interface, or NG interface). In some examples, the tenth message carrying the second prediction result may be an SGNB RELEASE REQUEST ACKNOWLEDGE message or an SENB ADDITION REQUEST message or an SGNB ADDITION REQUEST message or an SGNB CHANGE REQUIRED message of X2; or the tenth message may also be an S-NODE RELEASE REQUEST ACKNOWLEDGE message or an S-NODE ADDITION REQUEST message or an S-NODE CHANGE REQUIRED message of Xn, the message may be a HANDOVER REQUEST message or a RETRIEVE UE CONTEXT RESPONSE message or a RETRIEVE UE CONTEXT FAILURE message of X2 or Xn; or the tenth message may also be an SENB MODIFICATION REQUEST ACKNOWLEDGE message or an SENB MODIFICATION REQUEST REJECT message or an SGNB MODIFICATION REQUEST ACKNOWLEDGE message or an SGNB MODIFICATION REQUEST REJECT message or an SENB MODIFICATION CONFIRM message or an SENB MODIFICATION REFUSE message or an SGNB MODIFICATION CONFIRM message or an SGNB MODIFICATION REFUSE message of X2; or the tenth message may also be an S-NODE MODIFICATION REQUEST ACKNOWLEDGE message or an S-NODE MODIFICATION REQUEST REJECT message or an S-NODE MODIFICATION CONFIRM message or an S-NODE MODIFICATION REFUSE message of Xn; or the tenth message may also be a PATH SWITCH REQUEST ACKNOWLEDGE message or a PATH SWITCH REQUEST FAILURE message of NG; or the tenth message may also be a newly defined X2 or Xn or NG message.

In some examples, the tenth message (e.g., the second prediction result and information related thereto) may include one or more of the following (or include information or parameters or fields on (or indicating) each of the one or more of the following):

UE ID: it is used to identify the UE for which the prediction of the PDCP sequence number is required. For example, the UE ID may include one or more of an NG-RAN node UE XnAP ID, a Source NG-RAN node UE XnAP ID, an M-NG-RAN node UE XnAP ID, an S-NG-RAN node UE XnAP ID, an MeNB UE X2AP ID, an SeNB UE X2AP ID, an MeNB UE X2AP ID, an SgNB UE X2AP ID, an AMF UE NGAP ID, a RAN UE NGAP ID, or a Source AMF UE NGAP ID.

First Node ID: it is used to identify the first node. For example, the first node ID may include one or more of a Cell Global ID, a Target Cell Global ID and a Requested Target Cell ID.

Second Node ID: it is used to identify the second node. For example, the second node ID may include one or more of a Cell Global ID, a Target Cell Global ID and a Requested Target Cell ID.

Prediction Identification of Prediction Content: it is used to indicate whether information of the PDCP sequence number is a prediction content. For example, the information (e.g., field) may be indicated by a single bit, for example, a value (e.g., bit) of “1” may be used to indicate that the information is a prediction content, and a value (e.g., bit) of “0” may be used to indicate that the information is an actual state content.

Handover Time: it is used to indicate a time point when the UE performs handover. For example, the time may be a relative time or an absolute time.

Prediction Request Content Confirmation: it is used to indicate whether prediction of the PDCP sequence number for the UE can be performed. In an example, whether the prediction can be performed may be indicated by a single bit; for example, the bit of “1” indicates that all of the requested content(s) can be predicted, and the bit of “0” indicates that the requested content(s) cannot be predicted. In another example, the prediction of the request content(s) may also be confirmed one by one by a plurality of bits, for example, in a form of bitmap, where each bit corresponds to the confirmation of one prediction content; for example, the bit of “1” indicates that information of the predicted PDCP sequence number of the corresponding prediction content can be transmitted, and the bit of “0” indicates that information of the predicted PDCP sequence number of the corresponding prediction content cannot be transmitted. In still another example, separate fields may also be used to indicate the confirmation of different prediction contents.

Prediction Time Interval: it is used to indicate a prediction time interval (time period or time span) to which prediction data of the PDCP sequence number is applicable. The prediction time interval may be indicated by 2*n bits, for example, the first n bits indicate a prediction start time and the last n bits indicate a prediction end time, where n may be a positive integer. For example, the time may be a relative time or an absolute time. Alternatively, the prediction time interval may be indicated by separate fields, including one or more of the following:

Prediction Start Time: it is used to indicate a start time of the prediction. For example, the start time may be a relative time or an absolute time.

Prediction End Time: it is used to indicate an end time of the prediction. For example, the end time may be a relative time or an absolute time.

Prediction Type: it is used to indicate a type of prediction of the PDCP sequence number. For example, the prediction type includes but is not limited to: a prediction of the PDCP sequence number for data forwarding, a prediction of the PDCP sequence number for data transmission, a prediction of a changing trend of the PDCP sequence number for data transmission, etc.

Prediction Content: it is used to indicate predicted parameters. For example, the predicted parameters may include one or more of the following: PDCP sequence number for data forwarding, PDCP sequence number for data transmission, changing trend of the PDCP sequence number for data transmission, prediction accuracy, etc.

Identification of a cell for prediction: it is used to indicate a cell in which the prediction is performed for the UE. For example, the cell identification may indicate one or more of a cell, a master cell, a secondary cell, a primary cell, a primary secondary cell, etc. For example, the identification may be a Physical Cell Identifier, or a Global NG-RAN Cell Identity, etc.

In some examples, the prediction content may be related to the prediction type. For example, if the prediction type is the prediction of the PDCP sequence number for data forwarding, the prediction content includes at least one of a time point, a PDCP sequence number for data forwarding, a cell identification, a prediction accuracy, etc. Or, if the prediction type is the prediction of the PDCP sequence number for data transmission, the prediction content includes at least one of a time point, a PDCP sequence number for data transmission, a cell identification, a prediction accuracy, etc. Or, if the prediction type is the prediction of a changing trend of the PDCP sequence number for data transmission, the prediction content includes at least one of a time point, a cell identification, the changing trend of the PDCP sequence number for data transmission, a prediction accuracy, etc.

In some implementations, if the second node cannot feed back the prediction result of the PDCP sequence number to the first node according to the prediction request for the PDCP sequence number transmitted by the first node, the second node transmits a twelfth message including information indicating that the prediction cannot be performed or the prediction fails to the first node, so that the first node knows that the second node cannot perform prediction according to the request.

In some implementations, the information indicating that the prediction cannot be performed or the prediction fails may be carried by any suitable message (existing message or newly defined message) over any suitable interface (e.g., X2 interface, Xn interface, S1 interface, or NG interface). In some examples, the twelfth message carrying the information indicating that the prediction cannot be performed or the prediction fails may be an SGNB RELEASE REQUEST ACKNOWLEDGE message or an SGNB RELEASE REQUEST REJECT message or an SGNB CHANGE REQUIRED message of X2; or the twelfth message may also be an S-NODE RELEASE REQUEST ACKNOWLEDGE message or an S-NODE RELEASE REJECT message or an S-NODE CHANGE REQUIRED message of Xn; or the twelfth message may also be a RETRIEVE UE CONTEXT RESPONSE message or a RETRIEVE UE CONTEXT FAILURE message of X2 or Xn; or the twelfth message may also be an SENB MODIFICATION REQUEST ACKNOWLEDGE message or an SENB MODIFICATION REQUEST REJECT message or an SGNB MODIFICATION REQUEST ACKNOWLEDGE message or an SGNB MODIFICATION REQUEST REJECT message or an SENB MODIFICATION CONFIRM message or an SENB MODIFICATION REFUSE message or an SGNB MODIFICATION CONFIRM message or an SGNB MODIFICATION REFUSE message of X2; or the twelfth message may also be an S-NODE MODIFICATION REQUEST ACKNOWLEDGE message or an S-NODE MODIFICATION REQUEST REJECT message or an S-NODE MODIFICATION CONFIRM message or an S-NODE MODIFICATION REFUSE message of Xn; or the twelfth message may also be a PATH SWITCH REQUEST ACKNOWLEDGE message or a PATH SWITCH REQUEST FAILURE message of NG; or the twelfth message may also be a newly defined X2 or Xn or NG message.

In some examples, the twelfth message (e.g., the information indicating that the prediction cannot be performed or the prediction fails and/or information related thereto) includes one or more of the following (or includes information or parameters or fields on (or indicating) each of the one or more of the following):

UE ID: it is used to identify the UE for which the prediction of the PDCP sequence number is required. For example, the UE ID may include one or more of an NG-RAN node UE XnAP ID, a Source NG-RAN node UE XnAP ID, an M-NG-RAN node UE XnAP ID, an S-NG-RAN node UE XnAP ID, an MeNB UE X2AP ID, an SeNB UE X2AP ID, an MeNB UE X2AP ID, an SgNB UE X2AP ID, an AMF UE NGAP ID, a RAN UE NGAP ID, or a Source AMF UE NGAP ID.

First Node ID: it is used to identify the first node. For example, the first node ID may include one or more of a Cell Global ID, a Target Cell Global ID and a Requested Target Cell ID.

Second Node ID: it is used to identify the second node. For example, the second node ID may include one or more of a Cell Global ID, a Target Cell Global ID and a Requested Target Cell ID.

Prediction Request Content Confirmation: it is used to indicate whether prediction of the PDCP sequence number for the UE can be performed. In an example, whether the prediction can be performed may be indicated by a single bit; for example, the bit of “1” indicates that all of the requested content(s) can be predicted, and the bit of “0” indicates that the requested content(s) cannot be predicted. In another example, the prediction of the request content(s) may also be confirmed one by one by a plurality of bits, for example, in a form of bitmap, where each bit corresponds to the confirmation of one prediction content; for example, the bit of “1” indicates that information of the predicted PDCP sequence number of the corresponding prediction content can be transmitted, and the bit of “0” indicates that information of the predicted PDCP sequence number of the corresponding prediction content cannot be transmitted. In still another example, separate fields may also be used to indicate the confirmation of different prediction contents.

Cause: it is used to indicate a cause for the failure of the request, for example, prediction failure of the PDCP sequence number, prediction failure of the PDCP sequence number for data forwarding, prediction failure of the PDCP sequence number for data transmission, prediction failure of the changing trend of the PDCP sequence number for data transmission, no prediction ability, no prediction ability of the PDCP sequence number for data forwarding, no prediction ability of the PDCP sequence number for data transmission, no prediction ability of the PDCP sequence number for data transmission, no prediction ability of the PDCP sequence number, insufficient data, etc.

According to some embodiments of the disclosure, a method for supporting data collection and processing may include receiving, by a first node, a thirteenth message including a result of feedback of a packet data convergence protocol (PDCP) sequence number (PDCP Sequence Number) for data transmission of a UE (in embodiments of the disclosure, it may be referred to as a third feedback result) from a second node, so that reference information is provided for the first node to predict the PDCP sequence number for the UE, etc. In this way, by setting the data forwarding amount in consideration of the feedback result of the PDCP sequence number for data transmission of the UE, the forwarding amount of unnecessary data can be reduced.

In some implementations, the first node may transmit a fourteenth message including a request for PDCP sequence number reporting (or feedback) for the UE (in embodiments of the disclosure, it may be referred to as a fifth request) to the second node, so as to inform the second node of a feedback requirement for reporting of the PDCP sequence number for data transmission of the UE. After receiving the message, the second node needs to report information of the PDCP sequence number for data transmission of the UE to the first node according to the feedback requirement, so that the first node may obtain a result of the PDCP sequence number for data transmission of the UE in the second node, and thus reference information is provided for the first node to predict the PDCP sequence number for the UE, thus setting accurate data forwarding amount and reducing unnecessary data forwarding.

In some implementations, the first node may be one of a gNB, a gNB CU (Central Unit)-CP (Control Plane), an en-gNB, an eNB, or an ng-eNB.

In some implementations, the second node may be one of a gNB, a gNB CU-CP, an en-gNB, an eNB, or an ng-eNB.

In some examples, in a dual connectivity scenario in which a master node and a secondary node are connected with the UE, when handover occurs, the second node may be a master node, and the first node may be a source secondary node or a target secondary node changed from the source secondary node. In some other examples, the first node may be a master node and the second node may be a source secondary node.

In some implementations, the request for PDCP sequence number reporting (or feedback) for the UE (e.g., the fifth request) may be carried by any suitable message (existing message or newly defined message) over any suitable interface (e.g., X2 interface, Xn interface, S1 interface, or NG interface). In some examples, the fourteenth message carrying the fifth request may be an SENB RELEASE REQUEST message or an SGNB RELEASE REQUEST message of X2; or the fourteenth message may also be an S-NODE RELEASE REQUEST message of Xn; or the fourteenth message may also be a HANDOVER REQUEST ACKNOWLEDGE message or a RETRIEVE UE CONTEXT REQUEST message or a HANDOVER SUCCESS message of X2 or Xn; or the fourteenth message may also be an SENB MODIFICATION REQUEST message or an SGNB MODIFICATION REQUEST message or an SENB MODIFICATION REQUIRED message or an SGNB MODIFICATION REQUIRED message of X2; or the fourteenth message may also be an S-NODE MODIFICATION REQUEST message or an S-NODE MODIFICATION REQUIRED message of Xn; or the fourteenth message may also be a HANDOVER COMMAND message or a HANDOVER PREPARATION FAILURE message or a HANDOVER REQUEST ACKNOWLEDGE message or a HANDOVER NOTIFY message or a HANDOVER SUCCESS message or a PATH SWITCH REQUEST message of NG, or it may also be a newly defined X2 or Xn or NG message.

In some examples, the fourteenth message (e.g., the fifth request or information related thereto) may include one or more of the following (or include information or parameters or fields on (or indicating) each of the one or more of the following):

UE ID: it is used to identify the UE for which information of the PDCP sequence number for data transmission needs to be reported. For example, the UE ID may include one or more of an NG-RAN node UE XnAP ID, a Source NG-RAN node UE XnAP ID, an M-NG-RAN node UE XnAP ID, an S-NG-RAN node UE XnAP ID, an MeNB UE X2AP ID, an SeNB UE X2AP ID, an MeNB UE X2AP ID, an SgNB UE X2AP ID, an AMF UE NGAP ID, a RAN UE NGAP ID, or a Source AMF UE NGAP ID.

First Node ID: it is used to identify a node transmitting the request. For example, the first node ID may include one or more of a Cell Global ID, a Target Cell Global ID and a Requested Target Cell ID.

Second Node ID: it is used to identify a node receiving the request. For example, the identification may include one or more of a Cell Global ID, a Target Cell Global ID and a Requested Target Cell ID.

Reporting Identification: it is used to indicate whether a request for reporting of the PDCP sequence number is included. The information (e.g., field) may be indicated by a single bit, for example, a value (e.g., bit) of “1” may be used to indicate that the request is the request for reporting of the PDCP sequence number, and a value (e.g., bit) of “0” may be used to indicate that the request is not the request for reporting of the PDCP sequence number.

Reporting Registration Request: it is used to indicate a start, end, addition, etc. of the reporting of the PDCP sequence number.

Reporting Information Time Interval: it is used to indicate a corresponding time interval (time period or time span) for information (for example, PDCP sequence number) that needs to be reported. For example, the information reporting time interval may indicate a time interval for the reported PDCP sequence number. For example, the reporting information time interval may be indicated by 2*n bits, for example, the first n bits indicate an information start time and the last n bits indicate an information end time, and the time may be a relative time or an absolute time. Alternatively, the reporting information time interval may be indicated by separate fields, including one or more of the following:

Reporting Information Start Time: it is used to indicate a corresponding start time of the reported information. For example, the start time may be a relative time or an absolute time.

Reporting Information End Time: it is used to indicate a corresponding end time of the reported information. For example, the end time may be a relative time or an absolute time.

Result Reporting Type: it is used to indicate a reporting type of the PDCP sequence number. For example, the result reporting type may be used to indicate whether the PDCP sequence number is reported aperiodically (for example, reported once or reported sporadically) or reported periodically. For example, the reporting type may include, but is not limited to, an on-demand type, a periodic type, etc.

Result Reporting Period: it is used to indicate a time interval of periodic reporting of the result of the PDCP sequence number. For example, the reporting period may also be a statistical time of the data reported this time. For example, if there is no such information (e.g., field), it indicates that a single report is enough, and the corresponding measurement and/or statistical time of the result of a single report is from the reporting start time to the reporting end time.

Reporting Content: it is used to indicate parameters that need to be reported. For example, the parameters that need to be reported may include one or more of a PDCP sequence number of a transmitted GTP (GPRS Tunnel Protocol)-U (user) packet, a corresponding time point, etc. The corresponding time point may be a relative time or an absolute time. For example, the PDCP sequence number may include PDCP sequence numbers of one or more GTP-U packets of a GTP-U packet indicated by highest successfully delivered PDCP Sequence Number, a GTP-U packet indicated by highest transmitted PDCP Sequence Number, a GTP-U packet indicated by successfully delivered retransmitted PDCP Sequence Number, a GTP-U packet indicated by retransmitted PDCP Sequence Number, a GTP-U packet indicated by successfully delivered retransmitted PDCP Sequence Number, a GTP-U packet indicated by start of successfully delivered out of sequence PDCP Sequence Number range, a GTP-U packet indicated by end of successfully delivered out of sequence PDCP Sequence Number range.

In some implementations, the second node may transmit the thirteenth message including information of the PDCP sequence number (for example, the third feedback result) to the first node according to its own situation and/or according to the reporting request of the PDCP sequence number (for example, the fifth request) transmitted by the first node, so that the first node may obtain the result of the PDCP sequence number for data transmission of the UE by the second node, and thus the first node may perform early data forwarding for the UE, thereby reducing data forwarding redundancy and other situations.

In some implementations, the third feedback result may be carried by any suitable message (existing message or newly defined message) over any suitable interface (e.g., X2 interface, Xn interface, S1 interface, or NG interface). In some examples, the thirteenth message carrying the third feedback result may be an SGNB RELEASE REQUEST ACKNOWLEDGE message or an SGNB CHANGE REQUIRED message of X2; or the thirteenth message may also be an S-NODE RELEASE REQUEST ACKNOWLEDGE message or an S-NODE CHANGE REQUIRED message of Xn; or the thirteenth message may also be a HANDOVER REQUEST message or a RETRIEVE UE CONTEXT RESPONSE message or a RETRIEVE UE CONTEXT FAILURE message of X2 or Xn; or the thirteenth message may also be an SENB MODIFICATION REQUEST ACKNOWLEDGE message or an SENB MODIFICATION REQUEST REJECT message or an SGNB MODIFICATION REQUEST ACKNOWLEDGE message or an SGNB MODIFICATION REQUEST REJECT message or an SENB MODIFICATION CONFIRM message or an SENB MODIFICATION REFUSE message or an SGNB MODIFICATION CONFIRM message or an SGNB MODIFICATION REFUSE message of X2; or the thirteenth message may also be an S-NODE MODIFICATION REQUEST ACKNOWLEDGE message or an S-NODE MODIFICATION REQUEST REJECT message or an S-NODE MODIFICATION CONFIRM message or an S-NODE MODIFICATION REFUSE message of Xn; or the thirteenth message may also be a PATH SWITCH REQUEST ACKNOWLEDGE message or a PATH SWITCH REQUEST FAILURE message of NG; or the thirteenth message may also be a newly defined X2 or Xn or NG message.

In some examples, the thirteenth message (e.g., the third feedback result and/or information related thereto) may include one or more of the following (or include information or parameters or fields on (or indicating) each of the one or more of the following):

UE ID: it is used to identify the UE for which information of the PDCP sequence number needs to be reported. For example, the UE ID may include one or more of an NG-RAN node UE XnAP ID, a Source NG-RAN node UE XnAP ID, an M-NG-RAN node UE XnAP ID, an S-NG-RAN node UE XnAP ID, an MeNB UE X2AP ID, an SeNB UE X2AP ID, an MeNB UE X2AP ID, an SgNB UE X2AP ID, an AMF UE NGAP ID, a RAN UE NGAP ID, or a Source AMF UE NGAP ID.

First Node ID: it is used to identify the first node. For example, the first node ID may include one or more of a Cell Global ID, a Target Cell Global ID and a Requested Target Cell ID.

Second Node ID: it is used to identify the second node. For example, the second node ID may include one or more of a Cell Global ID, a Target Cell Global ID and a Requested Target Cell ID.

Request Content Confirmation: it is used to indicate whether the feedback of the PDCP sequence number for data transmission of the UE can be performed. In an example, whether the reporting or feedback can be performed may be indicated by a single bit; for example, the bit of “1” indicates that all of the requested content(s) can be reported, and the bit of “0” indicates that the requested content(s) cannot be reported. In another example, the reporting request content(s) may also be confirmed one by one by a plurality of bits, for example, in a form of bitmap, where each bit corresponds to the confirmation of one reporting request; for example, the bit of “1” indicates that information of the PDCP sequence number corresponding to the reporting request can be transmitted, and a value (for example, bit) of “0” indicates that information of the PDCP sequence number corresponding to the reporting request cannot be transmitted. In still another example, separate fields may also be used to indicate the confirmation of different contents.

Reporting Information Time Interval: it is used to indicate a corresponding (or applicable) time interval (time period or time span) for the reported information. For example, the reporting information time interval may be indicated by 2*n bits, for example, the first n bits indicate an information start time and the last n bits indicate an information end time. For example, the time may be a relative time or an absolute time. Alternatively, the reporting information time interval may be indicated by separate fields, including one or more of the following:

Reporting Information Start Time: it is used to indicate a corresponding start time of the reported information. For example, the start time may be a relative time or an absolute time.

Reporting Information End Time: it is used to indicate a corresponding end time of the reported information. For example, the end time may be a relative time or an absolute time.

Reporting Content: it is used to indicate reported parameters. For example, the reported parameters may include one or more of a PDCP sequence number of a transmitted GTP-U packet, a corresponding time point, etc. The corresponding time point may be a relative time or an absolute time. For example, the PDCP sequence number may include PDCP sequence numbers of one or more GTP-U packets of a GTP-U packet indicated by highest successfully delivered PDCP Sequence Number, a GTP-U packet indicated by highest transmitted PDCP Sequence Number, a GTP-U packet indicated by successfully delivered retransmitted PDCP Sequence Number, a GTP-U packet indicated by retransmitted PDCP Sequence Number, a GTP-U packet indicated by successfully delivered retransmitted PDCP Sequence Number, a GTP-U packet indicated by start of successfully delivered out of sequence PDCP Sequence Number range, a GTP-U packet indicated by end of successfully delivered out of sequence PDCP Sequence Number range.

In some implementations, if the second node cannot feed back the result of information of the PDCP sequence number for data transmission to the first node according to the information reporting request of the PDCP sequence number transmitted by the first node, the second node transmits a fifteenth message including information indicating that the reporting of the PDCP sequence number cannot be performed to the first node, so that the first node knows that the second node cannot report according to the request.

In some implementations, the information indicating that the reporting of the PDCP sequence number cannot be performed may be carried by any suitable message (existing message or newly defined message) over any suitable interface (e.g., X2 interface, Xn interface, S1 interface, or NG interface). The fifteenth message indicating that the reporting of the PDCP sequence number cannot be performed may be an SGNB RELEASE REQUEST ACKNOWLEDGE message or an SGNB RELEASE REQUEST REJECT message of X2; or the fifteenth message may also be an S-NODE RELEASE REQUEST ACKNOWLEDGE message or an S-NODE RELEASE REJECT message of Xn; or the fifteenth message may also be a RETRIEVE UE CONTEXT RESPONSE message or a RETRIEVE UE CONTEXT FAILURE message of X2 or Xn; or the fifteenth message may also be an SENB MODIFICATION REQUEST ACKNOWLEDGE message or an SENB MODIFICATION REQUEST REJECT message or an SGNB MODIFICATION REQUEST ACKNOWLEDGE message or an SGNB MODIFICATION REQUEST REJECT message or an SENB MODIFICATION CONFIRM message or an SENB MODIFICATION REFUSE message or an SGNB MODIFICATION CONFIRM message or an SGNB MODIFICATION REFUSE message of X2; or the fifteenth message may also be an S-NODE MODIFICATION REQUEST ACKNOWLEDGE message or an S-NODE MODIFICATION REQUEST REJECT message or an S-NODE MODIFICATION CONFIRM message or an S-NODE MODIFICATION REFUSE message of Xn; or the fifteenth message may also be a PATH SWITCH REQUEST ACKNOWLEDGE message or a PATH SWITCH REQUEST FAILURE message of NG; or the fifteenth message may also be a newly defined X2 or Xn or NG message.

In some examples, the fifteenth message (e.g., information indicating that the reporting of the PDCP sequence number cannot be performed and/or information related thereto) may include one or more of the following (or include information or parameters or fields on (or indicating) each of the one or more of the following):

UE ID: it is used to identify the UE for which information of the PDCP sequence number for data transmission needs to be reported. For example, the UE ID may include one or more of an NG-RAN node UE XnAP ID, a Source NG-RAN node UE XnAP ID, an M-NG-RAN node UE XnAP ID, an S-NG-RAN node UE XnAP ID, an MeNB UE X2AP ID, an SeNB UE X2AP ID, an MeNB UE X2AP ID, an SgNB UE X2AP ID, an AMF UE NGAP ID, a RAN UE NGAP ID, or a Source AMF UE NGAP ID.

First Node ID: it is used to identify the first node. For example, the first node ID may include one or more of a Cell Global ID, a Target Cell Global ID and a Requested Target Cell ID.

Second Node ID: it is used to identify the second node. For example, the second node ID may include one or more of a Cell Global ID, a Target Cell Global ID and a Requested Target Cell ID.

Request Content Confirmation: it is used to indicate whether the feedback of the PDCP sequence number for data transmission of the UE can be performed. In an example, whether the reporting or feedback can be performed may be indicated by a single bit; for example, the bit of “1” indicates that all of the requested content(s) can be reported, and the bit of “0” indicates that the requested content(s) cannot be reported. In another example, the reporting request content(s) may also be confirmed one by one by a plurality of bits, for example, in a form of bitmap, where each bit corresponds to the confirmation of one reporting request; for example, the bit of “1” indicates that information of the PDCP sequence number corresponding to the reporting request can be transmitted, and a value (for example, bit) of “0” indicates that information of the PDCP sequence number corresponding to the reporting request cannot be transmitted. In another example, separate fields may also be used to indicate the confirmation of different contents.

Cause: it is used to indicate a cause for the failure of the request, for example, failure of obtaining of the PDCP sequence number for data transmission, insufficient data, etc.

The above describes methods for supporting data collection and processing according to various embodiments of the disclosure. Exemplary embodiments of the disclosure are further described below with reference to the accompanying drawings. For example, these embodiments may be based on or in addition to one or more of the embodiments of the disclosure described above. It should be noted that although various embodiments are described separately, these embodiments may be combined with each other in various appropriate ways to form new embodiments.

For the purpose of discussion, steps in these embodiments are shown in sequential order. However, in other embodiments, some steps may occur in a different order from that shown, some steps may be performed in parallel, some steps may be combined with other steps, and some steps may be excluded.

### Embodiment 1

Embodiment 1 describes a method for supporting data collection and processing according to some embodiments of the disclosure.

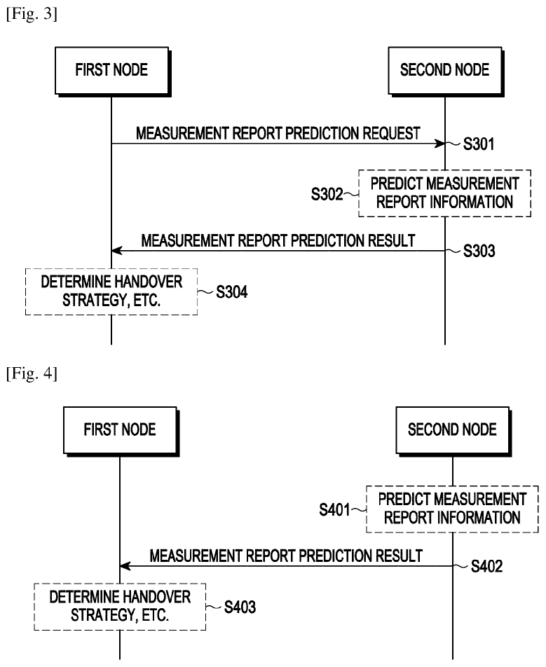

Embodiment 1 will be described with reference to FIG. 3. FIG. 3 illustrates a method for supporting data collection and processing according to some embodiments of the disclosure. Specifically, FIG. 3 illustrates a procedure of communicating prediction information of a measurement report of a UE between nodes, so as to provide the nodes with the prediction information of the measurement report of the UE within a prediction period, and thus to provide reference information for target node selection, handover execution condition setting, determination of whether to perform handover, determination of a handover timing, etc. for the UE, thereby avoiding situations such as too many candidate target nodes, inaccurate candidate target nodes, handover failure, handover ping-pong, etc.

In some implementations, for example, the first node may be a gNB or a gNB CU-CP or an en-gNB or an eNB or an ng-eNB, and the second node may be a gNB or a gNB CU-CP or an en-gNB or an eNB or an ng-eNB.

Referring to FIG. 3, in step S301, the first node may transmit a measurement report prediction request to the second node, so as to inform the second node of a requirement to feed back prediction information of the measurement report of a UE to the first node. In some implementations, for example, the measurement report prediction request may be the first request described in the previous embodiments, and the message carrying the measurement report prediction request may be the second message including the measurement report prediction request (e.g., the first request) described in the previous embodiments.

In response to the measurement report prediction request, in step S302, the second node may perform prediction of measurement report information, for example, based on collected measurement report information of the UE to obtain a measurement report prediction result. In some implementations, for example, the prediction of the measurement report information may be implemented by an AI model (for example, a machine learning model). For example, the measurement report information may be predicted by using the machine learning model.

In step S303, the second node may transmit the measurement report prediction result to the first node, so as to inform the first node of the prediction result for the UE. In some implementations, for example, the measurement report prediction result may be the aforementioned first prediction result, and the message carrying the prediction result may be the aforementioned first message including the first prediction result. If the second node cannot report the measurement report prediction result (for example, the first prediction result) of the UE as required, it will inform the first node of the failure of the measurement report prediction request and will not proceed to step S304. In some implementations, for example, the message carrying the failure of the measurement report prediction request may be the aforementioned third message including the information indicating prediction failure of the measurement report.

In step S304, the first node may perform target node selection, handover execution condition setting, determination of whether to perform handover, and determination of a handover timing, etc. for the UE according to the prediction information of the measurement report, etc. In some implementations, for example, the first node identifies a cell and/or node with a predicted measurement report greater than a predetermined threshold as a handover target cell and/or node.

### Embodiment 2

Embodiment 2 describes a method for supporting data collection and processing according to some embodiments of the disclosure.

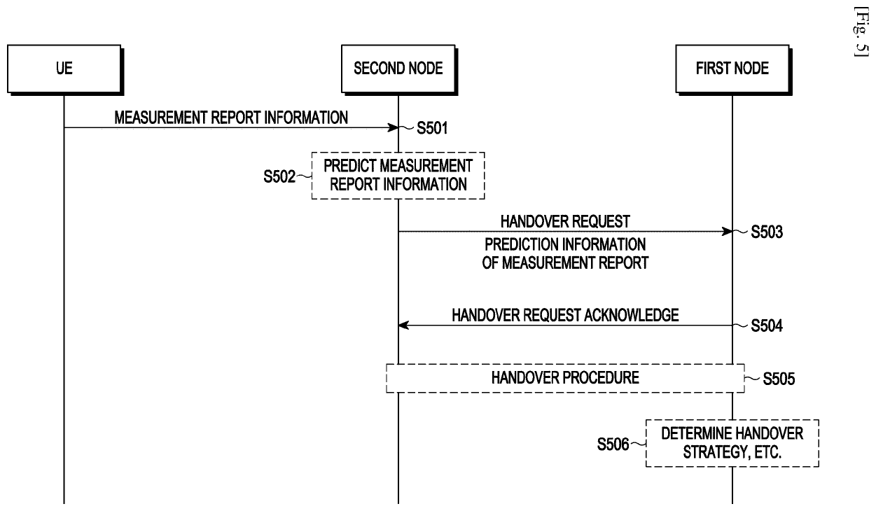

Embodiment 2 will be described with reference to FIG. 4. FIG. 4 illustrates a method for supporting data collection and processing according to some embodiments of the disclosure. Specifically, FIG. 4 illustrates the communicating of prediction information of a measurement report of a UE between nodes according to their own situations, so as to provide the nodes with the prediction information of the measurement report of the UE within a prediction period, and thus to provide reference information for target node selection, handover execution condition setting, determination of whether to perform handover, determination of a handover timing, etc. for the UE, thereby avoiding situations such as too many candidate target nodes, inaccurate candidate target nodes, handover failure, handover ping-pong, etc. In some implementations, for example, the first node may be a gNB or a gNB CU-CP or an en-gNB or an eNB or an ng-eNB, and the second node may be a gNB or a gNB CU-CP or an en-gNB or an eNB or an ng-eNB.

Referring to FIG. 4, in step S401, the second node may perform prediction of measurement report information, for example, based on collected measurement report information of the UE. In some implementations, for example, the prediction of the measurement report information may be implemented by an AI model (for example, a machine learning model). For example, the measurement report information may be predicted by using the machine learning model.

In step S402, the second node may transmit a prediction result of the measurement report information to the first node according to its own situation, so as to inform the first node of the prediction result for the UE. In some implementations, for example, the prediction result of the measurement report information may be the aforementioned first prediction result, and the message carrying the prediction result of the measurement report information may be the aforementioned first message including the first prediction result.

In step S403, the first node may perform target node selection, handover execution condition setting, determination of whether to perform handover, and determination of a handover timing, etc. for the UE according to the prediction information of the measurement report, etc. In some implementations, for example, a cell and/or node with a predicted measurement report greater than a predetermined threshold value is identified as a handover target cell and/or node.

### Embodiment 3

Embodiment 3 describes a method for supporting data collection and processing according to some embodiments of the disclosure.

Embodiment 3 will be described below with reference to FIG. 5. FIG. 5 illustrates a schematic diagram of a method supporting data collection and processing according to some embodiments of the disclosure. Specifically, FIG. 5 illustrates a procedure of communicating prediction information of a measurement report of a UE between nodes according to their own situations in a handover procedure, so as to provide the nodes with the prediction information of the measurement report of the UE within a prediction period, and thus to provide reference information for target node selection, handover execution condition setting, determination of whether to perform handover, determination of a handover timing, etc. for the UE, thereby reducing situations such as too many candidate target nodes, inaccurate candidate target nodes, handover failure, handover ping-pong, etc. In some implementations, for example, the first node may be a gNB or a gNB CU-CP or an en-gNB or an eNB or an ng-eNB, and the second node may be a gNB or a gNB CU-CP or an en-gNB or an eNB or an ng-eNB.

In step S501, the UE may report its own measurement information to the second node. In some implementations, for example, the reported measurement information may be a measurement report.

In step S502, the second node may perform prediction of measurement report information, for example, based on collected measurement report information of the UE. In some implementations, for example, the prediction of the measurement report information may be implemented by an AI model (for example, a machine learning model). For example, the measurement report information may be predicted by using the machine learning model.

In step S503, the second node may transmit a prediction result of the measurement report information to the first node in a handover request for the UE, so as to inform the first node of the prediction result for the UE. In some implementations, for example, the prediction result of the measurement report information may be the aforementioned first prediction result, and the message carrying the prediction result of the measurement report information may be the aforementioned first message including the first prediction result.

In step S504, the first node may transmit a handover request acknowledge message to the second node to confirm the handover request.

In step S505, the second node and the first node may perform a handover procedure for the UE.

In step S506, the first node may perform target node selection, handover execution condition setting, determination of whether to perform handover, and determination of a handover timing, etc. for the UE according to the prediction information of the measurement report, etc. In some implementations, for example, a cell and/or node with a predicted measurement report greater than a predetermined threshold value is identified as a handover target cell and/or node.

### Embodiment 4

Embodiment 4 describes a method for supporting data collection and processing according to some embodiments of the disclosure.

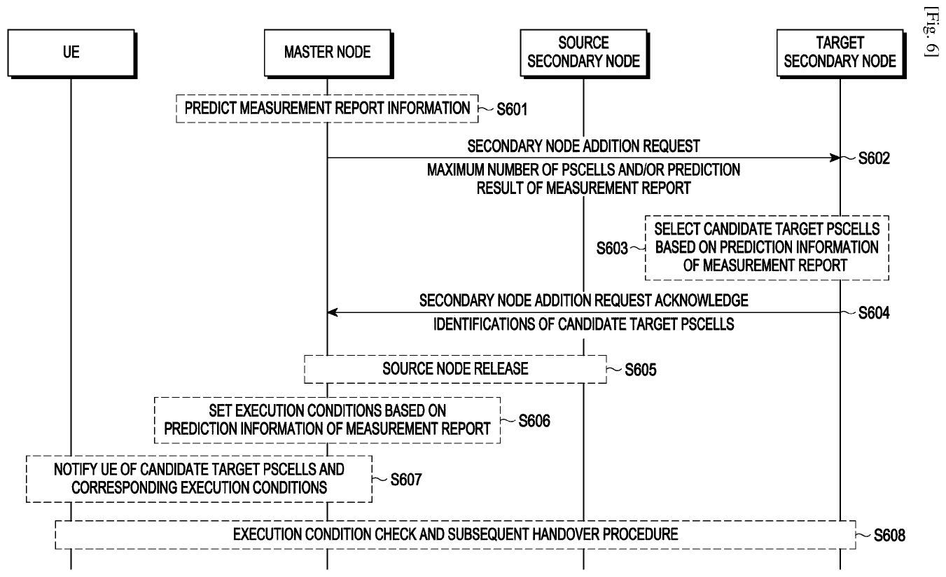

Embodiment 4 will be described below with reference to FIG. 6. FIG. 6 illustrates a schematic diagram of a method supporting data collection and processing according to some embodiments of the disclosure. Specifically, FIG. 6 illustrates a procedure of communicating prediction information of a measurement report of a UE between nodes in a case of dual connectivity, for supporting and optimizing a procedure of conditional PSCell change. After measurement report prediction is performed, the master node provides the prediction result to the target secondary node for the target secondary node to perform selection of candidate target PSCell(s), so that accurate target cells are provided, invalid target cells are reduced and accurate execution conditions are set, thereby ensuring the handover success rate, reducing situations such as handover failure, too many candidate target nodes, etc., and reducing signaling overhead. In some implementations, for example, the master node may be a gNB or a gNB CU-CP or an en-gNB or an eNB or an ng-eNB, the source secondary node may be a gNB or a gNB CU-CP or an en-gNB or an eNB or an ng-eNB, and the target secondary node may be a gNB or a gNB CU-CP or an en-gNB or an eNB or an ng-eNB.

In step S601, the master node may perform prediction of measurement report information, for example, according to collected measurement report(s). In some implementations, for example, the prediction of the measurement report information may be implemented by an AI model (for example, a machine learning model). For example, the measurement report information may be predicted by using the machine learning model.

In step S602, the master node may transmit a secondary node addition request message carrying a maximum number of PSCells and/or a measurement report prediction result (for example, corresponding to the aforementioned first prediction result) to the target secondary node. In some implementations, the secondary node addition request message may be the aforementioned first message including the first prediction result.

In step S603, the target secondary node may select candidate target PSCell(s) based on the prediction information of the measurement report, where the number of candidate target PSCell(s) does not exceed the received maximum number of PSCells.

In step S604, the target secondary node may transmit a secondary node addition request acknowledge message carrying identification(s) of the selected PSCell(s) to the master node.

In step S605, the master node may communicate messages with the source secondary node to release the source secondary node.

In step S606, the master node may set execution condition(s) for the received candidate target PSCell(s) based on the prediction information of the measurement report.

In step S607, the master node may notify the UE of the candidate target PSCell(s) and the corresponding execution condition(s).

In step S608, the UE may check the execution condition(s), and if an execution condition of the execution condition(s) is met, a subsequent handover procedure is performed.

Therein, step S606 may be performed before step S605 or simultaneously with step S605.

### Embodiment 5

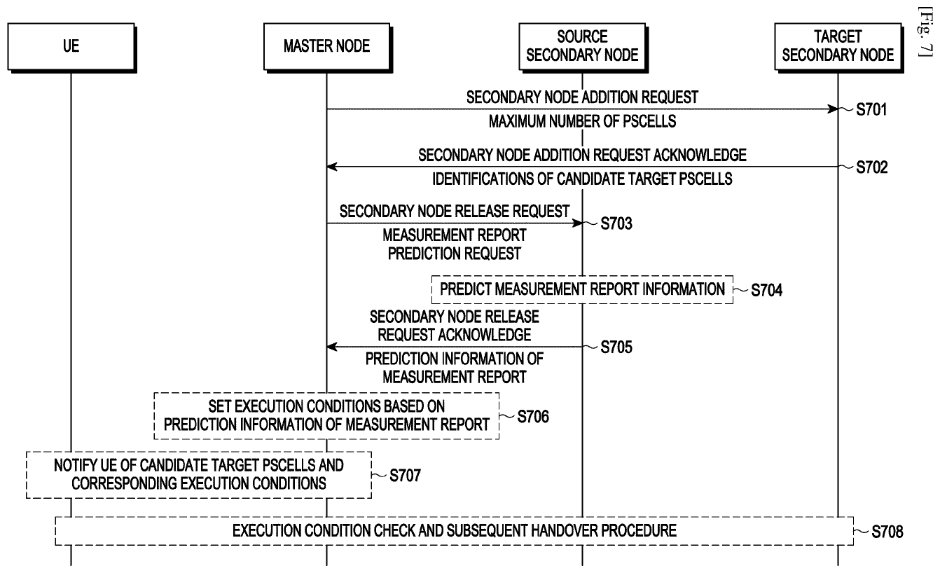

Embodiment 5 will be described below with reference to FIG. 7. Embodiment 5 describes a method for supporting data collection and processing according to some embodiments of the disclosure.

FIG. 7 illustrates a method for supporting data collection and processing according to some embodiments of the disclosure. Specifically, FIG. 7 illustrates a procedure of communicating prediction information of a measurement report of a UE between nodes in a case of dual connectivity, for supporting and optimizing a procedure of conditional PSCell change. For example, the source secondary node may provide a prediction result to the master node after measurement report prediction is performed, for the master node to perform selecting of candidate target PSCell(s) and setting of execution condition(s) of the candidate target PSCell(s), so that accurate target cells are provided, invalid target cells are reduced and accurate execution conditions are set, thereby ensuring the handover success rate, and reducing situations such as handover failure, too many candidate target nodes, etc. In some implementations, for example, the master node may be a gNB or a gNB CU-CP or an en-gNB or an eNB or an ng-eNB, the source secondary node may be a gNB or a gNB CU-CP or an en-gNB or an eNB or an ng-eNB, and the target secondary node may be a gNB or a gNB CU-CP or an en-gNB or an eNB or an ng-eNB.

In step S701, the master node may transmit a secondary node addition request message carrying a maximum number of PSCells to the target secondary node.

In step S702, the target secondary node may perform selection of candidate target PSCell(s), and may feed back a secondary node addition request acknowledge message carrying identification(s) of the selected candidate target PSCell(s) to the master node.

In step S703, the master node may transmit a secondary node release request message carrying a measurement report prediction request (for example, corresponding to the aforementioned first request) to the source secondary node. In some implementations, for example, the secondary node release request message may be the aforementioned second message including the first request.

In step S704, the source secondary node may perform prediction of measurement report information according to collected measurement report(s). In some implementations, for example, the prediction of the measurement report information may be implemented by an AI model (for example, a machine learning model). For example, the measurement report information may be predicted by using the machine learning model.

In step S705, the source secondary node may transmit a secondary node release request acknowledge message carrying a measurement report prediction result (for example, it may correspond to the first prediction result) to the master node. In some implementations, the secondary node release request acknowledge message may be the aforementioned first message including the first prediction result.

In step S706, the master node may screen the received candidate target PSCell(s) and set execution condition(s) for the candidate target PSCell(s) based on the prediction information of the measurement report.

In step S707, the master node may notify the UE of the candidate target PSCell(s) and the corresponding execution condition(s).

In step S708, the UE may check the execution condition(s), and if an execution condition of the execution condition(s) is met, a subsequent handover procedure is performed.

### Embodiment 6

Embodiment 6 describes a method for supporting data collection and processing according to some embodiments of the disclosure.

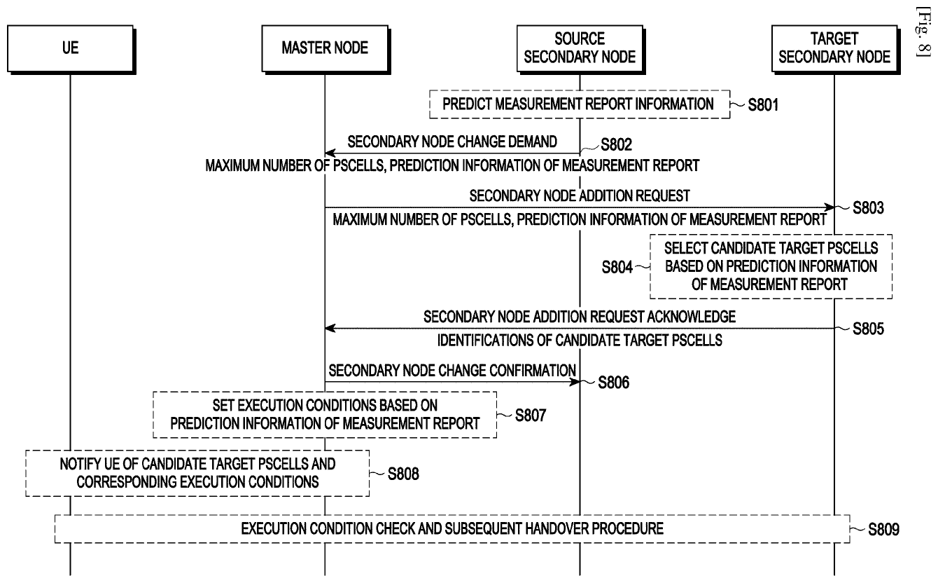

Embodiment 6 will be described below with reference to FIG. 8. FIG. 8 illustrates a schematic diagram of a method supporting data collection and processing according to some embodiments of the disclosure. Specifically, FIG. 8 illustrates a procedure of communicating prediction information of a measurement report of a UE between nodes in a case of dual connectivity, for supporting and optimizing a procedure of conditional PSCell change. For example, after measurement report prediction is performed, the source secondary node may provide the prediction result to the master node, and the master node may provide the prediction result to the target secondary node for the target secondary node to perform selecting of candidate target PSCell(s) and setting of execution condition(s), so that accurate target cells are provided and invalid target cells are reduced, thereby ensuring the handover success rate, reducing situations such as handover failure, too many candidate target nodes, etc., and reducing signaling overhead; the master node also perform selecting of candidate target PSCell(s) and setting of the execution condition(s) according to the prediction result, so that accurate target cells are provided, invalid target cells are reduced and accurate execution conditions are set, thereby ensuring the handover success rate, and reducing situations such as handover failure, too many candidate target nodes, etc. In some implementations, for example, the master node may be a gNB or a gNB CU-CP or an en-gNB or an eNB or an ng-eNB, the source secondary node may be a gNB or a gNB CU-CP or an en-gNB or an eNB or an ng-eNB, and the target secondary node may be a gNB or a gNB CU-CP or an en-gNB or an eNB or an ng-eNB.

In step S801, the source secondary node may perform prediction of measurement report information according to collected measurement report(s). In some implementations, for example, the prediction of the measurement report information may be implemented by an AI model (for example, a machine learning model).

In step S802, the source secondary node may transmit a secondary node change required message carrying a maximum number of PSCells and/or prediction information of the measurement report (for example, corresponding to the aforementioned first prediction result) to the master node. In some implementations, the secondary node change required message may be the aforementioned first message including the first prediction result.

In step S803, the master node may transmit a secondary node addition request message carrying the maximum number of PSCells and/or the prediction information of the measurement report to the target secondary node. In some implementations, the secondary node addition request message may be the aforementioned first message including the first prediction result.

In step S804, the target secondary node may perform selection of candidate target PSCell(s) based on the prediction information of the measurement report.

In step S805, the target secondary node may transmit a secondary node addition request acknowledge message carrying identification(s) of the selected candidate target PSCell(s) to the master node.

In step S806, the master node may transmit a secondary node change confirmation message to the source node.

In step S807, the master node may perform selecting of the received candidate target PSCell(s) and set execution condition(s) based on the prediction information of the measurement report.

In step S808, the master node may notify the UE of the candidate target PSCell(s) and the corresponding execution condition(s).

In step S809, the UE may check the execution condition(s), and if an execution condition of the execution condition(s) is met, a subsequent handover procedure is performed.

Therein, step S807 may be performed before step S806 or simultaneously with step S806.

In some implementations, the machine learning model for the prediction of the measurement report in each of Embodiments 1-6 may include, but is not limited to, perceptrons, feedforward neural networks, radial basis function networks, deep feedforward networks, recurrent neural networks, long/short-term memory networks, gated recurrent units, auto-encoders, variational auto-encoders, denoising auto-encoders, sparse auto-encoders, Markov chains, Hopfield networks, Boltzmann machines, restricted Boltzmann machines, deep belief networks, deep convolutional networks, deconvolutional neural networks, deep convolutional inverse graphics networks, generative adversarial networks, liquid state machines, extreme learning machines, echo state networks, deep residual networks, Kohonen networks, support vector machines, neural turing machines, convolutional neural networks, artificial neural networks, recurrent neural networks, deep neural networks, etc.

In some implementations, the machine learning model may be trained by online training, offline training, supervised learning, unsupervised learning, reinforcement learning, etc.

In some implementations, the input of the machine learning model may include one or more of an identification of a UE, a time point, a measurement value (for example, RSRP/RSRQ/SINR), a location coordinate, a camping cell, a movement velocity (including a movement speed magnitude and/or a movement direction), etc.

In some implementations, the output of the machine learning model may include one or more of a time point, a cell identification, a predicted measurement value (a RSRP value, RSRQ value, or SINR value), a changing trend of the RSRP or RSRQ or SINR (for example, increasing or abruptly increasing or decreasing or abruptly decreasing or remaining unchanged or changing in a ping-pong way, etc.).

### Embodiment 7

Embodiment 7 describes a method for supporting data collection and processing according to some embodiments of the disclosure.

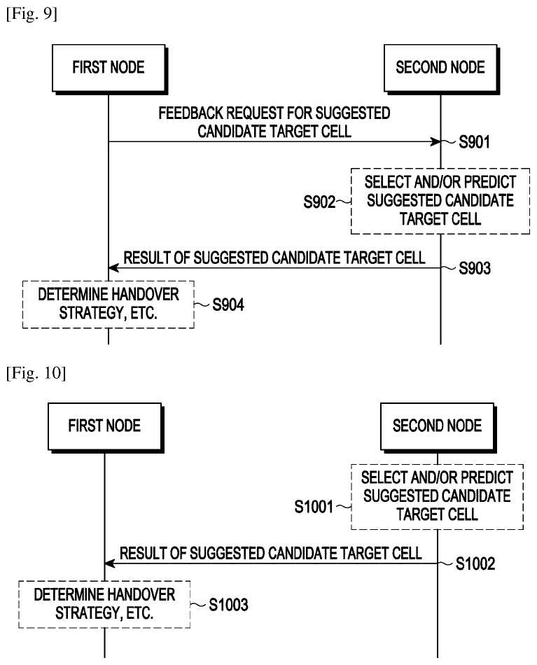

Embodiment 7 will be described below with reference to FIG. 9. FIG. 9 illustrates a schematic diagram of a method supporting data collection and processing according to some embodiments of the disclosure. Specifically, FIG. 9 illustrates a procedure of communicating information of a suggested candidate target cell for a UE between nodes, so as to provide the nodes with information of the suggested candidate target cell for the UE, and thus to provide reference information for target node selection, handover execution condition setting, determination of whether to perform handover, determination of a handover timing, etc. for the UE, thereby avoiding situations such as too many candidate target nodes, inaccurate candidate target nodes, handover failure, handover ping-pong, etc. In some implementations, for example, the first node may be a gNB or a gNB CU-CP or an en-gNB or an eNB or an ng-eNB, and the second node may be a gNB or a gNB CU-CP or an en-gNB or an eNB or an ng-eNB.

In step S901, the first node may transmit a feedback request for a suggested candidate target cell (for example, corresponding to the aforementioned second request) to the second node, so as to inform the second node of a requirement to feed back information of the suggested candidate target cell of a UE to the first node. In some implementations, for example, the message carrying the feedback request of the suggested candidate target cell may be the aforementioned fifth message including the second request.

In step S902, the second node may, for example, select and/or predict a suggested candidate target cell based on collected measurement report information of the UE. In some implementations, for example, the selection and/or prediction of the suggested candidate target cell may be implemented by an AI model (e.g., a machine learning model). For example, the suggested candidate target cell may be selected and/or predicted by using a machine learning model.

In step S903, the second node may transmit a result of the suggested candidate target cell (for example, corresponding to the aforementioned first feedback result) to the first node, so as to inform the first node of the selection and/or prediction result. In some implementations, for example, the message carrying the result of the suggested candidate target cell may be the aforementioned fourth message including the first feedback result. If the second node cannot report the result of the suggested candidate target cell of the UE as required, it will inform the first node of the failure of the feedback request for the suggested candidate target cell, and will not proceed to step S904. In some implementations, for example, the message carrying the failure of the feedback request of the suggested candidate target cell may be the aforementioned sixth message including information indicating the feedback failure of the suggested candidate target cell.

In step S904, the first node may perform target node selection, handover execution condition setting, determination of whether to perform handover, and determination of a handover timing, etc. for the UE according to information of the suggested candidate target cell, etc.

### Embodiment 8

Embodiment 8 describes a method for supporting data collection and processing according to some embodiments of the disclosure.

Embodiment 8 will be described below with reference to FIG. 10. FIG. 10 illustrates a schematic diagram of a method supporting data collection and processing according to some embodiments of the disclosure. Specifically, FIG. 10 illustrates communicating of information of a suggested candidate target cell for a UE between nodes according to their own situations, so as to provide the nodes with the information of the suggested candidate target cell for the UE, and thus to provide reference information for target node selection, handover execution condition setting, determination of whether to perform handover, determination of a handover timing, etc. for the UE, thereby avoiding situations such as too many candidate target nodes, inaccurate candidate target nodes, handover failure, handover ping-pong, etc. In some implementations, for example, the first node may be a gNB or a gNB CU-CP or an en-gNB or an eNB or an ng-eNB, and the second node may be a gNB or a gNB CU-CP or an en-gNB or an eNB or an ng-eNB.

In step S1001, the second node may, for example, select and/or predict a suggested candidate target cell based on collected measurement report information of the UE. In some implementations, for example, the selection and/or prediction of information of the suggested candidate target cell may be implemented by an AI model (e.g., a machine learning model). For example, the suggested candidate target cell may be selected and/or predicted by using a machine learning model.

In step S1002, the second node may, for example, transmit a result of the suggested candidate target cell (for example, corresponding to the aforementioned first feedback result) to the first node according to its own situation, so as to inform the first node of the selection and/or prediction result. In some implementations, for example, the message carrying the result of the suggested candidate target cell may be the aforementioned fourth message including the first feedback result.

In step S1003, the first node may perform target node selection, handover execution condition setting, determination of whether to perform handover, and determination of a handover timing, etc. for the UE according to information of the suggested candidate target cell, etc.

### Embodiment 9

Embodiment 9 describes a method for supporting data collection and processing according to some embodiments of the disclosure.

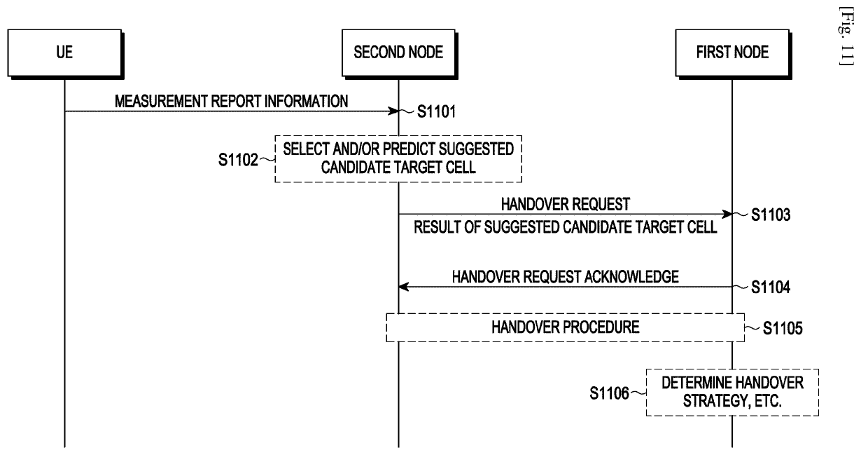

Embodiment 9 will be described below with reference to FIG. 11. FIG. 11 illustrates a schematic diagram of a method supporting data collection and processing according to some embodiments of the disclosure. Specifically, FIG. 11 illustrates a procedure of communicating information of a suggested candidate target cell for a UE between nodes according to their own conditions in a handover procedure, so as to provide the nodes with the information of the suggested candidate target cell for the UE, and thus to provide reference information for target node selection, handover execution condition setting, determination of whether to perform handover, determination of a handover timing, etc. for the UE, thereby reducing situations such as too many candidate target nodes, inaccurate candidate target nodes, handover failure, handover ping-pong, etc. In some implementations, for example, the first node may be a gNB or a gNB CU-CP or an en-gNB or an eNB or an ng-eNB, and the second node may be a gNB or a gNB CU-CP or an en-gNB or an eNB or an ng-eNB.

In step S1101, the UE may report its own measurement information to the second node. In some implementations, for example, the reported measurement information may be a measurement report.

In step S1102, the second node may, for example, select and/or predict a suggested candidate target cell based on collected measurement report information of the UE. In some implementations, for example, the selection and/or prediction of the suggested candidate target cell may be implemented by an AI model (e.g., a machine learning model). For example, the suggested candidate target cell may be selected and/or predicted by using the machine learning model.

In step S1103, the second node may transmit information of the suggested candidate target cell (for example, corresponding to the aforementioned first feedback result) to the first node in a handover request for the UE, so as to inform the first node of the selection and/or prediction result of the UE. In some implementations, for example, the message carrying the information of the suggested candidate target cell may be the aforementioned fourth message including the first feedback result.

In step S1104, the first node may transmit a handover request acknowledge message to the second node to confirm the handover request.

In step S1105, the second node and the first node may perform a handover procedure for the UE.

In step S1106, the first node may perform target node selection, handover execution condition setting, determination of whether to perform handover, and determination of a handover timing, etc. for the UE according to information of the suggested candidate target cell, etc.

### Embodiment 10

Embodiment 10 describes a method for supporting data collection and processing according to some embodiments of the disclosure.

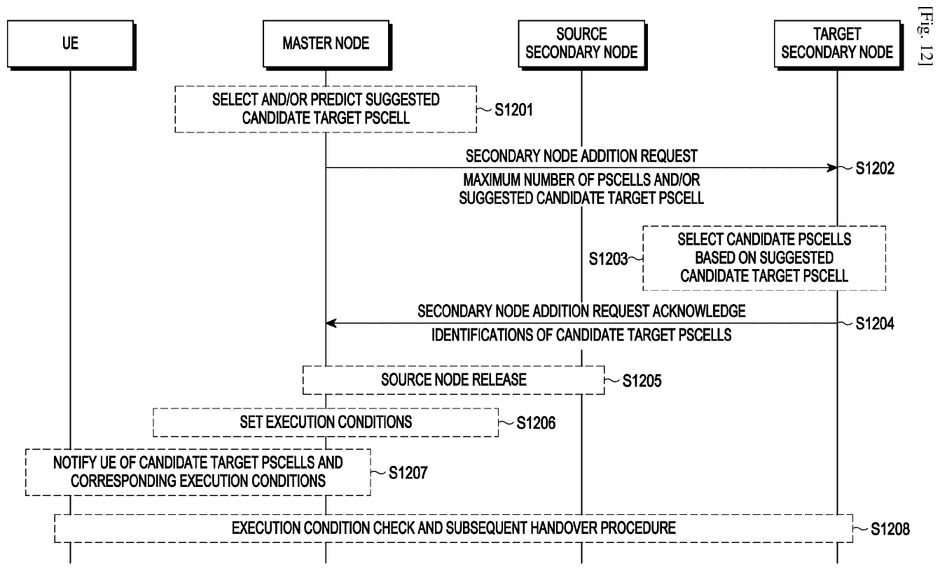

Embodiment 10 will be described below with reference to FIG. 12. FIG. 12 illustrates a schematic diagram of a method supporting data collection and processing according to some embodiments of the disclosure. Specifically, FIG. 12 illustrates a procedure of communicating information of a suggested candidate target cell for a UE between nodes in a case of dual connectivity, for supporting and optimizing a procedure of conditional PSCell change. For example, after selecting and/or predicting the suggested candidate target cell, the master node may provide the result to the target secondary node for the target secondary node to perform selection of candidate target PSCell(s), so that accurate target cells are provided and invalid target cells are reduced, thereby ensuring the handover success rate, reducing situations such as handover failure, too many candidate target nodes, etc., and reducing signaling overhead. In some implementations, for example, the master node may be a gNB or a gNB CU-CP or an en-gNB or an eNB or an ng-eNB, the source secondary node may be a gNB or a gNB CU-CP or an en-gNB or an eNB or an ng-eNB, and the target secondary node may be a gNB or a gNB CU-CP or an en-gNB or an eNB or an ng-eNB.

In step S1201, the master node may, for example, select and/or predict a suggested candidate target cell according to collected measurement report(s). In some implementations, for example, the selection and/or prediction of the suggested candidate target cell may be implemented by an AI model (e.g., a machine learning model). For example, the suggested candidate target cell may be selected and/or predicted by using a machine learning model.

In step S1202, the master node may transmit a secondary node addition request message carrying a maximum number of PSCells and/or a result of the suggested candidate target cell (for example, corresponding to the aforementioned first feedback result) to the target secondary node. In some implementations, the secondary node addition request message may be the aforementioned fourth message including the first feedback result.

In step S1203, the target secondary node may select candidate target PSCell(s) based on the information of the suggested candidate target cell, where the number of candidate target PSCells does not exceed the received maximum number of PSCells.

In step S1204, the target secondary node may transmit a secondary node addition request acknowledge message carrying identification(s) of the selected PSCell(s) to the master node.

In step S1205, the master node may communicate messages with the source secondary node to release the source secondary node.

In step S1206, the master node may set execution condition(s) for the received candidate target PSCell(s).

In step S1207, the master node may notify the UE of the candidate target PSCell(s) and the corresponding execution condition(s).

In step S1208, the UE may check the execution condition(s), and if an execution condition of the execution condition(s) is met, a subsequent handover procedure is performed.

Therein, step S1206 may be performed before step S1205 or simultaneously with step S1205.

### Embodiment 11

Embodiment 11 describes a method for supporting data collection and processing according to some embodiments of the disclosure.

Embodiment 11 will be described below with reference to FIG. 13. FIG. 13 illustrates a schematic diagram of a method supporting data collection and processing according to some embodiments of the disclosure. Specifically, FIG. 13 illustrates a procedure of communicating information of a suggested candidate target cell for a UE between nodes in a case of dual connectivity, for supporting and optimizing a procedure of conditional PSCell change. For example, after selecting and/or predicting the suggested candidate target cell, the source secondary node may provide the result to the master node, for the master node to perform selecting of candidate target PSCell(s) and setting of execution condition(s) of the candidate target PSCell(s), so that accurate target cells are provided, invalid target cells are reduced and accurate execution conditions are set thereby ensuring the handover success rate, reduce situations such as handover failure, too many candidate target nodes, etc., and reducing signaling overhead. In some implementations, for example, the master node may be a gNB or a gNB CU-CP or an en-gNB or an eNB or an ng-eNB, the source secondary node may be a gNB or a gNB CU-CP or an en-gNB or an eNB or an ng-eNB, and the target secondary node may be a gNB or a gNB CU-CP or an en-gNB or an eNB or an ng-eNB.

With reference to FIG. 13, in step S1301, the master node may transmit a secondary node addition request message carrying a maximum number of PSCells to the target secondary node.

In step S1302, the target secondary node may perform selection of candidate target PSCell(s), and feed back a secondary node addition request acknowledge message carrying identification(s) of the selected candidate target PSCell(s) to the master node.

In step S1303, the master node may transmit a secondary node release request message carrying a feedback request of a suggested candidate target cell (for example, the second request) to the source secondary node. In some implementations, for example, the secondary node release request message may be the aforementioned fifth message including the second request.

In step S1304, the source secondary node may select and/or predict information of the suggested candidate target cell according to collected measurement report(s). In some implementations, for example, the selection and/or prediction of the suggested candidate target cell may be implemented by an AI model (e.g., a machine learning model). For example, the suggested candidate target cell may be selected and/or predicted by using a machine learning model.

In step S1305, the source secondary node may transmit a secondary node release request acknowledge message carrying the result of the suggested candidate target cell (for example, corresponding to the aforementioned first feedback result) to the master node. In some implementations, the secondary node release request acknowledge message may be the aforementioned fourth message including the first feedback result.

In step S1306, the master node may select the received candidate target PSCell(s) and set execution condition(s) for the candidate target PSCell(s).

In step S1307, the master node may notify the UE of the candidate target PSCell(s) and the corresponding execution condition(s).

In step S1308, the UE may check the execution condition(s), and if an execution condition of the execution condition(s) is met, a subsequent handover procedure is performed.

### Embodiment 12

Embodiment 12 describes a method for supporting data collection and processing according to some embodiments of the disclosure.

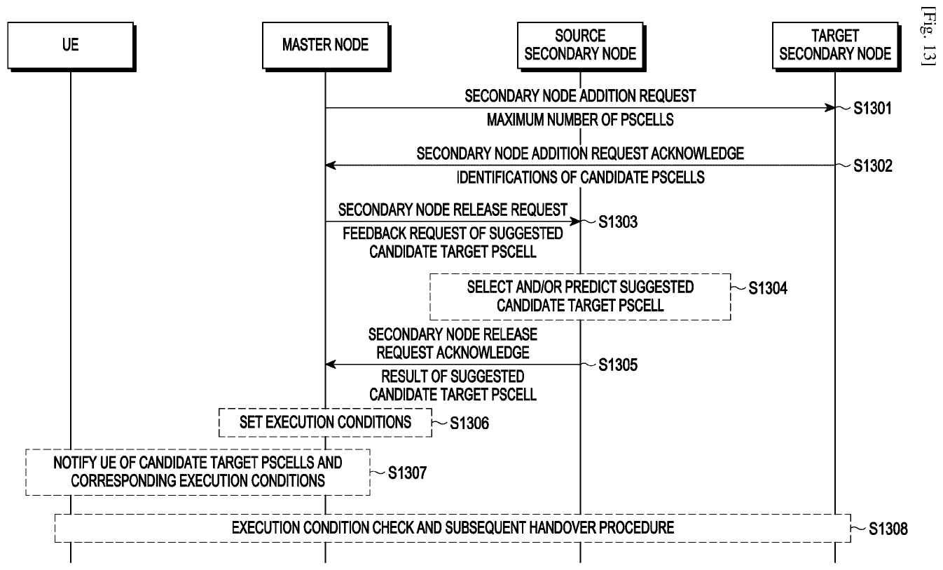

Embodiment 12 will be described below with reference to FIG. 14. FIG. 14 illustrates a schematic diagram of a method supporting data collection and processing according to some embodiments of the disclosure. Specifically, FIG. 14 illustrates a procedure of communicating information of a suggested candidate target cell for a UE between nodes in a case of dual connectivity, for supporting and optimizing a procedure of conditional PSCell change. For example, after selecting and/or predicting the suggested candidate target cell, the source secondary node may provide the result to the master node, and the master node may provide the result to the target secondary node for the target secondary node to perform selection of candidate target PSCell(s), so that accurate target cells are provided and invalid target cells are reduced, thereby ensuring the handover success rate, reducing situations such as handover failure, too many candidate target nodes, etc., and reducing signaling overhead. In some implementations, for example, the master node may be a gNB or a gNB CU-CP or an en-gNB or an eNB or an ng-eNB, the source secondary node may be a gNB or a gNB CU-CP or an en-gNB or an eNB or an ng-eNB, and the target secondary node may be a gNB or a gNB CU-CP or an en-gNB or an eNB or an ng-eNB.

Referring to FIG. 14, in step S1401, the source secondary node may select and/or predict information of a suggested candidate target cell according to collected measurement report(s). In some implementations, for example, the selection and/or prediction of information of the suggested candidate target cell may be implemented by an AI model (e.g., a machine learning model). For example, the suggested candidate target cell may be selected and/or predicted by using the machine learning model.

In step S1402, the source secondary node may transmit a secondary node change required message carrying a maximum number of PSCells and/or information of the suggested candidate target cell (for example, corresponding to the first feedback result) to the master node. In some implementations, the secondary node change required message may be the aforementioned fourth message including the first feedback result.

In step S1403, the master node may transmit a secondary node addition request message carrying the maximum number of PSCells and/or the information of the suggested candidate target cell to the target secondary node.

In step S1404, the target secondary node may perform selection of candidate target PSCell(s) based on the information of the suggested candidate target cell.

In step S1405, the target secondary node may transmit a secondary node addition request acknowledge message carrying identification(s) of the selected candidate target PSCell(s) to the master node.

In step S1406, the master node may transmit a secondary node change confirmation message to the source node.

In step S1407, the master node may set execution condition(s) for the received candidate target PSCell(s).

In step S1408, the master node may notify the UE of the candidate target PSCell(s) and the corresponding execution condition(s).

In step S1409, the UE may check the execution condition(s), and if an execution condition of the execution condition(s) is met, a subsequent handover procedure is performed.

Therein, step S1407 may be performed before or simultaneously with step S1406.

### Embodiment 13

Embodiment 13 describes a method for supporting data collection and processing according to some embodiments of the disclosure.

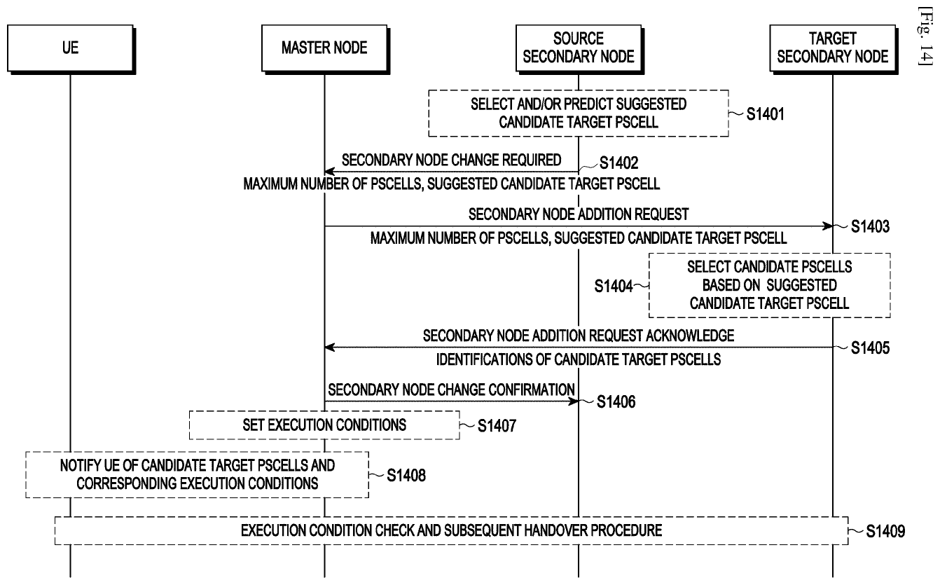

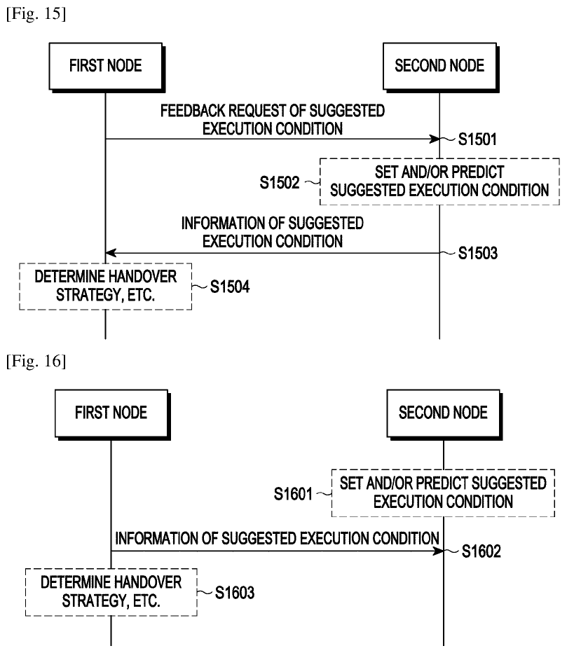

Embodiment 13 will be described below with reference to FIG. 15. FIG. 15 illustrates a schematic diagram of a method supporting data collection and processing according to some embodiments of the disclosure. Specifically, FIG. 15 illustrates a procedure of communicating information of a suggested execution condition for a UE between nodes, so as to provide the nodes with the information of the suggested execution condition for the UE, and thus to provide reference information for performing handover execution condition setting, target node selection, determination of whether to perform handover, and determination of a handover timing, etc. for the UE, thereby reducing situations such as inaccurate handover condition, handover failure, handover ping-pong, etc. In some implementations, for example, the first node may be a gNB or a gNB CU-CP or an en-gNB or an eNB or an ng-eNB, and the second node may be a gNB or a gNB CU-CP or an en-gNB or an eNB or an ng-eNB.

Referring to FIG. 15, in step S1501, the first node may transmit a feedback request of a suggested execution condition (for example, corresponding to the aforementioned third request) to the second node, so as to inform the second node of a requirement to feed back information of the suggested execution condition of a UE to the first node. In some implementations, for example, the message carrying the feedback of the suggested execution condition may be the aforementioned eighth message including the third request.

In step S1502, the second node may set and/or predict the suggested execution condition for a candidate target cell based on collected measurement report information of the UE. In some implementations, for example, the setting and/or prediction of the suggested execution condition may be implemented by an AI model (e.g., a machine learning model). For example, the suggested execution condition may be selected and/or predicted by using the machine learn model.

In step S1503, the second node may transmit a result of the suggested execution condition (for example, corresponding to the second feedback result) to the first node, so as to inform the first node of the setting and/or prediction result. In some implementations, for example, the message carrying the suggested execution condition may be the aforementioned seventh message including the second feedback result. If the second node cannot report the result of the suggested execution condition of the candidate target cell of the UE as required, it will inform the first node of the failure of the feedback request of the suggested execution condition and will not proceed to step S904. In some implementations, for example, the message carrying the failure of the feedback request of the suggested execution condition may be the aforementioned ninth message including information indicating the feedback failure of the suggested execution condition.

In step S1504, the first node may perform target node selection, handover execution condition setting, determination of whether to perform handover, and determination of a handover timing, etc. for the UE according to information of the suggested execution condition, etc.

### Embodiment 14

Embodiment 14 describes a method for supporting data collection and processing according to some embodiments of the disclosure.

Embodiment 14 will be described below with reference to FIG. 16. FIG. 16 illustrates a schematic diagram of a method supporting data collection and processing according to some embodiments of the disclosure. Specifically, FIG. 16 illustrates communicating of information of a suggested execution condition for a UE between nodes according to their own situations, so as to provide the nodes with the information of the suggested execution condition for the candidate target cell of the UE, and thus to provide reference information for performing handover execution condition setting, target node selection, determination of whether to perform handover, and determination of a handover timing, etc. for the UE, thereby reducing situations such as inaccurate handover condition, handover failure, handover ping-pong, etc. In some implementations, for example, the first node may be a gNB or a gNB CU-CP or an en-gNB or an eNB or an ng-eNB, and the second node may be a gNB or a gNB CU-CP or an en-gNB or an eNB or an ng-eNB.

Referring to FIG. 16, in step S1601, the second node may set and/or predict a suggested execution condition for a candidate target cell based on collected measurement report information of the UE. In some implementations, for example, the setting and/or prediction of information of the suggested execution condition may be implemented by an AI model (e.g., a machine learning model). For example, the suggested execution condition may be selected and/or predicted by using the machine learn model.

In step S1602, the second node may, for example, transmit a result of the suggested execution condition (e.g., corresponding to the second feedback result) to the first node according to its own situation, so as to inform the first node of the setting and/or prediction result. In some implementations, for example, the message carrying the result of the suggested execution condition may be the aforementioned seventh message including the second feedback result.

In step S1603, the first node may perform target node selection, handover execution condition setting, determination of whether to perform handover, and determination of a handover timing, etc. for the UE according to the information of the suggested execution condition, etc.

### Embodiment 15

Embodiment 15 describes a method for supporting data collection and processing according to some embodiments of the disclosure.

Embodiment 15 will be described below with reference to FIG. 17. FIG. 17 illustrates a schematic diagram of a method supporting data collection and processing according to some embodiments of the disclosure. Specifically, FIG. 17 illustrates a procedure of communicating information of a suggested candidate target cell for a UE and/or a suggested execution condition between nodes according to their own situations in a handover procedure, so as to provide the nodes with information of the suggested candidate target cell for the UE and/or the suggested execution condition, and thus provide reference information for target node selection, handover execution condition setting, determination of whether to perform handover, determination of a handover timing, etc. for the UE, thereby reducing situations such as too many candidate target nodes, inaccurate candidate target nodes, inaccurate handover condition, handover failure and handover ping-pong, etc. In some implementations, for example, the first node may be a gNB or a gNB CU-CP or an en-gNB or an eNB or an ng-eNB, and the second node may be a gNB or a gNB CU-CP or an en-gNB or an eNB or an ng-eNB.

Referring to FIG. 17, in step S1701, the UE may report its own measurement information to the second node. In some implementations, for example, the reported measurement information may be a measurement report.

In step S1702, the second node may select and/or predict a suggested candidate target cell and/or a suggested execution condition based on collected measurement report information of the UE. In some implementations, for example, the selection and/or prediction of the suggested candidate target cell may be implemented by an AI model (e.g., a machine learning model), and/or the setting and/or prediction of the suggested execution condition may be implemented by the AI model (e.g., a machine learning model).

In step S1703, the second node may transmit information of the suggested candidate target cell (e.g., corresponding to the aforementioned first feedback result) and/or information of the suggested execution condition (e.g., corresponding to the aforementioned second feedback result) to the first node in a handover request for the UE, so as to inform the first node of the selected and/or predicted target cell for the UE and/or information of the suggested execution condition. In some implementations, for example, the message carrying the information of the suggested candidate target cell and/or information of the suggested execution condition may refer to the aforementioned fourth message including the first feedback result and/or the aforementioned seventh message including the second feedback result.

In step S1704, the first node may transmit a handover request acknowledge message to the second node to confirm the handover request.

In step S1705, the second node and the first node may perform a handover procedure for the UE.

In step S1706, the first node may perform target node selection, handover execution condition setting, determination of whether to perform handover, and determination of a handover timing, etc. for the UE according to the information of the suggested candidate target cell and/or the information of the suggested execution condition.

### Embodiment 16

Embodiment 16 describes a method for supporting data collection and processing according to some embodiments of the disclosure.

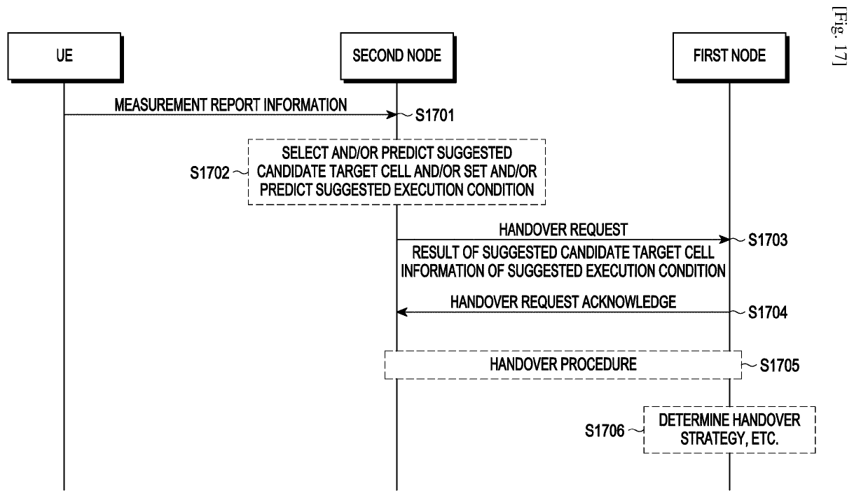

Embodiment 16 will be described below with reference to FIG. 18. FIG. 18 illustrates a schematic diagram of a method supporting data collection and processing according to some embodiments of the disclosure. Specifically, FIG. 18 illustrates a procedure of communicating information of a suggested candidate execution condition for a UE between nodes in a case of dual connectivity, for supporting and optimizing a procedure of conditional PSCell change. For example, after setting and/or predicting a suggested candidate execution condition, the source secondary node may provide the result to the master node for the master node to set an execution condition for a candidate target PSCell, so that an accurate execution condition is set, thereby ensuring the handover success rate and reducing handover failure. In some implementations, for example, the master node may be a gNB or a gNB CU-CP or an en-gNB or an eNB or an ng-eNB, the source secondary node may be a gNB or a gNB CU-CP or an en-gNB or an eNB or an ng-eNB, and the target secondary node may be a gNB or a gNB CU-CP or an en-gNB or an eNB or an ng-eNB.

With reference to FIG. 18, in step S1801, the master node may transmit a secondary node addition request message carrying a maximum number of PSCells to the target secondary node.

In step S1802, the target secondary node may perform selection of candidate target PSCell(s), and feed back a secondary node addition request acknowledge message carrying identification(s) of the selected candidate target PSCell(s) to the master node.

In step S1803, the master node may transmit a secondary node release request message carrying a feedback request of a suggested execution condition (for example, corresponding to the third request) to the source secondary node. In some implementations, for example, the secondary node release request message may be the aforementioned eighth message including the third request.

In step S1804, the source secondary node may set and/or predict information of the suggested execution condition for the candidate target cell of the UE according to collected measurement report(s). In some implementations, for example, the setting and/or prediction of the suggested execution condition may be implemented by an AI model (e.g., a machine learning model).

In step S1805, the source secondary node may transmit a secondary node release request acknowledge message carrying a result of the suggested execution condition (for example, corresponding to the second feedback result) to the master node. In some implementations, the secondary node release request acknowledge message may be the aforementioned seventh message including the second feedback result.

In step S1806, the master node may set an execution condition for a received candidate target PSCell with reference to the suggested execution condition provided by the source secondary node.

In step S1807, the master node may notify the UE of the candidate target PSCell(s) and the corresponding execution condition(s).

In step S1808, the UE may check the execution condition(s), and if an execution condition of the execution condition(s) is met, a subsequent handover procedure is performed.

### Embodiment 17

Embodiment 17 describes a method for supporting data collection and processing according to some embodiments of the disclosure.

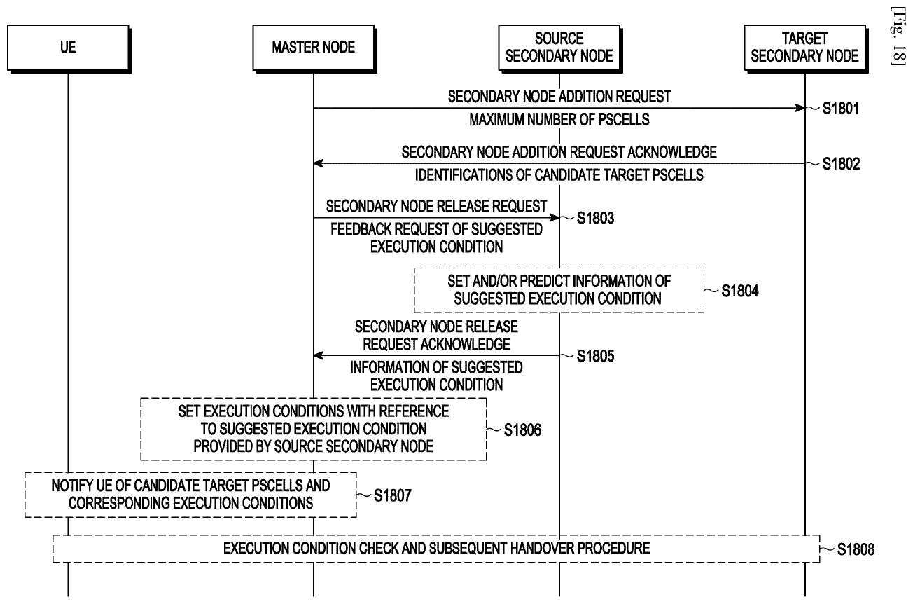

Embodiment 17 will be described below with reference to FIG. 19. FIG. 19 illustrates a schematic diagram of a method supporting data collection and processing according to some embodiments of the disclosure. Specifically, FIG. 19 illustrates a procedure of communicating information of a suggested candidate target cell for a UE and/or a suggested execution condition between nodes in a case of dual connectivity, for supporting and optimizing a procedure of conditional PSCell change. For example, after selecting and/or predicting the suggested candidate target cell and/or setting and/or predicting the suggested execution condition, the source secondary node may provide the result to the master node, and the master node may provide the result of the suggested candidate target cell to the target secondary node for the target secondary node to perform selection of candidate target PSCell(s), and thus accurate target cells are provided and invalid target cells are reduced, thereby ensuring the handover success rate, reducing situations such as handover failure, too many candidate target nodes, etc., and reducing signaling overhead; after obtaining information of the suggested execution condition, the master node may provide reference information for performing handover execution condition setting, target node selection, determination of whether to perform handover, and determination of a handover timing, etc. for the UE, thereby reducing situations such as inaccurate handover condition, handover failure, handover ping-pong, etc. In some implementations, for example, the master node may be a gNB or a gNB CU-CP or an en-gNB or an eNB or an ng-eNB, the source secondary node may be a gNB or a gNB CU-CP or an en-gNB or an eNB or an ng-eNB, and the target secondary node may be a gNB or a gNB CU-CP or an en-gNB or an eNB or an ng-eNB.

Referring to FIG. 19, in step S1901, the source secondary node may select and/or predict information of a suggested candidate target cell and/or set and/or predict a suggested execution condition according to collected measurement report(s). In some implementations, for example, the selection and/or prediction of information of the suggested candidate target cell may be implemented by an AI model (e.g., a machine learning model), and the setting and/or prediction of the suggested execution condition may be implemented by an AI model (e.g., a machine learning model).

In step S1902, the source secondary node may transmit a secondary node change required carrying a maximum number of PSCells and/or information of the suggested candidate target cell (for example, corresponding to the first feedback result) and/or the suggested execution condition (for example, corresponding to the second feedback result) to the master node. In some implementations, the secondary node change required message may be the aforementioned fourth message including the first feedback result and/or the aforementioned seventh message including the second feedback result.

In step S1903, the master node may transmit a secondary node addition request message carrying the maximum number of PSCells and/or the information of the suggested candidate target cell to the target secondary node.

In step S1904, the target secondary node may perform selection of candidate target PSCell(s) based on the information of the suggested candidate target cell.

In step S1905, the target secondary node may transmit a secondary node addition request acknowledge message carrying identification(s) of the selected candidate target PSCell(s) to the master node.

In step S1906, the master node may transmit a secondary node change confirmation message to the source node.

In step S1907, the master node may set an execution condition for a received candidate target PSCell with reference to the suggested execution condition provided by the source secondary node.

In step S1908, the master node may notify the UE of the candidate target PSCell(s) and the corresponding execution condition(s).

In step S1909, the UE may check the execution condition(s), and if an execution condition of the execution condition(s) is met, a subsequent handover procedure is performed.

Therein, step S1907 may be performed before step S1906 or simultaneously with step S1906.

### Embodiment 18

Embodiment 18 describes a method for supporting data collection and processing according to some embodiments of the disclosure.

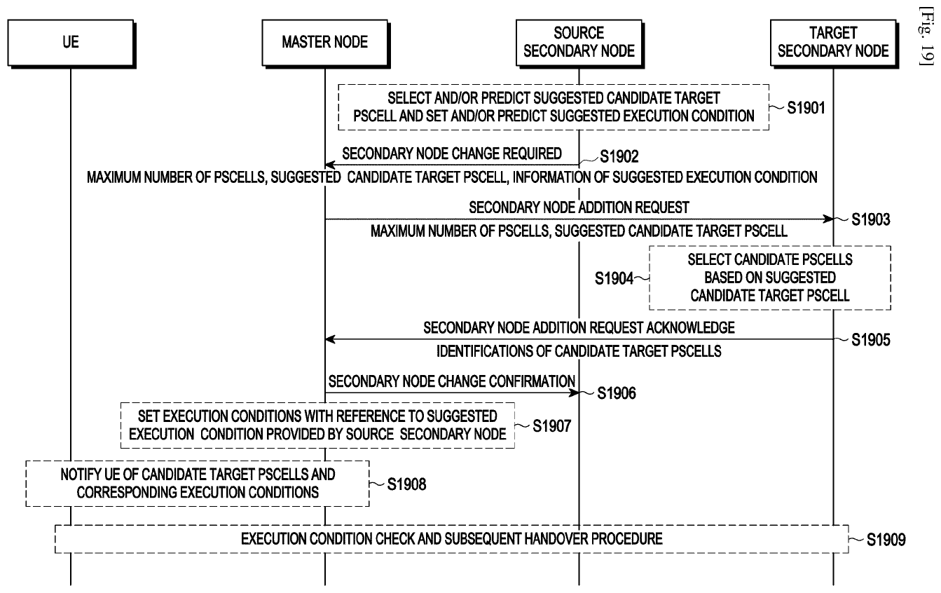

Embodiment 18 will be described below with reference to FIG. 20. FIG. 20 illustrates a schematic diagram of a method supporting data collection and processing according to some embodiments of the disclosure. Specifically, FIG. 13 illustrates a procedure of communicating information of a suggested execution condition for a UE between nodes in a case of dual connectivity, for supporting and optimizing a procedure of conditional PSCell change. After setting and/or predicting the suggested execution condition of the candidate target cell, the target secondary node provides the result to the master node for the master node to set an execution condition for a candidate target PSCell, so that an accurate execution condition is set, thereby ensuring the handover success rate and reducing handover failure. In some implementations, for example, the master node may be a gNB or a gNB CU-CP or an en-gNB or an eNB or an ng-eNB, the source secondary node may be a gNB or a gNB CU-CP or an en-gNB or an eNB or an ng-eNB, and the target secondary node may be a gNB or a gNB CU-CP or an en-gNB or an eNB or an ng-eNB.

With reference to FIG. 20, in step S2001, the master node may transmit a secondary node addition request message carrying a maximum number of PSCells to the target secondary node.

In step S2002, the target secondary node may perform selection of candidate target PSCell(s), and/or set and/or predict suggested execution condition(s) for the candidate target PSCell(s). In some implementations, for example, the setting and/or prediction of the suggested execution condition(s) may be implemented by an AI model (e.g., a machine learning model).

In step S2003, the target secondary node may feed back a secondary node addition request acknowledge message carrying identification(s) of the selected candidate target PSCell(s) and/or corresponding suggested execution condition(s) (for example, corresponding to the second feedback result) to the master node. In some implementations, for example, the secondary node addition request acknowledge message may be the aforementioned seventh message including the second feedback result.

In step S2004, the master node may transmit a secondary node change confirmation message to the source secondary node.

In step S2005, the master node may set execution condition(s) for the received candidate target PSCell(s) with reference to the suggested execution condition(s) provided by the target secondary node.

In step S1307, the master node may notify the UE of the candidate target PSCell(s) and the corresponding execution condition(s).

In step S1308, the UE may check the execution condition(s), and if an execution condition of the execution condition(s) is met, a subsequent handover procedure is performed.

In some implementations, the machine learning model used for the selection and/or prediction of the suggested candidate target cell in each of embodiments 7-18 may include, but is not limited to, perceptrons, feedforward neural networks, radial basis function networks, deep feedforward networks, recurrent neural networks, long/short-term memory networks, gated recurrent units, auto-encoders, variational auto-encoders, denoising auto-encoders, sparse auto-encoders, Markov chains, Hopfield networks, Boltzmann machines, restricted Boltzmann machines, deep belief networks, deep convolutional networks, deconvolutional neural networks, deep convolutional inverse graphics networks, generative adversarial networks, liquid state machines, extreme learning machines, echo state networks, deep residual networks, Kohonen networks, support vector machines, neural turing machines, convolutional neural networks, artificial neural networks, recurrent neural networks, deep neural networks, etc.

In some examples, the machine learning model may be trained by online training, offline training, supervised learning, unsupervised learning, reinforcement learning, etc.

In some examples, the input of the machine learning model may include one or more of an identification of a UE, a time point, a measurement value (RSRP/RSRQ/SINR), a location coordinate, a camping cell, a moving velocity (including a magnitude and/or a direction), a neighboring node information (such as a resource state), etc.

In some examples, the output of the machine learning model may include one or more of a time point, an identification of the suggested candidate target cell, etc.

In some implementations, the machine learning model for setting and/or predicting the suggested execution condition in each of Embodiments 13-18 may include, but is not limited to, perceptrons, feedforward neural networks, radial basis function networks, deep feedforward networks, recurrent neural networks, long/short-term memory networks, gated recurrent units, auto-encoders, variational auto-encoders, denoising auto-encoders, sparse auto-encoders, Markov chains, Hopfield networks, Boltzmann machines, restricted Boltzmann machines, deep belief networks, deep convolutional networks, deconvolutional neural networks, deep convolutional inverse graphics networks, generative adversarial networks, liquid state machines, extreme learning machines, echo state networks, deep residual networks, Kohonen networks, support vector machines, neural turing machines, convolutional neural networks, artificial neural networks, recurrent neural networks, deep neural networks, etc.

In some examples, the machine learning model may be trained by online training, offline training, supervised learning, unsupervised learning, reinforcement learning, etc.

In some examples, the input of the machine learning model may include one or more of an identification of a UE, a time point, a candidate target cell, a measurement value (RSRP/RSRQ/SINR), a location coordinate, a camping cell, a moving velocity (including a magnitude and/or a direction), a neighboring node information (such as a resource state), etc.

In some examples, the output of the machine learning model may include one or more of a time point, an identification of a candidate target cell, an execution condition of a suggested candidate target cell, etc.

### Embodiment 19

Embodiment 19 describes a method for supporting data collection and processing according to some embodiments of the disclosure.

Embodiment 19 will be described below with reference to FIG. 21. FIG. 21 illustrates a schematic diagram of a method supporting data collection and processing according to some embodiments of the disclosure. Specifically, FIG. 21 illustrates a procedure of communicating prediction information of a PDCP sequence number of a UE between nodes, so as to provide the nodes with necessary information required for the prediction of the PDCP sequence number for the UE within a prediction period, so that data forwarding amount is accurately set when performing data forwarding for the UE, thereby reducing the forwarding amount of unnecessary data. In some implementations, for example, the first node may be a gNB or a gNB CU-CP or an en-gNB or an eNB or an ng-eNB, and the second node may be a gNB or a gNB CU-CP or an en-gNB or an eNB or an ng-eNB.

Referring to FIG. 21, in step S2101, the first node may transmit a prediction request for a PDCP sequence number (for example, corresponding to the fourth request) to the second node, so as to inform the second node of information required for prediction of the PDCP sequence number. In some implementations, for example, the message carrying the prediction request of the PDCP sequence number may be the aforementioned eleventh message including the fourth request.

In step S2102, the second node may perform prediction of PDCP sequence number information based on collected PDCP sequence number information for the UE. In some implementations, for example, the prediction of the PDCP sequence number may be implemented by an AI model (for example, a machine learning model).

In step S2103, the second node may determine a data forwarding strategy according to the predicted PDCP sequence number, and perform related data forwarding, so as to reduce unnecessary data forwarding amount. In some implementations, for example, PDCP sequence numbers for data forwarding predicted for different target nodes and/or cells are used as data forwarding starting points for performing data forwarding with corresponding target nodes and/or cells.

### Embodiment 20

Embodiment 20 describes a method for supporting data collection and processing according to some embodiments of the disclosure.

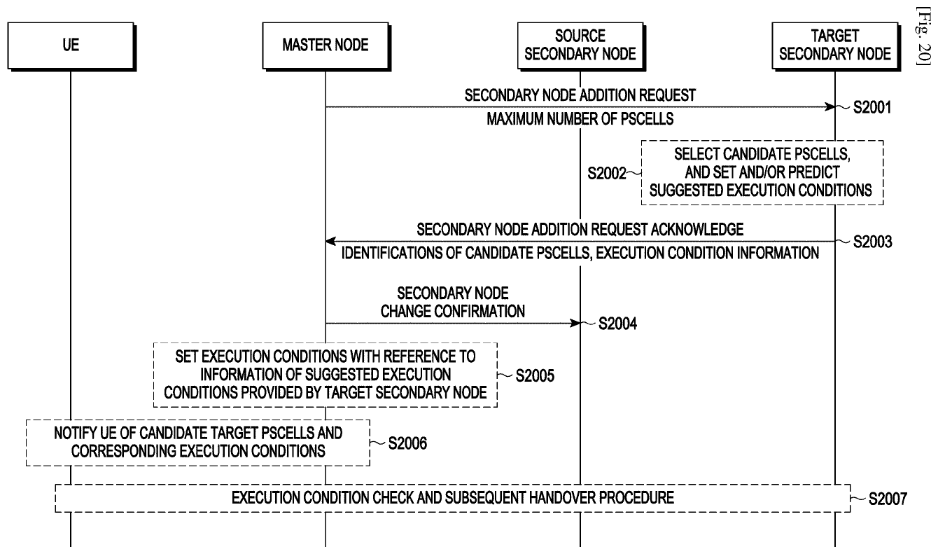

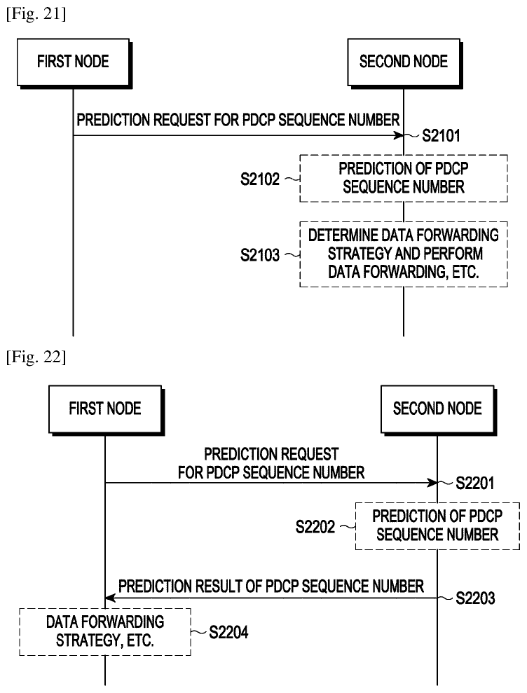

Embodiment 20 will be described below with reference to FIG. 22. FIG. 22 illustrates a schematic diagram of a method supporting data collection and processing according to some embodiments of the disclosure. Specifically, FIG. 22 illustrates a procedure of communicating prediction information of a PDCP sequence number of a UE between nodes, so as to provide the nodes with necessary information required for the prediction of the PDCP sequence number for the UE within a prediction period, and feed back a related prediction result of the PDCP sequence number to the first node, so that the data forwarding amount is accurately set when performing data forwarding for the UE, thereby reducing the forwarding amount of unnecessary data. In some implementations, for example, the first node may be a gNB or a gNB CU-CP or an en-gNB or an eNB or an ng-eNB, and the second node may be a gNB or a gNB CU-CP or an en-gNB or an eNB or an ng-eNB.

Referring to FIG. 22, in step S2201, the first node may transmit a prediction request for a PDCP sequence number (for example, corresponding to the fourth request) to the second node, so as to inform the second node of information required for prediction of the PDCP sequence number. In some implementations, for example, the message carrying the prediction request of the PDCP sequence number may be the aforementioned eleventh message including the fourth request.

In step S2202, the second node may perform prediction of PDCP sequence number information, for example, based on collected PDCP sequence number information for the UE. In some implementations, for example, the prediction of the PDCP sequence number may be implemented by an AI model (for example, a machine learning model).

In step S2203, the second node may transmit a prediction result of the PDCP sequence number (for example, corresponding to the second prediction result) to the first node, so as to inform the first node of the prediction result for the UE. In some implementations, for example, the message carrying the prediction result of the PDCP sequence number may be the aforementioned tenth message including the second prediction result. If the second node cannot report the prediction result of the PDCP sequence number for the UE as required, it will inform the first node of the failure of the prediction request of the PDCP sequence number and will not proceed to step S2204. In some implementations, for example, the message carrying the failure of the prediction request of the PDCP sequence number may be the twelfth message including information indicating prediction failure of the PDCP sequence number.

In step S2204, the first node may determine a data forwarding strategy for the UE according to the prediction information for the PDCP sequence number, etc., so as to reduce unnecessary data forwarding amount. In some implementations, for example, PDCP sequence numbers for data forwarding predicted for different target nodes and/or cells are used as data forwarding starting points for performing data forwarding with corresponding target nodes and/or cells.

### Embodiment 21

Embodiment 21 describes a method for supporting data collection and processing according to some embodiments of the disclosure.

Embodiment 21 will be described below with reference to FIG. 23. FIG. 23 illustrates a schematic diagram of a method supporting data collection and processing according to some embodiments of the disclosure. Specifically, FIG. 23 illustrates a procedure of communicating prediction information of a PDCP sequence number for data forwarding of a UE between nodes in a case of dual connectivity, for supporting and optimizing a procedure of conditional PSCell change. For example, the source secondary node may determine a corresponding data forwarding strategy (for example, PDCP sequence numbers for data forwarding predicted for different target nodes and/or cells are used as data forwarding starting points for performing data forwarding with corresponding target nodes and/or cells) after predicting the PDCP sequence number for data forwarding, and then perform related data forwarding, so as to reduce the forwarding amount of unnecessary data. In some implementations, for example, the master node may be a gNB or a gNB CU-CP or an en-gNB or an eNB or an ng-eNB, the source secondary node may be a gNB or a gNB CU-CP or an en-gNB or an eNB or an ng-eNB, and the target secondary node may be a gNB or a gNB CU-CP or an en-gNB or an eNB or an ng-eNB.

In step S2301, the master node may transmit a secondary node addition request message carrying a maximum number of PSCells to the target secondary node.

In step S2302, the target secondary node may perform selection of candidate target PSCell(s), and feed back a secondary node addition request acknowledge message carrying identification(s) of the selected candidate target PSCell(s) to the master node.

In step S2303, the master node may transmit a secondary node release request message carrying a prediction request for a PDCP sequence number for data forwarding (for example, corresponding to the aforementioned fourth request) to the source secondary node. In some implementations, for example, the secondary node release request message may be the aforementioned eleventh message including the fourth request.

In step S2304, the source secondary node may perform prediction of the PDCP sequence number information for data forwarding based on collected PDCP sequence number information for the UE. In some implementations, for example, the prediction of the PDCP sequence number for data forwarding may be implemented by an AI model (for example, a machine learning model).

In step S2305, the source secondary node may transmit a secondary node release request acknowledge message to the master node.

In step S2306, the master node may set execution condition(s) for the received candidate target PSCell(s), and the master node may inform the UE of the candidate target PSCell(s) and the corresponding execution condition(s).

In step S2307, direct data forwarding may be performed with different PDCP sequence numbers as the starting points for different target nodes according to the predicted PDCP sequence numbers for data forwarding. In some implementations, for example, PDCP sequence numbers for data forwarding predicted for different nodes and/or cells are used as data forwarding starting points for performing data forwarding with corresponding target nodes and/or cells. For example, step S2307 may include:
S2307.a: for different target nodes, the source secondary node performs direct data forwarding with the target secondary nodes with different PDCP sequence numbers as the starting points according to the predicted PDCP sequence numbers for data forwarding; and/or
S2307.b: for different target nodes, the source secondary node performs data forwarding with the target secondary node through the master node with different PDCP sequence numbers as the starting points according to the predicted PDCP sequence numbers for data forwarding.

Therein, step S2306 may be performed before or simultaneously with steps S2303, 2304 and 2305.

### Embodiment 22

Embodiment 22 describes a method for supporting data collection and processing according to some embodiments of the disclosure.

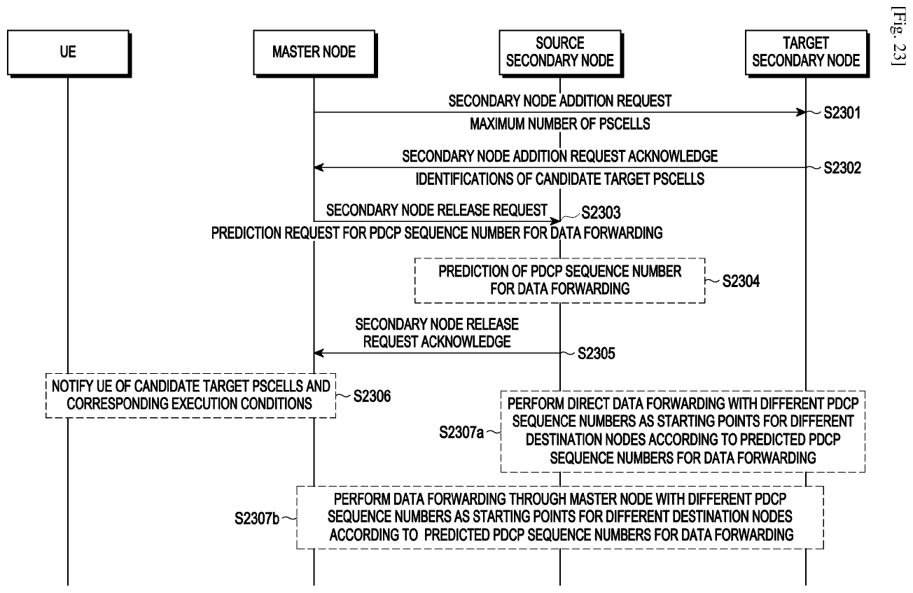

Embodiment 22 will be described below with reference to FIG. 24. FIG. 24 illustrates a schematic diagram of a method supporting data collection and processing according to some embodiments of the disclosure. Specifically, FIG. 24 illustrates a procedure of communicating information of a PDCP sequence number for data transmission of a UE between nodes, in order to provide a feedback requirement for the information of the PDCP sequence number to the node, which then feeds back related information of the PDCP sequence number for data transmission to the first node. As such, necessary information is provided for prediction of the PDCP sequence number for the UE, so that the data forwarding amount is accurately set and the forwarding amount of unnecessary data is reduced. In some implementations, for example, the first node may be a gNB or a gNB CU-CP or an en-gNB or an eNB or an ng-eNB, and the second node may be a gNB or a gNB CU-CP or an en-gNB or an eNB or an ng-eNB.

Referring to FIG. 24, in step S2401, the first node may transmit a reporting request for a PDCP sequence number for data transmission (for example, it may correspond to the aforementioned fifth request) to the second node, so as to inform the second node of the feedback requirement for information of the PDCP sequence number. In some implementations, for example, the message carrying the reporting request for the PDCP sequence number may be the aforementioned fourteenth message including the fifth request.

In step S2402, the second node may transmit a result of the PDCP sequence number for data transmission of the UE (for example, it may correspond to the third feedback result) to the first node, so as to inform the first node of information of the PDCP sequence number for the UE. In some implementations, for example, the message carrying the result of the PDCP sequence number for the UE may be the thirteenth message including the third feedback result. If the second node cannot report information of the PDCP sequence number for the UE as required, it will inform the first node of the report failure of the PDCP sequence number, and step S2403 and subsequent steps will not be performed. In some implementations, for example, the message carrying the report failure of the PDCP sequence number may be the fifteenth message including the information indicating the report failure of the PDCP sequence number.

In step S2403, the first node may perform prediction of the PDCP sequence number based on collected information of the PDCP sequence number for data transmission of the UE, such as a prediction of information of a PDCP sequence number for data transmission, a prediction of information of a PDCP sequence number for data forwarding, or a prediction of a changing trend of the PDCP sequence number for data transmission. In some implementations, for example, the prediction of the PDCP sequence number may be implemented by an AI model (for example, a machine learning model).

In step S2404, the first node may inform the second node of a prediction result of the predicted PDCP sequence number, so that the second node may determine a data forwarding strategy for the UE according to the prediction information for the PDCP sequence number, etc., thereby reducing unnecessary data forwarding amount. In some implementations, for example, the message carrying the prediction result of the PDCP sequence number may be the aforementioned tenth message including the second prediction result. In some implementations, for example, PDCP sequence numbers for data forwarding predicted for different target nodes and/or cells are used as data transmission starting points for performing data transmission with corresponding target nodes and/or cells.

### Embodiment 23

Embodiment 23 describes a method for supporting data collection and processing according to some embodiments of the disclosure.

Embodiment 23 will be described below with reference to FIG. 25. FIG. 25 illustrates a schematic diagram of a method supporting data collection and processing according to some embodiments of the disclosure. Specifically, FIG. 25 illustrates a procedure of communicating information of a PDCP sequence number of a UE between nodes in a case of dual connectivity, for supporting and optimizing a procedure of conditional PSCell change. For example, after the source secondary node reports information of the PDCP sequence number to the master node, the master node may perform prediction of the PDCP sequence number and feed back the result to the source secondary node. Then, the source secondary node may determine a corresponding data forwarding strategy according to the prediction result of the PDCP sequence number (for example, for different target nodes, PDCP sequence numbers for data forwarding predicted and/or cells are used as data forwarding starting points for performing data forwarding with corresponding target nodes and/or cells), and then perform related data forwarding, so as to reduce the forwarding amount of unnecessary data. In some implementations, for example, the master node may be a gNB or a gNB CU-CP or an en-gNB or an eNB or an ng-eNB, the source secondary node may be a gNB or a gNB CU-CP or an en-gNB or an eNB or an ng-eNB, and the target secondary node may be a gNB or a gNB CU-CP or an en-gNB or an eNB or an ng-eNB.

With reference to FIG. 25, in step S2501, the master node may transmit a secondary node addition request message carrying a maximum number of PSCells to the target secondary node.

In step S2502, the target secondary node may perform selection of candidate target PSCell(s), and may feed back a secondary node addition request acknowledge message carrying identification(s) of the selected candidate target PSCell(s) to the master node.

In step S2503, the master node may transmit a secondary node release request message carrying the reporting request of the PDCP sequence number (for example, corresponding to the aforementioned fifth request) to the source secondary node. In some implementations, for example, the secondary node release request message may be the aforementioned fourteenth message including the fifth request.

In step S2504, the source secondary node may transmit a secondary node release request acknowledge message carrying information of the PDCP sequence number (for example, corresponding to the aforementioned third feedback result) to the master node. In some implementations, for example, the secondary node release request acknowledge message may be the thirteenth message including the third feedback result.

In step S2505, the master node may predict information of the PDCP sequence number based on the received information of the PDCP sequence number for the UE. In some implementations, for example, the prediction of the PDCP sequence number may be implemented by an AI model (for example, a machine learning model).

In step S2506, the master node may transmit the prediction result of the PDCP sequence number (for example, corresponding to the aforementioned second prediction result) to the source secondary node. In some implementations, for example, the message carrying the prediction result of the PDCP sequence number may be the aforementioned tenth message including the second prediction result.

In step S2507, the master node may set execution condition(s) for the received candidate target PSCell(s), and notify the UE of the candidate target PSCell(s) and the corresponding execution condition(s).

In step S2508, the PDCP sequence number for data forwarding may be determined according to the predicted PDCP sequence number, and then data forwarding is performed with different PDCP sequence numbers as the starting points for different target nodes. In some implementations, for example, PDCP sequence numbers for data forwarding predicted for different nodes and/or cells are used as data forwarding starting points for performing data forwarding with corresponding target nodes and/or cells. For example, step S2508 may include:
S2508.a: the source secondary node determines the PDCP sequence number for data forwarding according to the predicted PDCP sequence number, and then for different target nodes, performs direct data forwarding with the target secondary nodes with different PDCP sequence numbers as the starting points; and/or
S2508.b: the source secondary node determines the PDCP sequence number for data forwarding according to the predicted PDCP sequence number, and then for different target nodes, performs data forwarding with the target secondary node through the master node with different PDCP sequence numbers as the starting points.

Therein, step S2507 may be performed before or simultaneously with steps S2503, 2504, 2505 and 2506.

In some implementations, the machine learning model used for prediction of the PDCP sequence number in Embodiments 19-23 may include, but is not limited to, perceptrons, feedforward neural networks, radial basis function networks, deep feedforward networks, recurrent neural networks, long/short-term memory networks, gated recurrent units, auto-encoders, variational auto-encoders, denoising auto-encoders, sparse auto-encoders, Markov chains, Hopfield networks, Boltzmann machines, restricted Boltzmann machines, deep belief networks, deep convolutional networks, deconvolutional neural networks, deep convolutional inverse graphics networks, generative adversarial networks, liquid state machines, extreme learning machines, echo state networks, deep residual networks, Kohonen networks, support vector machines, neural turing machines, convolutional neural networks, artificial neural networks, recurrent neural networks, deep neural networks, etc.

In some implementations, the input of the machine learning model may include one or more of an identification of a UE, a time point, a historical information of a PDCP sequence number for transmission, a candidate target cell, a measurement result (RSRP/RSRQ/SINR), a location coordinate, a camping cell, a moving velocity (including a magnitude and/or a direction), a neighboring node information (such as a resource state), etc. The output of the model may include one or more of a time point, a cell identification, a predicted PDCP sequence number for data forwarding, a predicted PDCP sequence number for data transmission, a predicted changing trend of the PDCP sequence number for data transmission, etc.

In some implementations, the machine learning model may be trained by online training, offline training, supervised learning, unsupervised learning, reinforcement learning, etc.

Various embodiments of the disclosure have been described with reference to FIGS. 3 to 25. Although various embodiments have been described separately, it should be understood by those skilled in the art that one or more of these embodiments can be combined as needed to form a new embodiment, and the formed new embodiment should also be part of the disclosure.

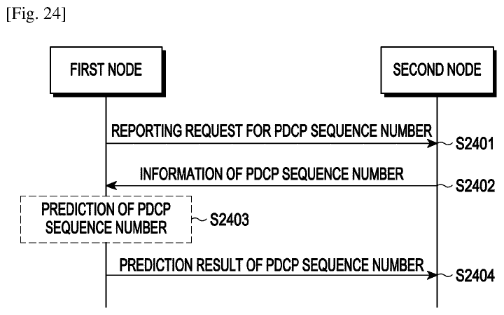

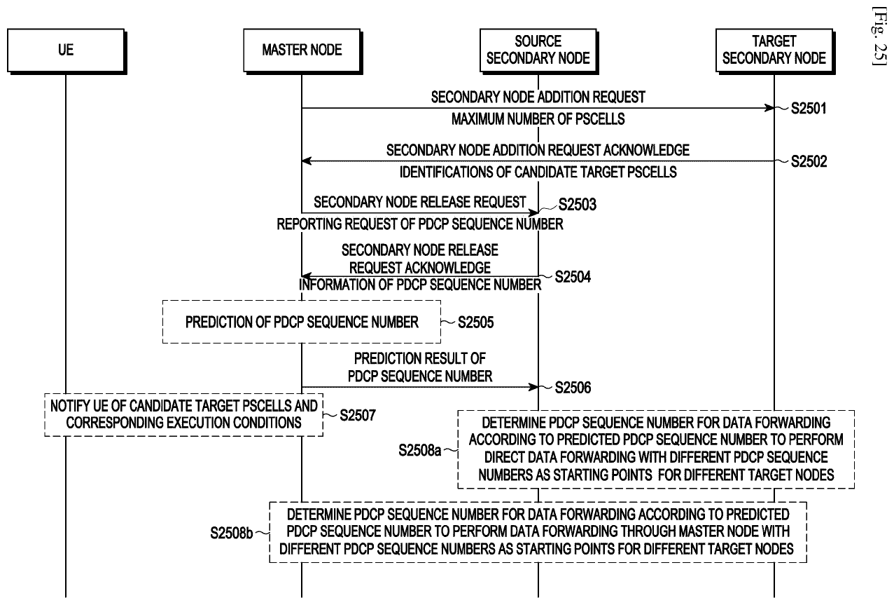

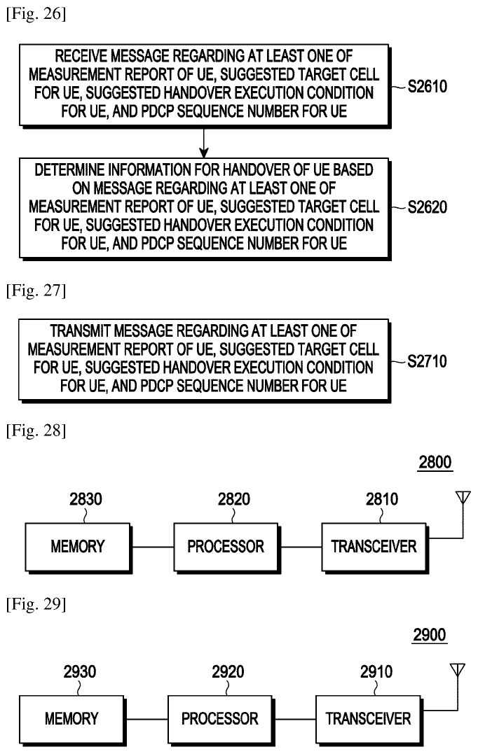

FIG. 26 illustrates a flowchart of a method performed by a first node according to some embodiments of the disclosure.

Referring to FIG. 26, in step S2610, a message regarding at least one of a measurement report of a UE, a suggested target cell for the UE, a suggested handover execution condition for the UE, and a PDCP sequence number for the UE is received from a second node. For example, the message may include at least one of the first message, the fourth message, the seventh message, the tenth message and the thirteenth message described above.

In some implementations, the description of information or parameters or fields carried by each of the first message, the fourth message, the seventh message, the tenth message and the thirteenth message may refer to the various embodiments described before, and detailed description is omitted here for brevity.

In some implementations, details about receiving each of the first message, the fourth message, the seventh message, the tenth message and the thirteenth message may refer to the various embodiments described before, and detailed description is omitted here for brevity.

Next, in step S2620, information for handover of the UE is determined based on the received message.

For example, the information for handover of the UE includes at least one of: information on selection of a target node, information on a handover execution condition, information on determination of whether to perform handover, information on determination of a handover timing, or information on a setting of a data forwarding amount for data forwarding.

In some implementations, the first node may be one of a gNB, a gNB CU-CP, an en-gNB, an eNB, or an ng-eNB.

In some implementations, the second node may be one of a gNB, a gNB CU-CP, an en-gNB, an eNB, or an ng-eNB.

In some examples, in a dual connectivity scenario in which a master node and a secondary node are connected with the UE, when handover occurs, the second node may be a master node, and the first node may be a source secondary node or a target secondary node changed from the source secondary node. In some other examples, the first node may be a master node and the second node may be a source secondary node.

According to the embodiments of the disclosure, by considering the message regarding at least one of the measurement report of the UE, the suggested target cell for the UE, the suggested handover execution condition for the UE, and the PDCP sequence number for the UE to determine the information for handover, it may be possible to improve the efficiency of handover and/or avoid data forwarding redundancy during handover.

FIG. 27 illustrates a flowchart of a method performed by a second node according to some embodiments of the disclosure.

Referring to FIG. 27, in operation S2710, a message regarding at least one of a measurement report of a UE, a suggested target cell for the UE, a suggested handover execution condition for the UE, and a packet data convergence protocol (PDCP) sequence number for the UE is transmitted to a first node, where information for handover of the UE is determined based on the transmitted message. For example, the transmitted message may include at least one of the first message, the fourth message, the seventh message, the tenth message and the thirteenth message described above.

In some implementations, the description of information or parameters or fields carried by each of the first message, the fourth message, the seventh message, the tenth message and the thirteenth message may refer to the various embodiments described before, and detailed description is omitted here for brevity.

In some implementations, details about transmitting each of the first message, the fourth message, the seventh message, the tenth message and the thirteenth message may refer to the various embodiments described before, and detailed description is omitted here for brevity.

In some implementations, the first node may be one of a gNB, a gNB CU-CP, an en-gNB, an eNB, or an ng-eNB.

In some implementations, the second node may be one of a gNB, a gNB CU-CP, an en-gNB, an eNB, or an ng-eNB.

In some examples, in a dual connectivity scenario in which a master node and a secondary node are connected with the UE, when handover occurs, the second node may be a master node, and the first node may be a source secondary node or a target secondary node changed from the source secondary node. In some other examples, the first node may be a master node and the second node may be a source secondary node.

According to the embodiments of the disclosure, the first node or other nodes may determine information for handover by considering the message regarding at least one of the measurement report of the UE, the suggested target cell for the UE, the suggested handover execution condition for the UE, and the PDCP sequence number for the UE, so that the handover efficiency of the UE can be improved and/or data forwarding redundancy during handover can be avoided.

FIG. 28 illustrates a block diagram of configuration of a terminal according to some embodiments of the disclosure.

Referring to FIG. 28, a terminal 2800 according to some embodiments of the disclosure may include a transceiver 2810, at least one processor 2820 and a memory 2830. The terminal may be implemented to include more or less elements than those shown in FIG. 28.

The transceiver 2810 may transmit or receive signals to or from another terminal, base station and/or network entity. The transceiver 2810 may receive, for example, downlink data packets from a base station and may transmit uplink data packets to the base station.

The processor 2820 may control the overall operation of the terminal. For example, the processor 2820 may control to perform one or more of the above-described operations performed by a terminal (e.g., UE).

The memory 2830 may store information, data, programs, instructions and the like processed by the terminal.

FIG. 29 illustrates a block diagram of configuration of a base station according to some embodiments of the disclosure.

For example, the structure of the base station shown in FIG. 29 illustrates a structure of the first node, the second node, the master node, the source secondary node or the target secondary node related to the above embodiment of the disclosure.

Referring to FIG. 29, the base station 2900 according to the above embodiment may include a transceiver 2910, at least one base station processor 2920 and a memory 2930. The base station may be implemented to include more or less elements than those shown in FIG. 29.

The transceiver 2910 may transmit or receive signals to or from a terminal, another base station and/or network entity. The transceiver 2910 may receive, for example, uplink data packets from a terminal and may transmit downlink data packets to the terminal.

The processor 2920 may control the overall operation of the base station. For example, the processor 2920 may control to perform one or more of the above-described operations performed by the first node, the second node, the master node, the source secondary node or the target secondary node.

The memory 2930 may store information, data, programs, instructions and the like processed by the base station.

The embodiments of the disclosure disclosed in the specification and drawings are only for providing specific examples to easily explain the technical problems of the disclosure and help to understand the disclosure, and are not intended to limit the scope of the disclosure. That is, it is obvious to those skilled in the art that other modified examples based on the technical ideas of the disclosure may be implemented. In addition, the above embodiments may be combined with each other and used as needed. For example, various embodiments of the disclosure may be combined with each other to implement a base station and a terminal. In addition, although the above embodiment is suggested based on a NR system, other modified examples based on the technical ideas of the above embodiments may be implemented in other systems, such as an FDD or TDD LTE system.

According to embodiments of the disclosure, at least a part of an apparatus (e.g., a module or its functionality) or a method (e.g., an operation or a step) may be implemented for example as instructions stored in a computer-readable storage medium (e.g., a memory) in the form of program modules. When executed by a processor or controller, the instructions may enable the processor or controller to perform corresponding functions. Computer-readable media may include, for example, hard disk, floppy disk, magnetic media, optical recording media, DVD, and magneto-optical media. The instructions may include codes created by a compiler or codes executable by an interpreter. Modules or devices according to various embodiments of the disclosure may include at least one or more of the above components, omit some of the above components, or include other additional components. Operations performed by modules, programming modules or other components according to various embodiments of the disclosure may be performed sequentially, in parallel, repeatedly or heuristically, or at least some operations may be performed in a different order or omitted, or other operations may be added.

The above description is only exemplary implementations of the present invention, and is not used to limit the scope of protection of the present invention, which is defined by the appended claims.

1-15. (canceled)

16. A method performed by a first node in a wireless communication system, the method comprising:
transmitting, to a second node, a first message of a request for first information about a first packet data convergence protocol (PDCP) sequence number for data transmission;
receiving, from the second node, a second message including the first information about the PDCP sequence number for the data transmission; and
predicting second information about a second PDCP sequence number for data transmission based on the first information,
wherein the second information about the second PDCP sequence number is used to determine a third PDCP sequence number for data transmission of a third node.

17. The method of claim 16, further comprising:
transmitting, to the second node, the predicted second information about the second PDCP sequence number.

18. The method of claim 16, wherein the second information is used to determine a fourth PDCP sequence number for data transmission of the third node through the first node.

19. The method of claim 16, wherein the second information about the second PDCP sequence number is predicted based on an artificial intelligence (AI) model.

20. The method of claim 16,
wherein the first node comprises a master node,
wherein the second node comprises a source secondary node, and
wherein and the third node comprises a target secondary node.

21. A method performed by a second node in a wireless communication system, the method comprising:
receiving, from a first node, a first message of a request for first information about a first packet data convergence protocol (PDCP) sequence number for data transmission;
transmitting, to the first node, a second message including the first information about the first PDCP sequence number; and
based on second information about a second PDCP sequence number for data transmission, determining a third PDCP sequence number for data transmission of a third node,
wherein the second information about the second PDCP sequence number is predicted, based on the first information about the first PDCP sequence number.

22. The method of claim 21, further comprising:
receiving, from the second node, the predicted second information about the second PDCP sequence number.

23. The method of claim 21, wherein the second information about the second PDCP sequence number is used to determine a fourth PDCP sequence number for data transmission of the third node through the first node.

24. The method of claim 21, wherein the second information about the second PDCP sequence number is predicted based on an artificial intelligence (AI) model.

25. The method of claim 21,
wherein the first node comprises a master node,
wherein the second node comprises a source secondary node, and
wherein and the third node comprises a target secondary node.

26. A first node in a wireless communication system, the first node comprising:
a transceiver; and
at least one processor coupled to the transceiver and configured to:
transmit, to a second node, a first message of a request for first information about a first packet data convergence protocol (PDCP) sequence number for data transmission,
receive, from the second node, a second message including the first information about the PDCP sequence number for the data transmission, and
predict second information about a second PDCP sequence number for data transmission based on the first information,
wherein the second information about the second PDCP sequence number is used to determine a third PDCP sequence number for data transmission of a third node.

27. The first node of claim 26, wherein the at least one processor is further configured to transmit, to the second node, the predicted second information about the second PDCP sequence number.

28. The first node of claim 26, wherein the second information is used to determine a fourth PDCP sequence number for data transmission of the third node through the first node.

29. The first node of claim 26, wherein the second information about the second PDCP sequence number is predicted based on an artificial intelligence (AI) model.

30. The first node of claim 26,
wherein the first node comprises a master node,
wherein the second node comprises a source secondary node, and
wherein and the third node comprises a target secondary node.

31. A second node in a wireless communication system, the second node comprising:
a transceiver; and
at least one processor coupled to the transceiver and configured to:
receive, from a first node, a first message of a request for first information about a first packet data convergence protocol (PDCP) sequence number for data transmission,
transmit, to the first node, a second message including the first information about the first PDCP sequence number, and
based on second information about a second PDCP sequence number for data transmission, determine a third PDCP sequence number for data transmission of a third node,
wherein the second information about the second PDCP sequence number is predicted, based on the first information about the first PDCP sequence number.

32. The second node of claim 31, wherein the at least one processor is further configured to receive, from the second node, the predicted second information about the second PDCP sequence number.

33. The second node of claim 31, wherein the second information about the second PDCP sequence number is used to determine a fourth PDCP sequence number for data transmission of the third node through the first node.

34. The second node of claim 31, wherein the second information about the second PDCP sequence number is predicted based on an artificial intelligence (AI) model.

35. The second node of claim 31,
wherein the first node comprises a master node,
wherein the second node comprises a source secondary node, and
wherein and the third node comprises a target secondary node.
